(19) United States
(12) Patent Application Publication
(10) Pub. No.: US 2014/0324645 A1
(43) Pub. Date: Oct. 30, 2014

(54) METHOD AND SYSTEM FOR CONFIGURING AND PROCESSING COMPENSATION PLANS

(71) Applicant: OPTYMYZE PTE. LTD., Singapore (SG)

(72) Inventors: MARK A. STIFFLER, SINGAPORE (SG); ANNE LUONGO, PHILADELPHIA, PA (US); MARISSA ARNEY, PHILADELPHIA, PA (US); VINIT MANJARDEKAR, WAYNE, PA (US)

(73) Assignee: OPTYMYZE PTE. LTD., Singapore (SG)

(21) Appl. No.: 14/259,789

(22) Filed: Apr. 23, 2014

Related U.S. Application Data
(60) Provisional application No. 61/816,016, filed on Apr. 25, 2013.

(51) Int. Cl. G06Q 40/00

(52) U.S. Cl. CPC G06Q 40/12
USPC 705/30

(57) ABSTRACT

A computer-implemented method of configuring and processing a compensation plan in a plan management system is disclosed, including the steps of presenting a graphical user interface via a display device that is configured to present guidance and receive user input related to the compensation plan. The method further includes the steps of receiving a user input specifying a plan roster containing a plan entity for which the compensation plan performs calculations, receiving a user input specifying a plan metric configured to perform a metric calculation on input data related to the plan entity to produce metrics data, receiving a user input specifying a plan component configured to perform an earnings calculation on input data comprising the metric results data to produce earnings data, and receiving a user input specifying a plan payment configured to perform a payment calculation on input data comprising the earnings data to produce payments data.

### CROSS REFERENCE TO RELATED APPLICATION

This application claims the benefit of U.S. Provisional Application Ser. No. 61/816,016, filed Apr. 25, 2013, which is incorporated by reference as if fully set forth herein.

### FIELD OF INVENTION

This application is generally related to methods and systems for configuring and processing compensation plans, and more particularly related to a computerized method and system for configuring compensation plans in sales performance management solutions, and processing or running such compensation plans to determine performance metrics, earnings, and payments.

### BACKGROUND

Business and other organizations often have different ways of determining how to compensate their employees, which may range from simple salary structures to more complicated arrangements depending on factors like output, performance, and meeting predetermined objectives. Furthermore, how compensation is determined usually varies greatly across different industries and positions. For example, compensation for sales representatives may be calculated very differently from administrative personnel paid on an hourly basis. Whereas some positions may not be eligible for any bonuses, other positions' compensation may be made up largely of bonuses or commissions. Many compensation plans are “pay for performance plans,” meaning that a measure of performance serves as the basis for determining how much an individual or position earns and is paid. Accordingly, organizations need to effectively design, implement, and manage compensation plans to determine the proper compensation to be paid to its employees, contractors, and other individuals. Although such compensation plans may be manually administered by the organization, where an individual or department is responsible for calculating the compensation to be paid to each employee for every pay period, doing so is highly inefficient, error-prone, and generally impractical or impossible for larger organizations with large numbers of employees and/or complex compensation plans. Consequently, specialized compensation plan systems in the form of software or other computerized means have been developed to represent an organization's compensation plans and run those plans to determine compensation, bonuses, and other related information. Portions of the compensation plan may also be automated by the system, such as updates to a plan or automatic calculations for each pay period.

The design, implementation, and management of compensation plans often plays a large role in the field of sales performance management (SPM), which includes a wide array of different and interrelated business applications geared towards driving and managing sales operations and driving the effectiveness and productivity of sales forces and sales channels. SPM applications may be directed to the areas of sales compensation management (SCM), workflow, sales analytics, data management, reporting, customized alerts and dashboards, and other business operations. SPM solutions, including computer software, often include specific workflow systems for configuring and managing the organization's workflow processes. SCM applications may include functionality specifically directed towards compensation plan management. Together with other SPM applications, compensation plan management systems allow SPM solutions to effectively manage an organization's compensation plans, data analysis, and other operational functions, and provide individuals within the organization with clear, accurate, and timely compensation payments and information. Compensation plan management (CPM) systems generally allow one or more compensation plans to be represented and implemented in a computerized system, accept input data related to the compensation plan, and process the compensation plan to determine compensation results and related information. In some cases, different industries or organizations may have compensation plans that are similar at a high level, but the details of those compensation plans may vary greatly, including the structure of the compensation plan, how the compensation plan is implemented in the system, the type of input data required for the compensation plan, how calculations are performed to determine compensation, how payments are made, etc. In other cases, an organization may have compensation plans that are unique to its own business and needs.

In known compensation plan management applications used in SPM solutions, the process for setting up or implementing a compensation plan in the application can be extremely unintuitive, complicated, and time consuming. In order to accommodate for a wide variety of compensation plans, such CPM applications may require individuals with specialized technical knowledge to set up and administer the compensation plan, and may require a large amount of custom coding to meet an organization's business needs. In other known CPM applications that try to simplify the process for setting up or implementing compensation plans, very rigid structures are provided for defining those compensation plans. For example, compensation plans in these applications or systems are usually designed and created to work in conjunction with a fix set of data in a particular format, not necessarily in the form that the organization normally generates in its ordinary course of business. Therefore, a lot of pre-processing is usually required to get the organization's data in the correct form before it can be used as an input in the CPM application. Furthermore, the rigid structure of these CPM applications often limits the ways in which an organization can design its compensation plan, and do not allow for true customization of plans. Instead, an organization may be forced to design its compensation plans to fit the types of plans that are supported by the CPM application. The organization may also be limited in how it can administer its plans, as calculation or payment options are often dictated by the system. In order to make significant changes to compensation plans or allow more customized compensation plans in these rigid CPM applications, custom coding and programming is often required. This increases the cost and time required to implement plan changes, as well as the possibility of software errors and related issues. The need for custom code in implementing, modifying, and administering compensation plans is highly burdensome for the organization and users, as it makes it more difficult to implement and update compensation plans as business requirements change, something that happens frequently for an organization and in the SPM field in general. Furthermore, known CPM applications often require data to be retrieved from and saved to databases or other applications outside of the SPM application, which may complicate the implementation and administration of compensation plans within the CPM application, as the configuration or administrative user is required to maintain such data separately from the compensation plan and ensure continued accuracy of their data values and format. When changes need to be made to such data, the user is forced to go outside of the CPM application and manually make those changes, which further contributes to administrative burden and possibility for errors.

In view of the above, a need exists for technology that enables compensation plans, including complex and unique plans, to be easily implemented, modified, and administered without using custom code, presented in an intuitive and business-oriented fashion both during setup and subsequent administration, and fully integrated to work with any data and business application within a SPM system. A need further exists for a CPM system that represents compensation plans as discrete parts that make business sense for the user, guides the configuration user through creating and implementing a compensation plan in an easily understood fashion, and automatically creates necessary data tables and other objects related to compensation plans as such plans are being defined or run in the system.

### SUMMARY

A computer-implemented method of configuring and processing a compensation plan in a plan management system is disclosed. The method including the steps of presenting a graphical user interface via a display device, the graphical user interface being configured to present guidance and receive user input related to the compensation plan, and receiving a user input specifying a plan roster containing a plan entity representing a business unit for which the compensation plan performs calculations. The method further includes the steps of receiving a user input specifying a plan metric configured to perform a metric calculation on input data related to the plan entity to produce metrics data, receiving a user input specifying a plan component configured to perform an earnings calculation on input data comprising the metric results data to produce earnings data, and receiving a user input specifying a plan payment configured to perform a payment calculation on input data comprising the earnings data to produce payments data. A system for configuring and processing a compensation plan, as well as a computer software product are also disclosed. For sake of brevity, this summary does not list all aspects of the present method, system, computer software product, and related technologies, which are described in further detail below and in the claims.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangement shown.

FIG. 1 is a diagram illustrating the relationship between components of an embodiment of a compensation plan management (CPM) system;

FIG. 2 illustrates a simplified embodiment of a CPM system;

FIG. 3 illustrates a server based scalable embodiment of a CPM system;

FIG. 4 is a diagram illustrating the elements of a compensation plan of the CPM system of FIG. 1, 2, or 3;

FIG. 5 is a screenshot illustrating an embodiment of a graphical user interface of the CPM system of FIG. 1, 2, or 3;

FIGS. 6 and 7 are screenshots illustrating features of the graphical user interface shown in FIG. 5 related to plan rosters;

FIG. 8 is a screenshot illustrating an exemplary earnings roster table;

FIG. 9 is a diagram illustrating how an earnings roster table is generated using an assignment between entities;

FIG. 10 is a diagram illustrating how values from an earnings roster table may be utilized in a parameter table;

FIG. 11 is a screenshot illustrating features of the graphical user interface shown in FIG. 5 related to plan roster configuration and tables;

FIG. 12 is a diagram illustrating how an earnings to payment roster table is generated;

FIG. 13 is a screenshot illustrating features of the graphical user interface shown in FIG. 5 related to plan roster configuration and tables;

FIG. 14 is a screenshot illustrating features of the graphical user interface shown in FIG. 5 related to a summary flow diagram of a compensation plan;

FIG. 15 is a diagram illustrating how an earnings roster and earnings to payments roster are generated;

FIG. 16 is a screenshot illustrating features of the graphical user interface shown in FIG. 5 related to running a compensation plan;

FIG. 17 is a screenshot illustrating an exemplary earnings to payments roster table;

FIGS. 18-34 are screenshots illustrating features of the graphical user interface shown in FIG. 5 related to plan metrics;

FIG. 35 is an exemplary baseline prior period values table;

FIGS. 36-38 are screenshots illustrating features of the graphical user interface shown in FIG. 5 related to plan metric modifiers;

FIG. 39 is a screenshot illustrating features of the graphical user interface shown in FIG. 5 related to running a plan metric;

FIG. 40 is a diagram illustrating the steps associated with processing a plan metric;

FIG. 41 is a screenshot illustrating an exemplary plan metric results table;

FIG. 42 is a screenshot illustrating features of the graphical user interface shown in FIG. 5 related to modified metric results tables;

FIG. 43 is a screenshot illustrating features of the graphical user interface shown in FIG. 5 related to defining a plan period;

FIG. 44 is a screenshot illustrating features of the graphical user interface shown in FIG. 5 related to defining effective periods;

FIGS. 45-47 are screenshots illustrating features of the graphical user interface shown in FIG. 5 related to defining plan metric validations;

FIG. 48 is a screenshot illustrating features of the graphical user interface shown in FIG. 5 related to defining plan entities;

FIG. 49 is a screenshot illustrating features of the graphical user interface shown in FIG. 5 related to defining a plan component earnings calculation period;

FIG. 50 is a screenshot illustrating features of the graphical user interface shown in FIG. 5 related to defining a plan component's earnings calculation entity;

FIGS. 51-54 are screenshots illustrating features of the graphical user interface shown in FIG. 5 related to defining earnings calculations;

FIG. 55 is a screenshot illustrating features of the graphical user interface shown in FIG. 5 related to running a plan component;

FIG. 56 is a diagram illustrating the steps associated with processing a plan component;

FIGS. 57-59 are screenshots illustrating exemplary plan earnings results tables;

FIG. 60 is a screenshot illustrating features of the graphical user interface shown in FIG. 5 related to defining target earnings;

FIG. 61 is a screenshot illustrating features of the graphical user interface shown in FIG. 5 related to defining target earnings values;

FIG. 62 is a screenshot illustrating features of the graphical user interface shown in FIG. 5 related to defining target earning weights;

FIG. 63 is a screenshot illustrating features of the graphical user interface shown in FIG. 5 related to defining plan payments;

FIG. 64 is a screenshot illustrating an exemplary payment results table;

FIGS. 65-68 are screenshots illustrating features of the graphical user interface shown in FIG. 5 related to defining calculations for plan payments;

FIG. 69 is a screenshot illustrating features of the graphical user interface shown in FIG. 5 related to defining earnings calculations based on a commission rate;

FIG. 70 is a screenshot illustrating an exemplary parameter table;

FIGS. 71-77 are screenshots illustrating features of the graphical user interface shown in FIG. 5 related to a job management element;

FIGS. 78A-78B are screenshots illustrating features of the graphical user interface shown in FIG. 5 related to different versions of a data transformation process;

FIG. 78C is a screenshot illustrating features of the graphical user interface shown in FIG. 5 related to different versions of a compensation plan;

FIG. 79 is a screenshot illustrating features of the graphical user interface shown in FIG. 5 related to defining a new version of a compensation plan; and

FIG. 80 is a tablet computer that may be utilized in the CPM systems of FIGS. 2 and 3.

### DETAILED DESCRIPTION OF THE PREFERRED EMBODIMENTS

It is to be understood that the figures and descriptions of the present application have been simplified to illustrate elements that are relevant for a clear understanding of the present invention, while eliminating, for the purpose of clarity, many other elements found in business software and computing systems. One of ordinary skill in the art may recognize that other elements and steps may be desired or required in implementing the present system, method, computer software product, and related technologies. However, because such elements and steps are well known in the art, a discussion of such elements and steps would not facilitate a better understanding of the present invention and thus is not provided herein. The disclosure herein is directed to all such variations and modifications to such elements and steps known to those skilled in the art.

Certain terminology is used in the following description for convenience only and is not limiting. The words “front,” “back,” “left,” “right,” “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

Sales performance management (SPM) systems in the form of computer software allow large amounts of information to be processed accurately and quickly, and presented to members of an organization in a manner best suited to each individual's position and goals within the organization. SPM systems may include a number of different, but interrelated business applications that represent and carry out various business functions. For example and without limitation, these business applications may be used to determine the performance of individuals and sales channels within the organization, to analyze performance metrics in combination with other data to improve, recognize, and reward performance, and to improve the efficiency and productivity of sales operations and other business functions. Other examples of SPM business applications include general data management, which may include processes for extracting, loading, transforming, and validating data used by the SPM system, and analyzing data processing performance of the system. Sales analytics applications may be used to analyze and interpret various sales related data to determine specific issues and recommend areas for process or performance improvement. SPM applications may further include workflow process management, which may be used to define the requirements for initiating workflow processes, specify and manage the workflow routing processes, and analyze the effectiveness of workflow processes. Workflow process functionalities may be embedded with other applications to carry out various sequences of business operations. Additional business applications may be related to reporting capabilities, such as the reporting of sales and other business information through static reports as well as dynamically created reports in real-time. Individualized alerts and dashboards may be included in SPM systems to provide users with customized messages, data representations, what-if calculators, and other dynamic views that provide insight into business performance. In addition, a subset of SPM business processes may be specifically related to sales compensation management (SCM), which focuses on the management of sales compensation for salespeople and other sales channels. SCM applications may include solutions directed to the areas of compensation planning, merit adjustments, crediting and eligibility, commissions and variable pay, rewards and recognition, disputes and inquiries, auditing and compliance, and modeling and simulation of sales or compensation plans.

Compensation plan management (CPM) applications are an important part of such SPM systems, and are often a part of or work in conjunction with SCM business processes to define the elements of compensation plans, calculate relevant metrics, earnings, and payments to provide compensation information to relevant individuals or groups, and administer compensation plans over time. Accordingly, it may be desirable to integrate CPM applications within SPM systems to effectively manage compensation-related operations and processes, and exchange information with other business applications in the system. A CPM application may work with other SPM applications to carry out various calculations or other business operations using the same data as those applications, send updates to those applications, and provide customized information to individuals regarding their compensation. For example and without limitation, a CPM system according to the present application may work in conjunction within a larger SPM system to pull data from another application to use as inputs for calculation of plan metrics, provide calculation and payment information to a reporting application to provide compensation reports to individuals, and provide similar information to a user portal application to provide customized data views or alerts to individuals regarding their compensation. Embodying CPM applications and other SPM applications in software is advantageous over homegrown solutions, such as manual processes or spreadsheet based systems, in that the software can store and process large amounts of data, reduce opportunities for error, automate certain steps, and be configured to reflect changes in business requirements. The present computer-implemented method, system, computer software product, and related technologies may be used in such SPM software to configure, implement, and process compensation plans, and to provide an integrated, streamlined, and business oriented solution for compensation plan management.

It is to be understood that although the present invention is described within the context of a general SPM system, the principles embodied herein may be broadly applied to any performance management or other business solution utilizing compensation plans or other types of business rules related to calculating payments. Accordingly, the term “sales performance management system” or “SPM system” as used herein should not be interpreted as a system limited to or requiring the use of sales related processes or data. Similarly, while many of the examples in this application deal with sales related processes and information, one of ordinary skill in the art would appreciate that the present invention is not restricted to sales-centric applications, and may be used in a wide array of business solutions with various types of data and processes. Similarly, although the present CPM system is described as relating to the implementation and processing of compensation plans, one of ordinary skill in the art would appreciate that it is not limited to plans that calculate compensation data, but rather may be used for any business plan containing rules or calculations designed to process data to obtain a desired output.

As discussed above, an organization often has one or more compensation plans that dictate how compensation should be calculated for individuals in the organization. These compensation plans can vary greatly in terms of complexity. A compensation plan may generally be defined as a set of business rules or calculations related to compensation or other forms of payment. Additionally, organizations like companies often have the need to change or update compensation plans on a regular basis, which may result in different “versions” of a compensation plan over time or brand new plans that are implemented when necessary. An effective CPM system should be able to represent, process, and manage an organization's compensation plans and allow for changes to those plans.

The present CPM system allows a user to configure one or more compensation plans in an intuitive and business-oriented way, and represent different elements of the compensation plans using discrete elements that have some pre-defined characteristics, but still allow for some amount of user-specification to achieve flexibility in the resulting plan. After a user is guided through configuring a compensation plan in the present CPM system, the user may easily update or make changes to the plan, and process or “run” one or more elements that make up the plan to calculate compensation related information, such as payments for one or more individuals associated with the plan. Since a compensation plan often utilizes data that is commonly generated by an organization and the processing or running of plans may be related to other business applications, it is desirable to provide a CPM system that can be integrated within a SPM system to utilize pre-existing information and functions in the SPM system such as data records, data views, customized user portals, alerting capabilities, and automated processing. Such a CPM system must also be easily configurable and offer flexibility to accommodate a wide variety of compensation plans that may be required by an organization, but without the need for custom coding or other highly technical expertise. The present application discloses methods, systems, and related technologies for achieving such a CPM system, which allows an end user to create highly flexible compensation plans and either manually or automatically process these compensation plans to calculate payments for entities within the organization. During the configuration step, the present CPM system may guide the user through each step of the configuration in a user-friendly and business-oriented way, and may represent each element of the compensation plan in a logical flow that makes business sense to the user.

A compensation plan according to the present application may be used to calculate metrics, earnings, and payments for the entities of an organization, such as a position, territory, or an individual. Metrics are calculations of performance measures that serve as the basis of earnings calculations. Earnings are calculated for entities using metrics and before applying factors like eligibility, manual adjustments, overrides, and other payment-related calculations. Payments are calculations of the actual amounts that are paid to entities as compensation. Based on these types of calculations, a compensation plan may be broken down into discreet parts or elements, which allow a user to easily create a compensation plan using the present CPM system by combining these elements together. Specifically, a compensation plan includes a plan roster, which contains the values of entities for which metrics, earnings, and payments can be calculated. When entities are used in a plan roster, the present CPM system can take advantage of special entities that represent key business units and are associated with unique entity tables that can be accessed across different operations and applications of an SPM system that the CPM system is part of or associated with. A method and system for representing and utilizing such entities are described in detail in U.S. patent application Ser. No. 13/602,423 for “METHOD OF REPRESENTING BUSINESS UNITS IN SALES PERFORMANCE MANAGEMENT USING ENTITY TABLES AND SYSTEM COMPRISING SAME,” which is incorporated as if fully set forth herein. Going forward, the terms “entity” and “entities” will refer to the entity concept as described in U.S. application Ser. No. 13/602,423, and correspond to key business units within the CPM and SPM systems. The use of these special entities has significant benefits for the present CPM system, as will be described in detail below. In addition to these special entities, the plan roster may also utilize values of other business units that are defined by the user or in other data tables in the CPM system or an associated SPM system. A compensation plan further includes one or more plan metrics, which calculate metrics using input data from data tables that are maintained within the CPM system or maintained in a different associated system. A compensation plan also includes one or more plan components, which calculate earnings using one or more metrics, and one or more plan payments, which calculate the final payments to entities using the earnings output from the plan components. Each one of these elements of a compensation plan will be discussed in more detail below.

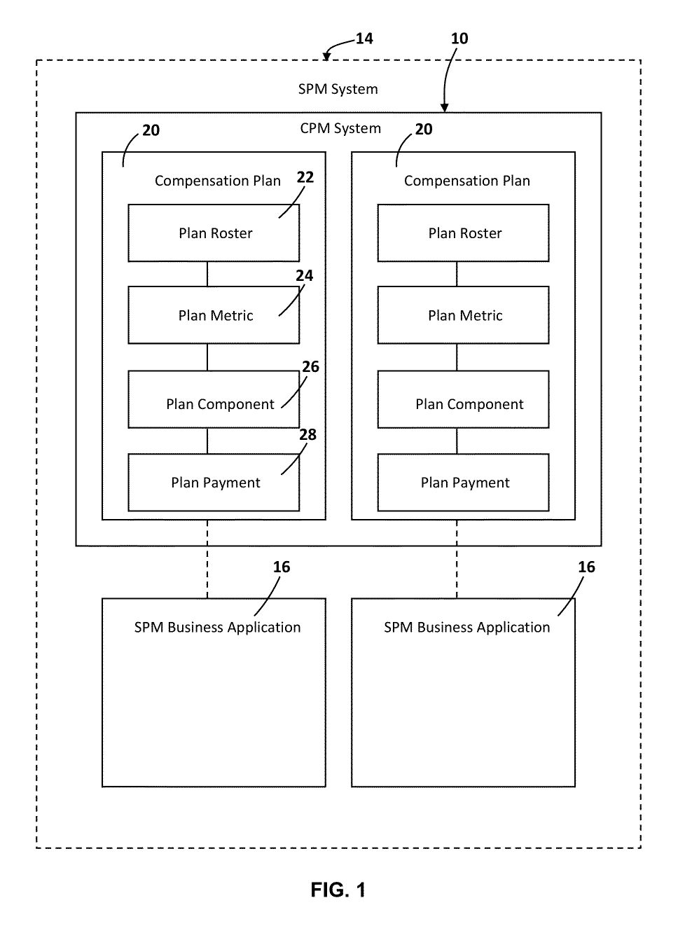

FIG. 1 is a diagram illustrating the relationship between a CPM system 10 and one or more compensation plans configured in the CPM system 10. The CPM system 10 may be a standalone system, or may be integrated in and designed to work with data within a larger SPM system 14, which may contain a number of interrelated SPM business applications 16. By using one or more elements of a graphical user interface, which will be discussed in detail below, an end user may create one or more compensation plans 20 by specifying a combination of plan rosters 22, plan metrics 24, plan components 26, and plan payments 28. Each compensation plan 20 or the entire CPM system 10 may be associated with a component of a SPM business application 16, which may supply and/or use data that is an input or output of a compensation plan 20, or work in conjunction with the CPM system 10 to perform functions such as automatic processing or running of plans, alerts to users regarding plans, or creating customized reports based on plan results.

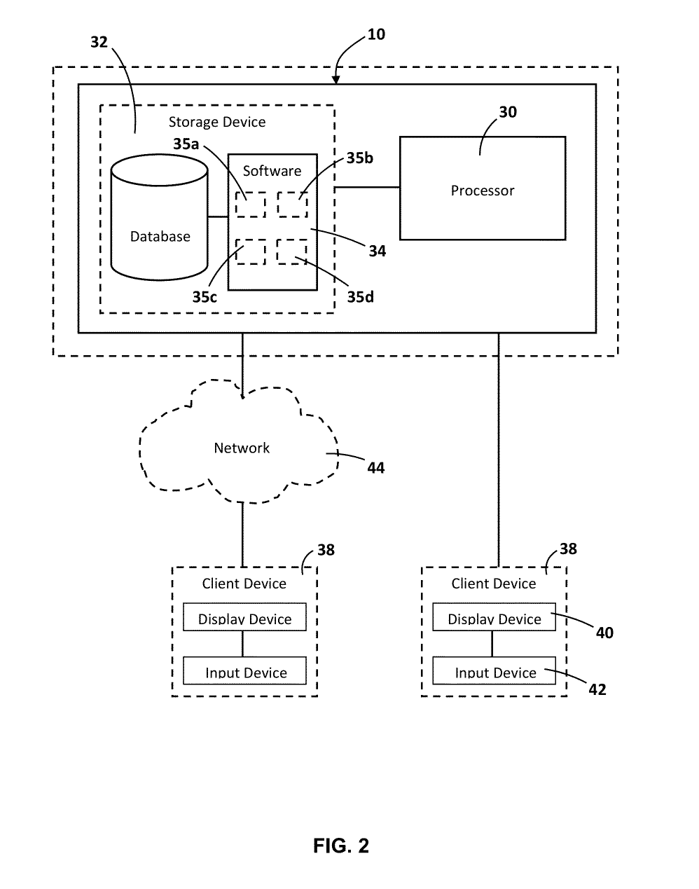

FIG. 2 illustrates an embodiment of a CPM system 10 according to the present application for creating one or more compensation plans 20 that can be processed to calculate compensation-related data for a specified entity or other business unit. The CPM system 10 shown in FIG. 2 includes a processor 30, a storage device 32 in communication with the processor 30, a display device 40 in communication with the processor 30, and an input device 42 in communication with at least one of the processor 30, storage device 32, or display device 40. The CPM system 10 further includes a software 34 stored in the storage device 32 and executable by the processor 30. As discussed above, the CPM system 10 may be integrated within the SPM system 14, and may share system resources therewith including, inter alia, the processor 30, the storage device 32, the display device 40, and the input device 42.

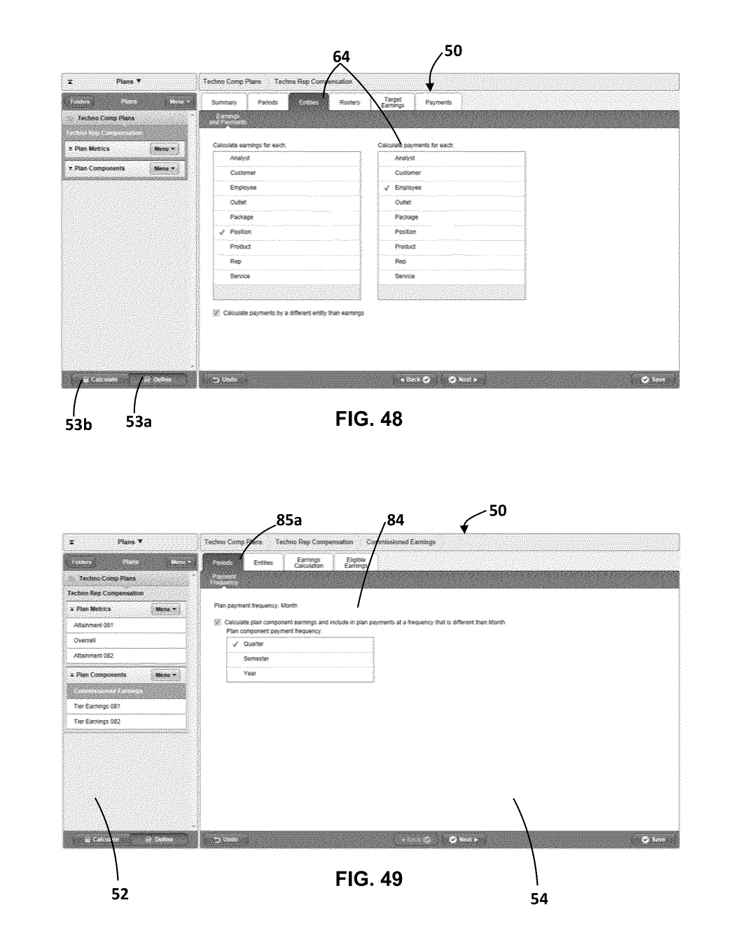

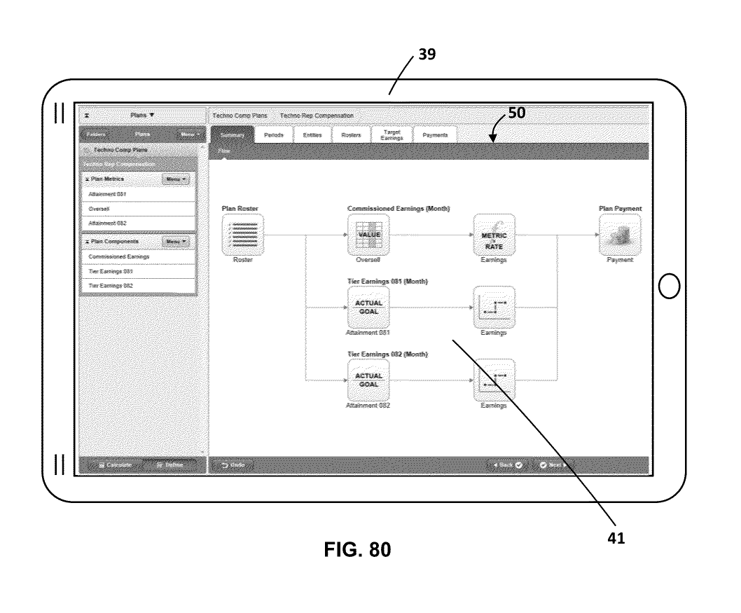

The processor 30 and the storage device 32 may be separate or part of the same machine. The processor 30 may further be associated with, or incorporated into, any suitable type of computing device, such as, for example and without limitation, a personal computer, a programmable logic controller, a server, or a mobile computing device. The storage device 32 may include a database 36 and the software 34, which may be stored in the same or separate storage components within the storage device 32 and may be in communication with each other. The database 36 may be configured to store information related to the CPM system 10 as well as information related to other business applications 16 within the SPM system 14. The storage device 32 may be or include a memory device, such as random access memory (RAM), read only memory (ROM), flash memory, a cache, or any other suitable computer-readable medium. The storage device 32 may also be or include a hard drive, a solid-state drive (SSD), a magnetic recording apparatus, a magneto-optical medium, an optical medium, a diskette, a thumb drive, or any other kind of computer-readable medium or suitable device for electronic data storage. As shown in FIG. 2, the display device 40 and input device 42 may be part of a client device 38, which is in communication with at least one of the processor 30 or the storage device 32. Optionally, the display device 40 and input device 42 may be part of the same device, such as the touch screen display 41 of the tablet computer shown in FIG. 80. The client device 38 may be directly associated with the processor 30 or storage device 32, such as through a direct connection or by being part of the same machine. Alternatively, the client device 38 may communicate with the processor 30 or storage device 32 through a network 44, such as a wide area network (WAN), local area network (LAN), or the internet. For example and without limitation, the processor 30 and the storage device 32 may be part of a server system that is physically separated from the client device 38. The display device 40 may be configured to present a graphical user interface that allows a user to interact with the present CPM system 10 and the SPM system 14, such as the graphical user interface 50 shown in FIGS. 5-8, 11, 13-14, 16-39, 41-55, 57-79 and described in detail below.

The software 34 includes a plurality of components configured to carry out functions associated with creating a compensation plan 20 in the CPM system 10 and processing/running the compensation plan 20 to generate payment information for instances of an entity. For example and without limitation, the software 34 may be configured to carry out the method steps described in detail below in relation to creating and configuring a compensation plan 20 in the present CPM system 10 and processing the compensation plan 20, either manually or as part of an automated process, such as via a job management system. Specifically, the software 34 may include a compensation plan creation component 35a configured to communicate with the graphical user interface 50, receive user inputs, and use those user inputs in creating, changing, and maintaining the compensation plan 20. The software 34 may further include a diagram component 35b, separate from or as part of the compensation plan creation component 35a, that is configured to present a diagram within the graphical user interface 50 to visually represent the different elements that the user has specified for a compensation plan 20, and how those components are associated with each other. The software 34 may further include a compensation plan processing component 35c, separate from or as part of the other software components, that is configured to process or run one or more elements of the compensation plan 20, or the entire compensation plan 20, either manually or as part of an automated process. The compensation plan processing component 35c may also operate with other applications in an associated SPM system 14, such as a job management application, to run the compensation plan 20 at regular intervals and/or perform other operations on the output payment data. Alternatively, the compensation plan processing component may include a job management component 35d that is integrated with the present CPM system 10.

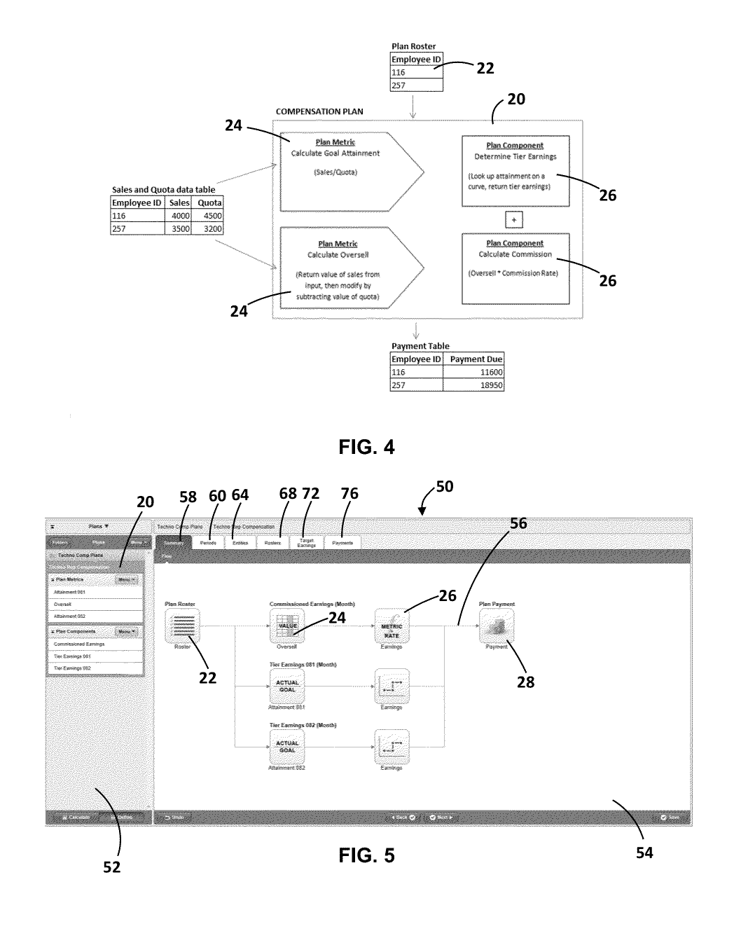

As shown in FIG. 4, a compensation plan 20 is defined in the present CPM system 10 by breaking down the plan into logical, discrete, and comprehensive building blocks that simplify the configuration process. The compensation plan creation component 35a of the software 34 may present via the graphical user interface 50 a wizard or setup interface that guides the end user through the specification or definition of each one of the building blocks by presenting at each step easily understood and business-oriented questions that the user can quickly answer in the process of creating and configuring a compensation plan 20. FIG. 4 illustrates each building block or element of an exemplary compensation plan 20, which may be represented as elements shown in a left hand pane of the graphical user interface 50, as well as in a summary diagram shown in a right hand pane of the graphical user interface 50, as discussed below and shown in additional figures. As shown in FIG. 4, a compensation plan utilizes data from a plan roster 22 that contains values of an entity for which plan metrics, earnings, and payment are to be calculated. In the example shown in FIG. 4, the entity in the plan roster 22 is that of “employee,” and each instance of the employee entity is identified by an employee ID number. The compensation plan 20 is made up of two different plan metrics 24, each representing a different measure of performance for the employee entity. The input to each one of the plan metric is from a sales and quota data table, which may be maintained in the CPM system 10 or maintained externally, such as in the data repository of an associated SPM system 14. The sales and quota data table includes the sales and quota information for each instance of the employee entity, for whom the plan metrics 24 are being calculated. The first plan metric 24 is labeled “calculate goal attainment” and performs a calculation of the sales/quota ratio. The second plan metric 24 is labeled “calculate oversell” and performs a calculation of the quota minus the sales amount. The results of the goal attainment plan metric calculation is then used as the input to the first plan component 26 labeled “determine tier earnings” to return a tier earnings value. The results of the calculate oversell plan metric 24 is used as the input to the second plan component 26 labeled “calculate commission” by multiplying the oversell value by a specified commission rate. The results of the first and second plan components 26 are then summed and placed into a payment table created by the CPM system 10 with the appropriate table structure, storing the payment due to each instance of the employee entity in the payment table.

FIG. 5 illustrates another exemplary compensation plan 20 as displayed to the end user via the graphical user interface 50. As shown in the left hand pane 52 of the graphical user interface, the user may define one or more compensation plans 20 and organize them in groups. In the example shown in FIG. 5, the user has created a folder named “Techno Comp Plans” in the left hand pane 52 that contains a compensation plan 20 named “Tech Rep Compensation.” If the “Techno” organization has additional compensation plans 20, such as compensation plans 20 for managers and executives, they can be created in the same folder for organizational purposes. As further shown in the left hand pane 52, the “Techno Rep Compensation” plan includes a number of plan metrics 24, including “Attainment 081,” “Oversell,” and “Attainment 082,” as well as a number of plan components 26, including “Commissioned Earnings,” “Tier Earnings 081,” and “Tier Earnings 082.” A flow diagram 56 is illustrated in the right hand pane 54 of the graphical user interface 50 to represent each element of the selected compensation plan 20 in a “Summary” tab of the graphical user interface 50. The summary flow diagram 56 includes a node or icon that visually represents the plan roster 22, which can be manually selected by the user to make changes to the plan roster definition or to process or run the plan roster individually apart from the rest of the compensation plan 20. Similarly, the summary flow diagram 56 includes a node or icon to represent each plan metric 24, and arrows connect each plan metric 24 to a node or icon that represents the plan component 26 which uses the plan metric output to perform an earnings calculation. The results of the plan components 26 are then summed and used as the input to the plan payment 28, which is also visually represented by a node or icon, and the plan payment 28 element of the compensation plan 20 then performs additional calculations on that data to produce the payment data for the instances of the entities specified in the plan roster 22. The arrows between nodes in the summary flow diagram 56 may be used to represent automatic predecessor relationships between plan elements. For example, a plan roster 22 is a predecessor to each plan metric 24, as the plan metric 24 must access the plan roster 22 to determine the instances of the plan earnings entity to calculate metric results for. Similarly, plan metrics 24 are predecessors to plan components 26 that use the plan metric's results as inputs data. Plan components 26 are in turn predecessors to the plan payment 28, which utilizes the plan components' aggregated earnings results to calculate the plan payments 28.

The graphical user interface 50 may be configured to guide the user through each step of creating/configuring a compensation plan 20 as described above. Each step may be represented by one or more plan configuration elements that may be presented as tabs and associated sub-tabs displayed in the right hand pane 54 of the graphical user interface 50, as shown in FIG. 5. These plan configuration elements and the options presented in each help guide the user through the plan creation process, yet are still extremely flexible in supporting a wide variety of specifications and calculations needed to create different types of compensation plans 20. The options and guidance presented in plan configuration elements may be context-specific, meaning that depending on how the user answers a questions or the type of information supplied in one plan configuration element, the subsequent plan configuration element may dynamically change to provide only relevant options and guidance. The compensation plan creation component 35a of the software 34 and the graphical user interface 50 may be configured to guide the user through creating a plan in order of plan period, plan entities, plan roster 22, plan metrics 24, plan components 26, and then plan payments 28. For each one of these plan elements, different plan configuration elements may be presented in the right hand pane 54 of the graphical user interface 50 as a series of tabs and associated sub-tabs. In this manner, a user can create and define a compensation plan 20 by going down each element in the left hand pane 52 of the graphical user interface 50, and for each of those elements, going across the tabs presented in the right hand pane 54. The summary flow diagram 56 showing each element of the compensation plan 20 may be displayed in the right hand pane 54 of the graphical user interface 50 after a user has defined every element of a compensation plan 20. Alternatively, the present CPM system 10 may be configured to allow the user to set up the structure of the compensation plan 20 by inserting the nodes or icons in the flow diagram 56 to represent each plan element, before specifying the details of each plan element. This allows the user to visualize the entire compensation plan 20 and what is required at each step before requiring the user to define each plan element in detail.

As further shown in FIG. 5, the plan configuration elements presented in the graphical user interface 50 may include the summary flow diagram element 58, a periods definition element 60, an entities definition element 64, a rosters definition element 68, a target earnings definition element 72, and a payments definition element 76, each presented as a tab in the right hand pane and each having additional sub-tabs. These plan configuration elements will be discussed in detail below and shown in the figures. As a broad overview, the periods definition element 60 may be configured to provide guidance, present options, and receive user input related to the calculation or payment frequency of a compensation plan 20 or specific plan elements. The entities definition element 64 contains similar functionality with respect to specifying the earnings entity and, in some cases, a different payments entity for the compensation plan 20. The rosters definition, target earnings definition, and payments definitions elements 68, 72, 76 each contains functionality with respect to defining a compensation plan's rosters, metrics, earnings, and payments.

The following discussion provides an overview of plan periods. The present CPM system 10 may guide the user through setting up each element of a compensation plan 20 in a logical order, starting with the plan period, then the plan entities, then the plan rosters 22, then the plan metrics 24, then the plan components 26, and finally the plan payments 28. However, the user may be permitted to deviate from this order, and go back and redefine a plan element after its initial configuration. The periods definition element 60 of the graphical user interface 50 may be configured to provide guidance, present options, and receive user input related to the compensation plan's payment frequency and effective periods. As shown in FIG. 43, the user may specify a payment frequency for which the compensation plan 20 may be run or processed to calculate payments. The periods definition element 60 may present the user with a number of preconfigured time units to choose from, such as, for example and without limitation, by month, quarter, fiscal quarter, fiscal year, semester, year, etc. The user may also be given the option of defining custom periods, which will be discussed in detail below, such as, for example and without limitation, by retail quarter or retail semester. The user may specify a start period and an optional end period for a compensation plan 20 to set boundaries for periods that the plan can be run for, the start and end periods being based on periods of plan payment frequency. This ensures that the compensation plan 20 is only being run for periods when it is effective, as there may be different “versions” of a compensation plan 20 as an organization updates or otherwise changes its plans over time. The present CPM system's support of different versions of a compensation plan 20 will be discussed below in detail.

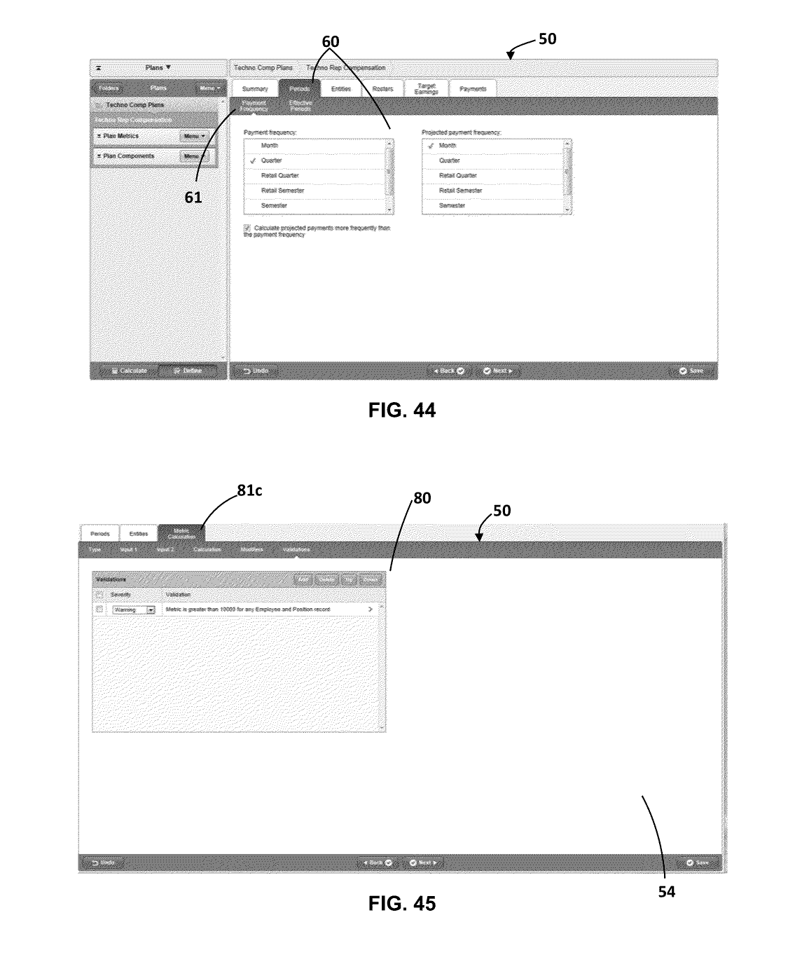

If the compensation plan 20 is to support projected payments that are calculated more frequently than the plan payment frequency, such as when an employee like a sales representative is paid quarterly, but is provided with monthly reports that show what the employee is on-track to make at the end of the quarter based on current performance, the user may specify a projected payment frequency by checking the box shown in FIG. 43. If the user elects to calculate projected payments, the options shown in FIG. 44 may be displayed via a “Payment Frequency” sub-tab 61 of the periods definition element 60. Given the options selected in FIG. 44, where projected payments are calculated each month and actual payments calculated every quarter, an example of the payments results table when the compensation plan is run for the month of January (the first month of a quarter) is shown below in Table 1. Assuming this is the first time the compensation plan 20 is being run, the CPM system 10 automatically crates and stores the payment results table, and populates it with earnings and payment data for the month of January, and indicates that this is a projected calculation by inserting the value “Y” into the “Projected” field. If the compensation plan 20 is rerun for the period of January or run for a subsequent period of February, the CPM system 10 may be configured to overwrite the results in Table 1 with the new earnings and payments calculations, or alternatively may append the new calculations to the first set of data. As shown in Table 2, when the compensation plan 20 is run for the payment period (the month of March, which is the last month of a quarter), the CPM system 10 may overwrite the results in Table 1 with the actual earnings and payments results for that quarter, and indicate that this is an actual payment by inserting the value “N” into the “Projected field.” The same payment results table may be maintained for subsequent periods, where the results from the end of the second quarter, third quarter, etc. would be appended to Table 2. Where the data from projected payment periods are not retained in the CPM system 10, the data for each projected payment period would be overwritten every time the plan is run, and only the data from the actual payment period at the end of the quarter would be saved in the CPM system 10 in the payment results table.

TABLE 1

| Employee | Employee | | | | Total | | | Payment |
|---|---|---|---|---|---|---|---|---|
| ID | Name | Month | Quarter | Projected | Earnings | Adjustment | Override | Due |
| 123 | Joe Smith | January | Q1 | Y | $1000.00 | | | $1000.00 |
| 234 | Sue Black | January | Q1 | Y | $500.00 | | | $500.00 |

TABLE 2

| Employee | Employee | | | | Total | | | Payment |
|---|---|---|---|---|---|---|---|---|
| ID | Name | Month | Quarter | Projected | Earnings | Adjustment | Override | Due |
| 123 | Joe Smith | March | Q1 | N | $4000.00 | | | $4000.00 |
| 234 | Sue Black | March | Q1 | N | $1500.00 | | | $1500.00 |

As discussed below, different elements of a compensation plan 20 may have different calculation periods than the overall compensation plan's payments. For example, a plan metric 22 that calculates a metric result and a plan component 24 that calculates an earnings result may be run at the same frequency as the overall compensation plan's payments, or at a lesser frequency. For example, a plan metric 22 and plan component 24 may be run and included in monthly plan payments only once a year to calculate an annual bonus amount. The period set for a plan metric 22 may also be used to automatically filter data being run through the plan 20 if the input data tables used in a plan metric 22 store data using effective dating or period options. As a further example, when defining a plan component 26, the user may utilize the periods definition element 60 to specify a plan component 26 earnings calculation period that is different from the plan payment 28 frequency. Where the plan payment 28 frequency is set to be “monthly,” the selected plan component 26 may be calculated at a lesser frequency and its earnings calculation included in the payment results on a quarterly basis. This may be desirable for compensation plans 20 with a quarterly bonus or other incentive program that is only paid out every quarter, even though regular compensation payments are made monthly. By giving the user the flexibility to specify different calculation periods for individual plan elements, the present CPM system 10 allows for implementation of a wide variety of plans while maintaining a business-oriented and intuitive setup interface.

As discussed above, in addition to preset time units that are presented to the user, the CPM system 10 may be configured to permit the user to specify custom time periods. To this effect, the present CPM system 10 may include, for example as part of the compensation plan creation element 35a of the software 34, a time unit definition element presented to the user via the graphical user interface 50 where the user indicates that a custom time unit is desired. Although an exemplary interface for the time unit definition element is not shown, one of ordinary skill in the art would appreciate that the user may specify custom time units in the present CPM system 10 using a variety of interfaces. For example and without limitation, the time unit definition element may include a number of elements displayed via tabs and sub-tabs in the right hand pane 54 of the graphical user interface 50. The available time units to be used in a compensation plan 20 may be listed in the left hand pane 52, and the user may add, edit, or delete a custom time unit. As an example, the user may configure a custom time unit for “Retail Quarter,” and may elect to start the retail quarter period on a different date every year. After selecting the basic properties of the time unit, the user may be guided to specify the periods contained in the “Retail Quarter” custom time unit and each period's name. The user may then be guided to specify the dates for the periods of the custom time unit each year. For example, if the user may select a year like 2012, then define the specific dates for each period of the custom time unit in the year 2012. The time unit definition element may allow the user to relate the periods of one time unit to the periods of another time unit, so that the two time units may be used in conjunction with one another in the compensation plan. For example, if a plan 20 is defined to have a payment frequency of “month,” it may contain a component with a calculation frequency of “retail quarter,” the custom time unit specified by the user. The CPM system 10 needs to know which period of the retail quarter time unit to run based on the month of the plan being run using the time unit relationship specified by the user. To create this relationship, the time unit definition element may present a list of the periods in the “month” time period (e.g., January, February, etc.) and allow the user to select which month matches up with which period in the “retail quarter” time unit (e.g., August—Retail Quarter 4 of the current year, September—Retail Quarter 4 of the current year, October—Retail Quarter 1 of the next year, etc.).

The following discussion provides an overview of plan entities. After specifying the periods of a compensation plan 20, the user may be guided to the next tab for the plan entities definition element 64 to specify the compensation plan's earnings entity—the person, place, or thing for which earnings are calculated. The values of each instance of the earnings entity are then stored in the earnings entity roster table, which will be discussed in detail below. Payments 28 in a compensation plan 20 are automatically calculated for the earnings entity by default, unless the user specifies a different entity as the “payment entity.” When a different payment entity is used for a plan 20, the user specifies an assignment table between the earnings and payment entities to determine which instance of the payment entity will be assigned the earnings calculated for each instance of the earnings entity, and the values of the earnings entity and assigned values of the payment entity are then stored in the earnings to payments entity roster table. The user may utilize the entities definition element 64 to specify the earnings entity for a compensation plan 20, and if applicable, a different payment entity. If the CPM system 10 is using the special entities defined in U.S. patent application Ser. No. 13/602,423 or associated with a larger SPM system 14 that utilizes such entities, the entities definition element 64 may be configured to display preconfigured entities that are available to the user for selection, those entities having specific entity tables and assignment tables that may be utilized by the CPM system 10. Alternatively, the user may also be permitted to specify other business units that do not have associated entity tables as the earnings and/or payment entity, provided that those business units are used in data tables with the proper format to be used by the present CPM system 10. The use of different earnings and payments entities in the present CPM system 10 is yet another way of giving the user wide flexibility in configuring the compensation plan 20, as different industries may require different earnings and payments calculations in their compensation plans 20, and the present CPM system 10 is designed to accommodate such diverse plans while maintaining its business-oriented and intuitive approach.

As discussed in detail below, a compensation plan's metric results and earnings are calculated for the plan's earnings entity by default, but may be calculated at a more detailed level by specifying additional entities and fields as the “calculation entity” in a plan metric 24 or plan component 26 definition. For example, a plan metric 24 or component 26 may calculate metric results and earnings not only for each instance of the earnings entity, but for combinations of each instance of the earnings entity and a different entity or field selected as the calculation entity. If earnings of a compensation component are calculated at a more detailed level than the plan's earnings entity, the earnings results will be aggregated to the plan's earning entity in plan component 26 calculations (e.g., earnings calculated for combinations of the “employee” and “position” entities may be aggregated to the “employee” earnings entity). The calculation entity specified for a plan component 26 must match the calculation entity for any plan metrics 24 used by the plan component 26 for input data. For example, if a compensation plan's earnings and payments entity is set as “employee,” any data used as input into a plan metric 24 for that plan must at least be identified by instances of the “employee” entity, but the actual calculation performed by the plan metric 24 may be more detailed. To further illustrate the example, where calculations of employees' quota attainment is desired, and the input data to a plan metric 24 with the additional calculation entity “product,” the incoming sales data must include fields for the employee ID and product ID, or other identifying information for each instance of the “employee” earnings entity and the “product” metric calculation entity. This allows the plan metric 24 to calculate metric results not only for each employee, but for each employee broken down by products sold by the employee. If the results of this plan metric 24 are then used as the input to a plan component 26, the plan component 26 must also be defined to include “product” as an earnings calculation entity to properly utilize the metric results.

The following discussion provides an overview of plan rosters 22. One of the building blocks or elements of a compensation plan 20 is the plan roster 22, which includes the list of entity values that identify who or what a plan's calculations can be run for. A plan roster 22 can include one or two separate rosters. Specifically, a compensation plan always includes an “earnings roster” 23a, which lists the values of an entity for which plan earnings are calculated for. During the configuration of a compensation plan 20, the user must specify an entity as the “earnings entity,” for which the CPM system 10 will create an earnings roster table to store the values of the earnings entity. An earnings roster table may be generated using the entity table for the earnings entity, or may be generated by using an assignment table that represents an assignment relationship between the earnings entity and another entity. This is an example where the use of special entities as defined in U.S. patent application Ser. No. 13/602,423 is advantageous, as the relationships between those entities may be defined in special assignment tables that can be utilized by the CPM system 10. For example, where the earnings entity is specified as “territory,” the present CPM system 10 may use an assignment between the “territory” entity and a specific “area” that the territory is assigned to, as to generate an earnings roster table that only includes territory values that are assigned to the “northeast” area. If a compensation plan's payments are to be made to the same entity that earnings are calculated for, then the payment entity is the same as the earnings entity, and the plan roster 22 only includes one entity and the CPM system 10 only generates one roster table—the earnings roster table. However, in certain circumstances a plan's earnings are calculated for one entity, but the actual payments are made to another entity. In this case, the user may specify a different payment entity during the plan roster definition step of creating the compensation plan 20, and an additional “earnings to payments” roster 23b table is generated by the CPM system 10 that includes the values of the earnings entity and corresponding values of the payment entity in an assignment relationship. For example, in the pharmaceutical industry, earnings are generally not calculated for each individual sales representative, but instead for a territory or position that the sales representative is assigned to. However, payments must be made to the sales representative as compensation, so an assignment relationship is used between the “territory” or “position” as the earnings entity and the “sales representative” as the payment entity.

Instead of utilizing an existing table in the CPM system 10 or an associated SPM system 14 as the earnings roster 23a table or the earnings to payments roster 23b table, the present CPM system 10 may be configured to generate the earnings roster table, and when applicable, the earnings to payments roster table on demand when a plan roster 22 is defined by the user, or alternatively when it is processed or run for the first time, either as part of a complete compensation plan 20 or manually as a single element. After a roster table has been generated by the system, it is maintained within the system and when the roster 22 or entire compensation plan 20 is redefined or run again, the roster table is updated accordingly. This is advantageous in that the user does not need to create these roster tables separately from the compensation plan definition process, or modify an existing table to be in the right form to be used with the CPM system 10. Instead, as the user is guided through the plan definition process and makes selections relating to the plan roster 22, the CPM system 10 automatically creates the necessary roster tables with the proper table structure according to the user's inputs and maintains them within the system in the proper format to be used by other elements of the compensation plan 20. Depending on the entity that the user selects as the earnings entity or payment entity, the compensation plan creation element 35a of the software 34 and the graphical user interface 50 may present the user with entity-specific choices and specifications as the user is guided through the definition of other plan elements.

As discussed above, the compensation plan creation element 35a of the software 34 and the graphical user interface 50 may operate in conjunction to provide guidance, present options, and receive user input to create or modify a compensation plan 20 in the present CPM system 10. Specifically, the graphical user interface 50 may be configured to provide a wizard or setup assistance interface that presents the user with a sequence of plan configuration elements for defining each building block of the compensation plan 20. For example and without limitation, the user may utilize the left hand pane 52 of the graphical user interface 50 to add a new folder of compensation plans 20 or a single compensation plan 20 that is organized in a folder or individually, by using the menu button shown at the right top hand corner of the left hand pane 52, as shown in FIG. 5. The menu button may display a drop down menu when selected, which gives the user the option of adding a folder of compensation plans 20 or a specific plan 20, each of which may be given a custom name by the user. The user may then continue to use the left hand pane 52 to add a plan metric 24 by using the menu button shown next to the “Plan Metrics” label. Similarly, the user may use the left hand pane 52 to add a plan component 26 by using the menu button shown next to the “Plan Components” label. As a new plan metric 24 or plan component 26 is added, the user may give it a custom name and then specify the details of the plan metric 24 or component 26 using plan metric definition elements 80 or plan component definition elements 84 presented as tabs and sub-tabs in the right hand pane 54. The CPM system 10 may be configured to require the user to specify the details of each plan metric 24 or component 26 as it is created, to ensure that the definition is correct and in line with any preceding or subsequent plan element. Alternatively, the user may be permitted to lay out the basic framework of the compensation plan 20 first by defining various plan metrics 24 and components 26 and seeing how they are laid out in the summary flow diagram 56 and then defining the details of each plan element.

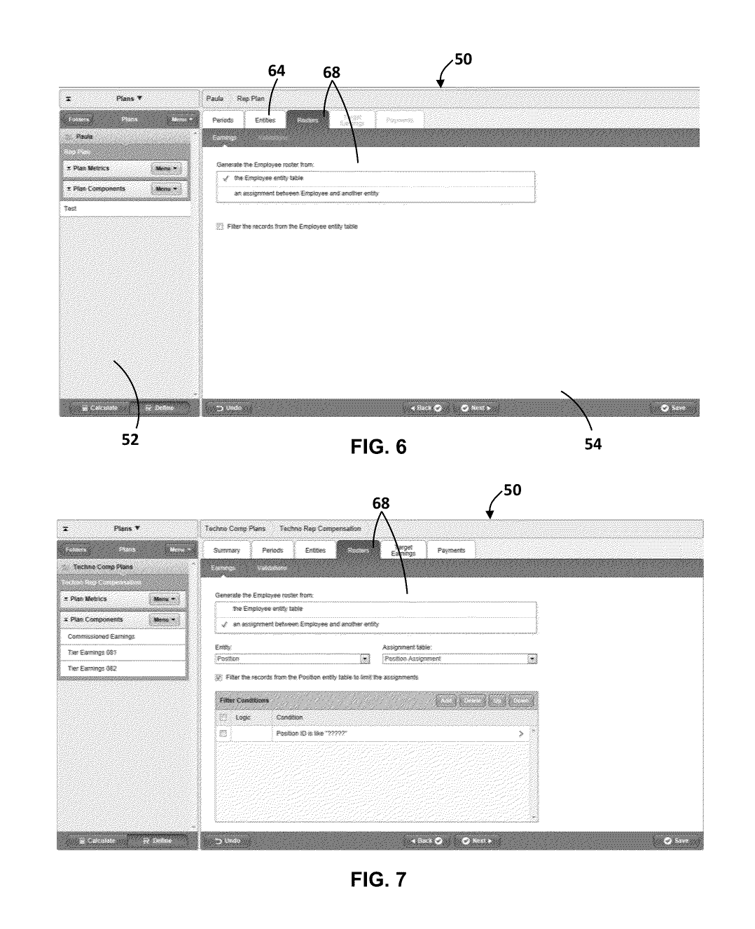

As shown in FIG. 6, the graphical user interface 50 may include a roster definition element 68 that is presented to the user as a tab displayed in the right hand pane 54. The roster definition element 68 may be configured to provide guidance, present options, and receive user input regarding the entity to be specified as the earnings entity and how to populate the earnings entity roster 23a table. In the example shown in FIG. 6, the user has previously selected “Employee” as the earnings entity using an entity definition element 64 that is also presented as a tab. Because of that selection, the roster definition element 68 dynamically incorporates that into the options presented to the user for how the employee earnings roster table should be generated. If the user selects the first option to generate the earnings roster table from the employee entity table, as shown in FIG. 6, the user may further elect to apply a filter to records that should be pulled from the employee entity table to populate the earnings roster table by checking a box, so that additional options may be displayed to the user to filter records in the employee entity table by a constant value or by another field in the employee entity table. For example and without limitation, the user may choose to filter the employee entity table by only full time employees, so that the earnings roster table only contains values of the employee entity that are working full time for whom earnings should be calculated for under the selected compensation plan 20.

In the example shown in FIG. 7, the user has selected the second option to generate the employee earnings roster 23a table by using an assignment relationship between the “employee” entity and another entity. As discussed above, the relationship between those entities is represented by a special assignment table that already exists in the CPM system 10 or in an associate SPM system 14 or other database. This allows the user to populate the earnings roster table using an existing assignment between the earnings entity and another entity. This option is generally used when the values of the earnings entity to be inserted into the earnings roster 23a table is limited by its relationship to the other entity that changes over time, since assignment tables can be effective for a range of dates or periods. As shown in FIG. 7, the earnings entity is “employee,” and the user opts to generate the employee earnings roster table from an assignment between the “employee” entity and the “position entity” by using an existing “Position Assignment” assignment table, which for the purposes of this example contains two different types of position IDs: those with numbers that are 3 digits long, and those with numbers that are 5 digits long. The rosters definition element 68 of the graphical user interface 50 may be configured to allow the user to make selections using dropdown menus, as shown in FIG. 7, which lists all available entities and corresponding assignment tables for ease of reference. The user is further given the ability to filter the records from the position entity table to limit the assignments, by specifying one or more conditions in the “filter conditions” section of the rosters definition element 68. As shown in FIG. 7, the user has selected to filter the assignment by only selecting positions having five numerical digits (which represents a specific “type” of position), this allows the values in the employee earnings roster table to be narrowed down to only those employees with position IDs that have five digits.

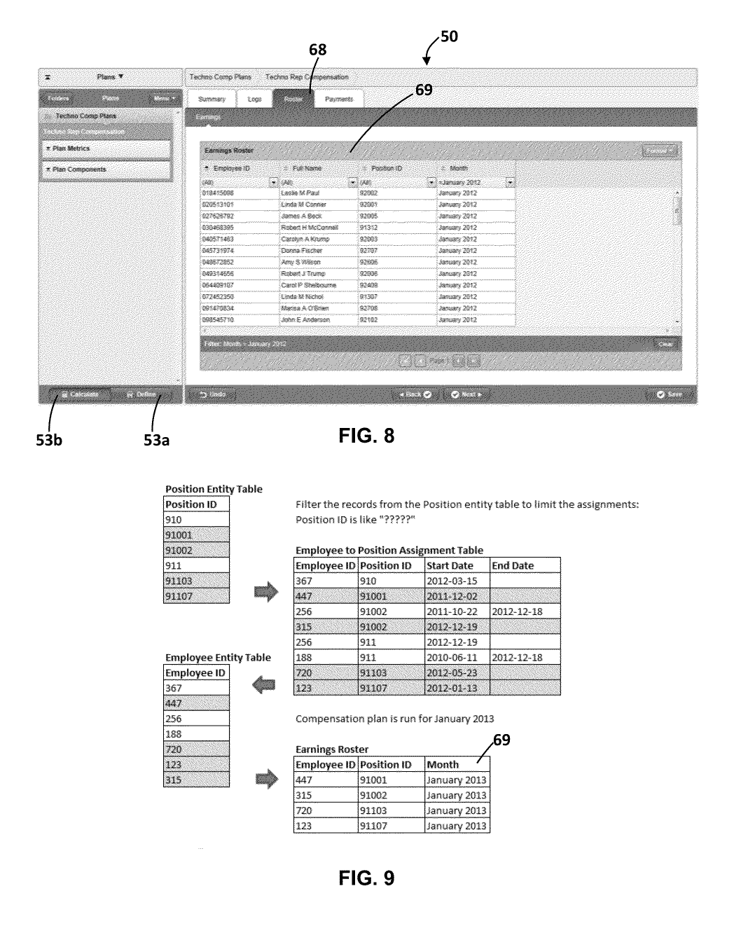

As shown in FIG. 8, once the user defines the earnings roster 23a with the specifications shown in FIG. 7, or after that earning roster 23a has been run individually or as part of the overall compensation plan 20, the CPM system 10 automatically creates an earnings roster table 69 for the “employee” entity in which the values of the employee entity has been filtered by five-digit position IDs. The process by which the earnings roster table 69 shown in FIG. 8 is generated using an assignment between “employee” and “position” is further shown in the diagram of FIG. 9. If the assignment table's records are effective dated to indicate that the assignment relationship is only valid during a specific time period, as shown in the assignment table of FIG. 9, then the CPM system 10 may be configured to only use assignments that are valid for the plan payment period specified by the user. Accordingly, even though the third record in the assignment table for Employee ID 256 has a Position ID of 91002, which satisfy the filter condition shown in FIG. 7, this instance of the employee entity is not present in the earnings roster table 69 because the compensation plan's payment period is specified to be January 2013, and the assignment relationship between Employee ID 256 and Position ID 91002 was only valid until Dec. 18, 2012. The earnings roster table 69 shown in FIG. 8 also includes a field that stores the period that each record in the roster table was generated for, i.e., the period for which the plan roster 22 or compensation plan 20 was run. The user may access the earnings roster table 69 by navigating away from the compensation plan creation element 35a of the graphical user interface 50, which may be accessed by the “Define” button 53a shown on the bottom of the left hand pane 52. By selecting the “Calculate” button 53b shown in the left hand pane 52, the user may navigate to a compensation plan processing element 35c, which may include a roster element displayed as a tab that is configured to display any earnings and/or earnings to payments roster tables that the CPM system 10 has generated.

The present CPM system 10 may be configured to require that records in plan rosters 22 match the input records for all other plan elements, such that if a record from an input does not match a record in the plan roster 22, the record is not run through when the plan element is processed. Input records are run through plan metrics 24 and plan components 26 only if they match the roster records for the period being run, based on the values of the earnings entity. For example, if a compensation plan 20 includes a plan metric 24 and plan component 26 that calculates the metric and earnings for employee #123 in January 2013, then there must be a record in the earnings roster table 69 for employee #123 in January 2013. If input records are missing for one or more of the plan rosters 22 being run, then the CPM system 10 may be configured to return an error message or similar alert and stop the processing of the compensation plan 20. Alternatively, the CPM system 10 may be configured to still complete plan calculations for the roster records for which input data does exist. In this case, the compensation plan 20 will complete with errors, which may be recorded in an error log, and may further notify the user of the roster records for which input values were missing and thus for which calculations were not performed. If none of the roster records being run have input values, the CPM system 10 may simply notify the user that processing of the plan has failed because plan calculations could not be performed for any of the roster records.

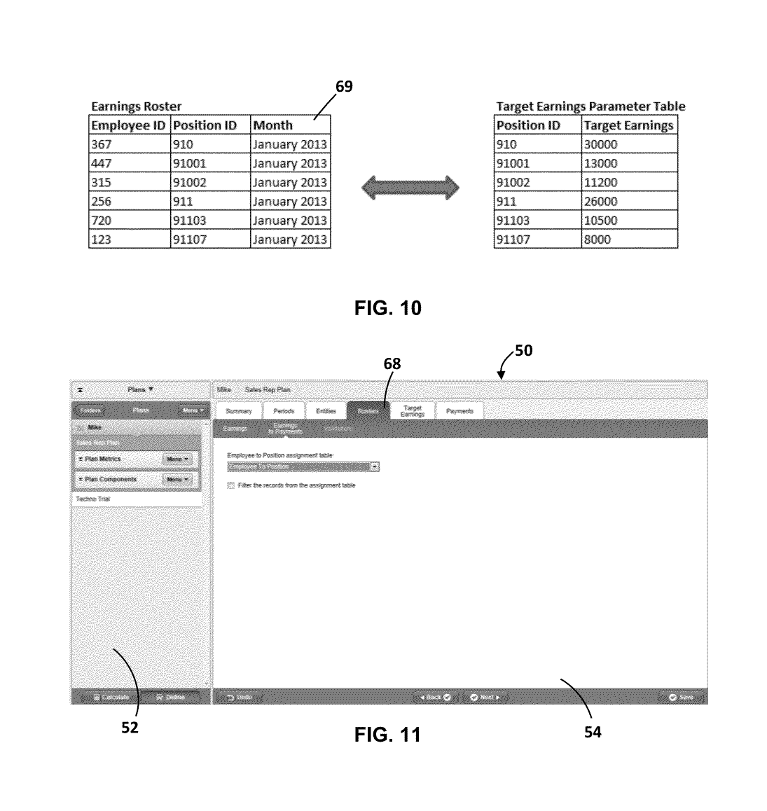

When a user is deciding whether to generate an earnings roster table 69 from an entity table or an assignment table between different entities, there are various considerations that should be taken into account. If the assignment table's records are stored by effective dates or periods, the CPM system 10 may be configured to filter the assignment table for records that are valid during the compensation plan's payment period, even if the plan calculates projected payments, which will be discussed in detail below. If an earnings entity has multiple assignments for a compensation plan's payment period, the CPM system 10 may be configured to utilize only one of the matching assignment records in the earnings roster table 69, such as the most recent assignment record. Alternatively, the CPM system 10 may be configured to return an error message and/or stop the processing of the plan roster 22 when confronted with such a scenario. When an entity table is used to generate the values of an earnings roster table 69, the fields from that entity table may also be used in another type of table created by the CPM system 10 on an as-needed basis, known as plan parameter tables. Parameter tables will be discussed in detail below, and are defined by the user directly within a compensation plan 20 to store specific parameter values to be used in calculations. Where an entity table is used to generate the earnings roster table 69, the CPM system 10 needs to be able to select the appropriate parameter values to be used in calculations for each roster record that the compensation plan 20 is run for. As shown in FIG. 10, where an earnings roster table 69 is generated using an assignment between the “employee” and “position” entity, fields from both entity tables are available to use to store target earnings values in a target earnings parameter table. However, if the earnings roster table 69 is generated using only the employee entity table, then target earnings values in the target earnings parameter table can only vary by employee. As described in detail with respect to the entity concept in U.S. patent application Ser. No. 13/602,423, an entity table often includes entity attribute fields containing entity attribute values that are descriptive of, but do no uniquely identify, each instance of the entity. This type of data may be used in earnings attributes fields of the earnings roster table 69 that contain additional “attributes” of the earnings entity or assignment entity used to generate the earnings roster table 69. In the example shown in FIG. 10, because an assignment was used to generate the earnings roster table 69, the earnings entity “employee” and the additional entity “position” from the selected assignment table are present in the earnings roster table 69. The user may configure the earnings roster table 69 to contain additional earnings attribute fields to store other entity attribute values of the earnings entity or assignment entity, such as by using a graphical user interface element provided as part of the rosters definition element 68 that allows the user to select attribute fields from each entity table to be included in the earnings roster table 69. To continue with the previous example, if the “position” entity table contains an additional entity attribute field that identifies the compensation level of each position, such as shown below in Table 3, the user may elect to include the “Compensation Level” field in the earnings roster table 69. This may be done to help identify records in the earnings roster table 69 to be more easily identifiable by the user, or because values of this additional attribute is needed for a plan parameter table. For example, rather than having to define a target earnings parameter table in which the target earnings varies by instances of the Position ID, the target earnings parameter table may be configured so that the target earnings varies by each instance of the Compensation Level.

TABLE 3

| Position ID | Compensation Level |
|---|---|
| 910 | 8 |
| 91001 | 4 |
| 91002 | 3 |
| 911 | 9 |
| 91103 | 4 |

In the present CPM system 10, the earnings roster table 69 preferably contains the following data fields: the earnings entity (the entity specified as the earnings entity for the plan, the values in this field may be the explicit entity ID that serves as a unique identifier of each instance of the earnings entity); the assignment entity (if the earnings roster table was generated using an assignment between the earnings entity and another entity, the values in this field may also be an explicit entity ID that identifies each instance of the assignment entity); the payment period; the projected payment period (this may be displayed only where a compensation plan is calculating projected payments for a period that is different from the actual payment period); the projected payment indication (usually contains a value of “Y” or “N” to indicate whether a row of data is being calculated for a projected payment period); and any additional attributes of the earnings and/or assignment entities that were selected by the user.

As discussed above, where the earnings entity is also the payment entity, the plan roster 22 only includes an earnings entity roster table 69. However, where the payment entity is different from the earnings entity, an additional “earnings to payments” roster table 70 (sometimes abbreviated as a “payments roster table”) must be created by the CPM system 10 as the user defines the payment entity roster or once the payment entity roster/compensation plan 20 is processed. The earnings to payments roster table 70 is only generated by the CPM system 10 if the earnings and payments entities are different, and contains both the values for the earnings entity and the corresponding values of the payments entity. To populate values of the earnings to payments roster table 70, the CPM system 10 may utilize a preexisting assignment table that contains assignments between instances of the earnings and payments entities. As shown in FIG. 11, the roster definition element 68 of the graphical user interface 50 may include an “earnings to payments” sub-tab that is only presented to the user if the user indicated at a previous step that a different payment entity is being used in the compensation plan 20. In the example shown in FIG. 11, the user has previously indicated that the earnings entity is “position” and the payments entity is “employee” using the entities definition tab, so the earnings to payments sub-tab automatically asks the user to select the relevant employee to position assignment table to use to generate the earnings to payments roster table 70. As discussed previously with respect to the earnings roster table 69, the user is also given the option of filtering the records from the assignment table. If the user selects this checkbox, additional elements will be presented to the user to determine how the records should be filtered.

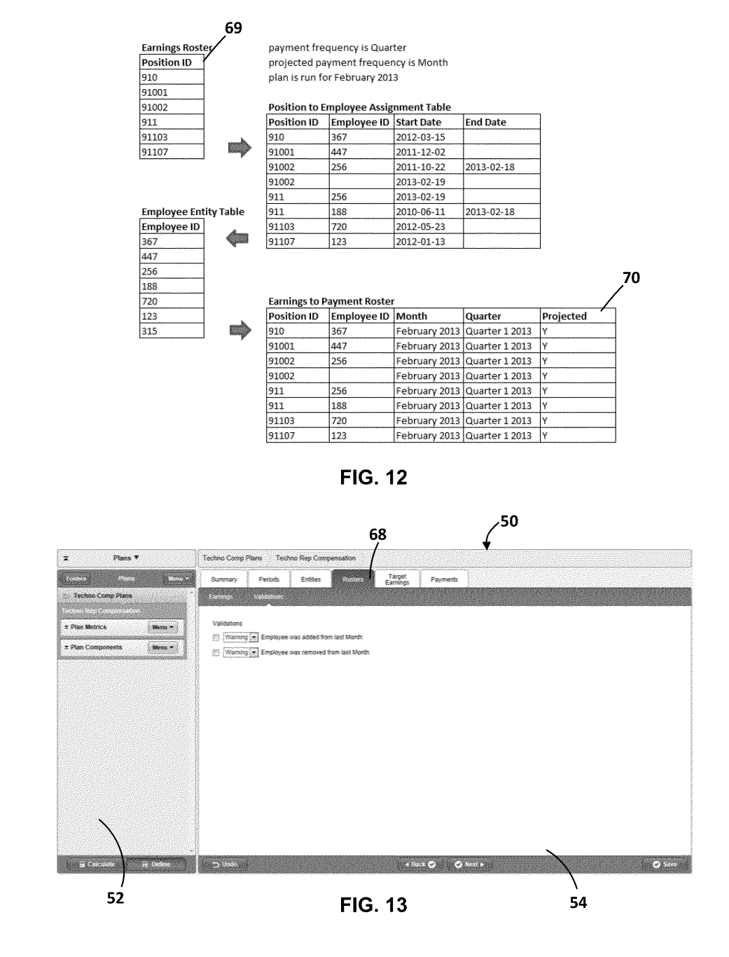

FIG. 12 is a diagram that illustrates how an earnings to payment roster table 70 according to the previous example can be automatically created and populated with the appropriate data values by the CPM system 10. The earnings roster table 69 contains the values for the “position” entity, each instance of which is identified by a unique Position ID. Given a compensation plan 20 payment frequency of every quarter (meaning that payments are made quarterly), and a projected payment frequency of every month (meaning that even though employees are only paid every quarter, the plan may be run every month to determine employees' projected payment at that month), and assuming that the compensation plan 20 is being run for the time period of February 2013, the CPM system 10 utilizes a pre-existing Position to Employee assignment table that is effective dated to determine the values of the employee entity that corresponds to each value of the position entity in the earnings roster table 69. The CPM system 10 then creates the earnings to payments roster table 70 and populates it with values of the proper instances of the earnings entity and the payments entity, automatically excluding any assignments that fall outside of the time period for which the plan is being run for. The earnings to payments roster table 70 may include the following data fields: the earnings entity (the values may be the explicit entity ID that serves as a unique identifier of each instance of the earnings entity); the payment entity (the values may be the explicit entity ID that serves as a unique identifier of each instance of the payments entity); the payment period; the projected payment period (this may be displayed only where a compensation plan 20 is calculating projected payments for a period different from the actual payment period); a field that identifies whether the plan is being run for a projected payment period as opposed to an actual payment period (e.g., with values of Y for “projected,” and N for “not projected”); and any additional attributes of entities that were selected by the user using the earnings to payments sub-tab shown in FIG. 11, which may contain a similar interface as the earnings attributes sub-tab. If the assignment table's records are stored by effective dates or periods, as shown in FIG. 12, the CPM system 10 may be configured to automatically filter the assignment for records that are valid for the compensation plan's payment period, even if the plan is being run to calculate projected payments. An assignment table used to generate the earnings to payments roster table 70 should only contain one assignment for each earnings entity. If multiple assignments are found, the CPM system 10 may be configured to assign full earnings amount to each entity assigned to the earnings entity, and/or generate an error or warning for the user. For example, if the earnings entity is “position” and the payment entity is “employee,” and two different employees are assigned to the same position at the same time, when the compensation plan 20 is run the earnings for the position will be assigned to both employees. If an earnings entity does not have an assignment to a corresponding payment entity in the assignment table, the CPM system 10 may be configured to populate the earnings to payments roster table 70 with empty values in the fields for the payment entity.

FIG. 17 illustrates an exemplary earnings to payments roster table 70, which is being presented in the compensation plan processing element of the graphical user interface 50. This earnings to payments roster table 70 contains all the values of the territory entity from the earnings roster table 69, as well as the employees assigned to each territory. In this example, earnings are calculated for each territory, but payments are made to the employees assigned to the territories. The earnings to payments roster table 70 also includes a field containing the period for which the plan was run and the roster information generated for.

After configuring the earnings roster 23a, and when necessary, a payments roster 23b, the user may be guided to specify one or more validations for the plan roster 22. As shown in FIG. 13, the compensation plan creation component 35a of the software 34 may display via the graphical user interface 50 a validation sub-tab within the roster definition element 68. Like many of the other plan configuration elements described in this application, the roster validation definition element 68 shown in FIG. 13 presents the user with a set of business-oriented questions and options to aid in configuring a compensation plan 20 in an intuitive and easy to understand fashion. Rather than having to configure separate validations on plan results, including the results of the plan roster 22, from a separate application outside of the CPM system 10 or by manually validating the results of the plan roster table and other results tables, the present system allows the user to configure logical validations from within the compensation plan 20 during initial configuration by answering the simple business questions indicated in the roster validation definition element. For plan rosters 22, logical validations include flagging instances of the earnings entity (“employees” in the example shown in FIG. 13) who were added to or removed from the compensation plan 20 relative to the prior period of the plan. The user may choose whether to perform these validations when generating the earnings roster 23a, and if so, can further choose whether the process will complete with warnings or errors if such situations are encountered. The difference between completing with warnings versus errors is relevant to additional processes that may require the plan roster 22 process as a predecessor, where the user may use the warning/error status to dictate whether the additional subsequent process should or should not run depending on the status of the plan roster 22 process. Although not shown in FIG. 13, the roster validations element 68 may also include an interface that allows the user to create custom validations, which may be performed as the earnings roster 23a is being generated or afterwards. One of ordinary skill in the art would appreciate that there are numerous ways of making custom validations available to the user.

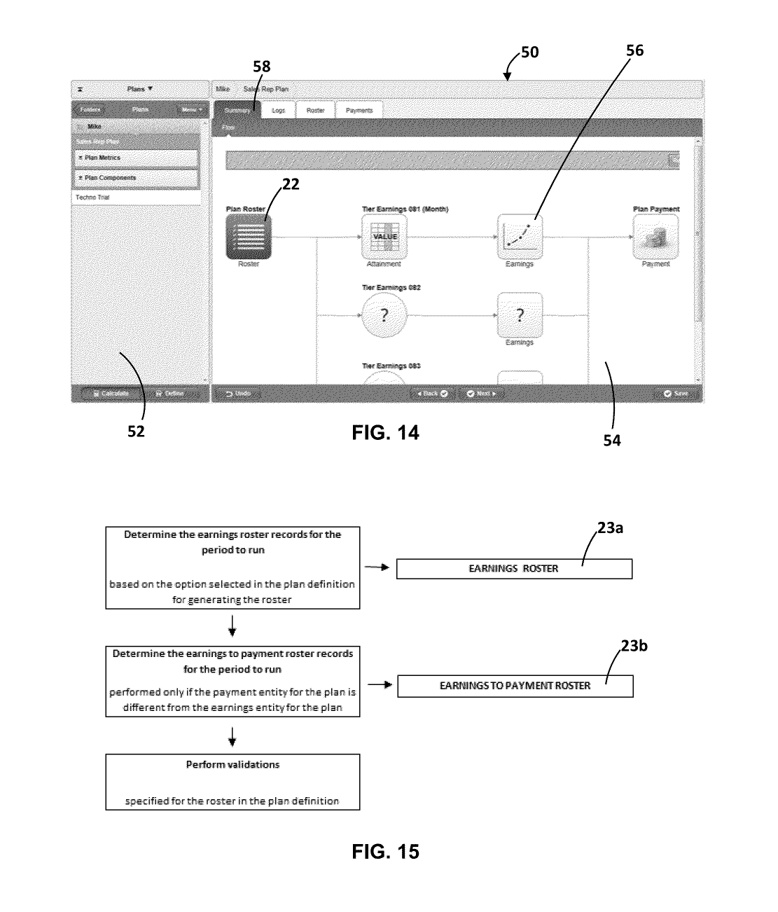

As discussed above, each element of a compensation plan 20 may be processed or run by itself or as part of the entire compensation plan 20. Accordingly, the plan roster 22 may be selected by the user to be run individually, or along with other plan elements when the entire compensation plan 20 is ran manually by the user or as part of an automated process. The plan roster 22 is a predecessor to all other plan elements that are run, meaning that the plan roster 22 controls what input records can be run through the other plan elements, as discussed above. The CPM system 10 may be configured to automatically create and populate the roster tables 69, 70 when a plan roster 22 is run for the first time, and to update the roster tables 69, 70 every subsequent time the plan roster 22 is run. As shown in FIG. 14, using the summary flow diagram 56 shown in the right hand pane 54 of the graphical user interface 50, the user may run the plan roster 22 individually by selecting the “calculate” option shown at the bottom of the left hand pane 52 (when defining the compensation plan 20, the user would select the “define” option instead), and then selecting the plan roster 22 icon in the flow diagram 56 (indicated by highlighting of the plan roster 22 icon), and then running the plan roster 22 by clicking on a “run” button displayed in the right hand pane 54.

As shown in FIG. 15, when the plan roster 22 is processed or run, either individually or as part of the overall compensation plan 20, the CPM system 10 first determines the specific records for the earnings roster 23a for the period that the roster is being run for, based on the options that the user selected when defining the plan roster portion of the compensation plan 20. If this is the first time the plan roster 22 is being run, the system creates the earnings roster table 69 with the appropriate table structure and populates the earnings roster table 69 with the records of the earnings entity for that period. If the plan roster 22 has previously been run, the earnings roster table 69 already exists in the system, and the system would either replace the existing records or append them with the records of the earnings entity for the new period. If the compensation plan's payment entity is different from the earnings entity, the CPM system 10 then determines the specific records for the earnings to payments entity roster 23b, by using the records from the earnings roster table 69 and the assignment table specified by the user during the roster definition step of plan configuration. The CPM system 10 then determines the instances of the payment entity that is assigned to each instance of the earnings entity in the earnings roster table 69, and creates or appends the earnings to payments roster table 70 and populates that table 70 with the appropriate records of the payment entity. If any validations were specified by the user for the plan roster 22 during the roster definition step of plan configuration, the CPM system 10 performs those validations on the roster records. For any validation that fails, the CPM system 10 may be configured to record an error message in an error log and assign the severity of the error selected by the user when setting up the validation.

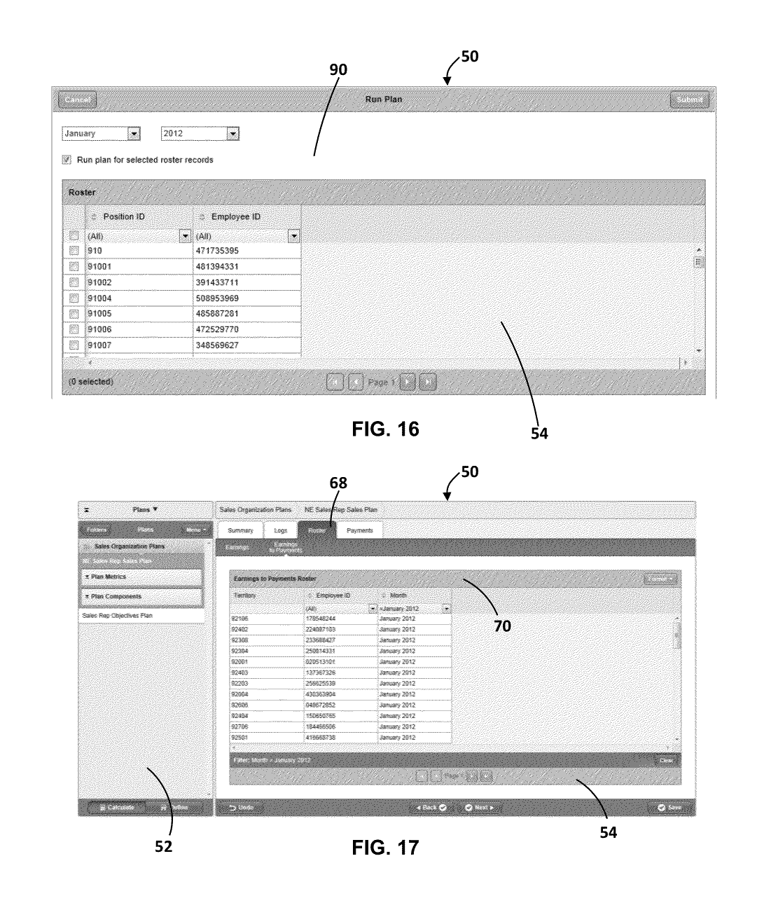

Once a plan roster 22 has been configured for a compensation plan 20 and run at least once, the compensation plan 20 may be run for only selected roster records. As shown in FIG. 16, the user may do so by utilizing a compensation plan processing element 90 of the graphical user interface 50, which may be presented in the right handle pane 54 once the user elects to run a compensation plan 20. Using the compensation plan processing element 90, the user may specify what period a plan 20 is being run for, and whether the plan 20 should be run for only selected roster records instead of the entire roster 22. If the user checks the “run plan for selected roster records” option, the plan processing element 90 may dynamically present additional roster information as shown in FIG. 16, which displays the previously generated plan roster 22 and allows the user to check off the specific records to run the plan 20 for. When running a plan 20 for selected roster records, the CPM system 10 attempts to update the selected records in the plan roster tables 69, 70 before running other plan elements, regardless of whether the plan roster 22 was specifically selected to run or not. If a selected roster record is no longer valid, such as if it does not meet the criteria to be included in the roster 22, then the plan roster process will fail and no other plan elements will be processed. In order to remove an invalid record from the roster tables 69, 70 and plan results tables, the entire compensation plan 20 must be rerun (i.e., all plan processes within the compensation plan).

The following discussion provides an overview of plan metrics 24, which is another one of the building blocks or elements of a compensation plan 20. A plan metric 24 uses input data that is generally related to sales or performance and performs a calculation to produce a metric result, which may be a measure of an entity's performance. A compensation plan 20 may include one or more plan metrics 24, each being defined as a separate element within the plan 20. A plan metric's metric result output may be used as in the input data for one or more plan components in the same compensation plan 20 in which the plan metric 24 is defined. While a metric result may be used as the main input for a plan component, it may also be used as the input for an earnings modifier, which will be discussed in detail below. The compensation plan creation element 35a of the software 34 and the graphical user interface 50 may present the user with plan metric definition elements 80, which are configured to provide guidance, present options, and receive user input related to creating and configuring one or more plan metrics 24. The user's specifications for a given plan metric 24 determine how the metric result that represents a measure of performance is calculated. The user may specify a metric calculation frequency, which determines what periods metric results can be generated for. The user may also specify a metric calculation entity, which determines what entity or business unit a plan metric's results are being calculated for, such as territories, products, territory and product combinations, etc. The user may further specify a metric calculation type, which determines the type of input data used by the metric and the specific calculations it performs.

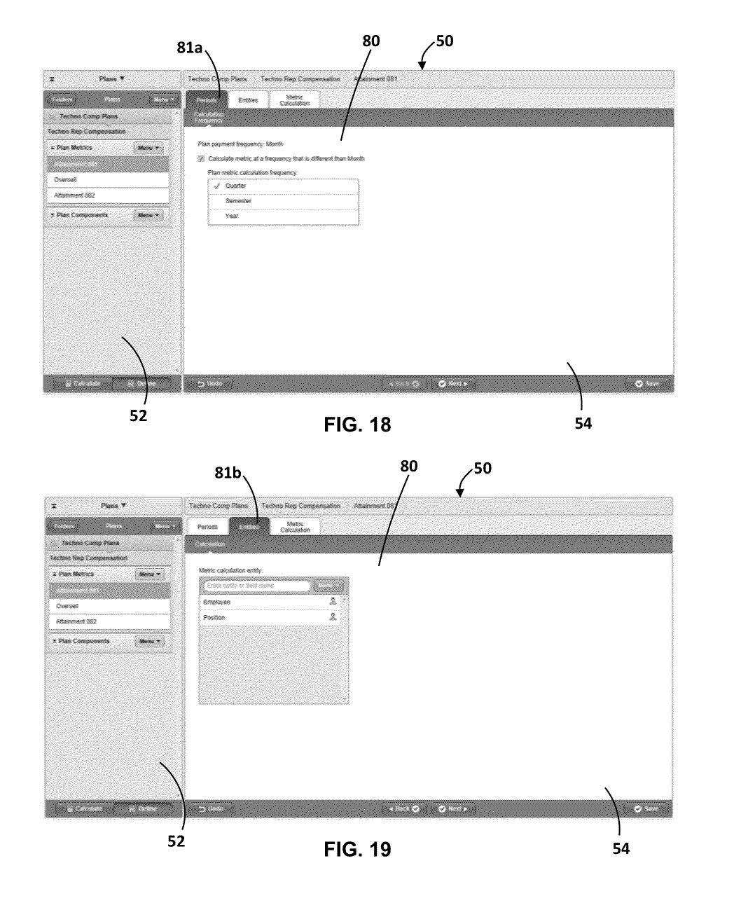

As discussed above, a plan metric 24 may be added to the compensation plan 20 by using a dropdown menu on the left hand pane 52. Once a plan metric 24 has been added, the user may configure that plan metric 24 using the plan metric definition element 80 shown in the right hand pane 54, which may include a number of tabs and sub-tabs to guide the user through the configuration process. As shown in FIG. 18, the plan metric definition element 80 may include a “Periods” tab 81a containing information regarding the metric calculation frequency. In this example, the plan payment frequency has previously been indicated as being “month” by the user. By default, every plan metric 24 in a compensation plan 20 will be calculated at the same frequency as the plan payment frequency, or specified projected payment frequency, if applicable. If the user wants the ability to calculate a plan metric 24 at a different frequency from the plan payments 28, the user may select the checkbox, which leads to additional options being made available as shown in FIG. 18. Using these additional options, the user may specify how frequently the selected plan metric 24 should be calculated, such as by quarter, semester, or year. The CPM system 10 may be configured so that a user can only select to calculate plan metrics 24 at a lesser, but corresponding, frequency than the plan payment 28 frequency. For example, if a plan 20 calculates payments monthly, a plan metric 24 may be run and calculated, and the metric result included in the payments data, only once a year to reflect a yearly bonus that's added to the payments. The frequency of the plan metric 24 (annually) corresponds to the frequency of the plan payments 28 (monthly) because the period of the metric 24 can be determined by the period of the payments 28. The plan metric 24 should not have a period that is more frequent than the plan payments 28, since the results of the plan metric 24 is used as the input to the plan component 26 that affects the plan payment 28, and multiple plan metric 24 results within a single plan component 26 earnings calculation period will mean that the system 10 will be unable to determine which plan metric result should be used for the earnings calculation and the subsequent payments calculation.

As shown in FIG. 19, the plan metric definition element 80 may further include an “Entities” tab 81b relating to specifying the metric calculation entity for the selected plan metric 24 being configured. This allows the user to specify what entity, business unit, or other record represented in a data field the plan metric 24 is being calculated for. By default, a plan metric's calculation entity will be the same as the compensation plan's earnings entity. The user may then specify additional entities and fields as the metric calculation entities in order to calculate metric results at a more detailed level than just for each instance of the earnings entity. The CPM system 10 may be configured to require that the calculation entity for a plan metric 24 is identical to the calculation entity of any plan component 26 that uses that plan metric's metric results as an input to the plan components 26 for earnings calculations. This ensures that the input data to the plan component 26 makes sense with respect to the earnings calculation. In the example shown in FIG. 19, the user has selected both the “employee” entity and the “product” entity as the metric calculation entities, meaning that the plan metric 24 utilizes data associated with both entities to calculate metric results at a detailed level for combinations of employees and products. The “Entities” tab 81b of the metrics definition element 80 is an example of how the present CPM system 10 and associated compensation plan creation element 35a provides a wide degree of flexibility for the user in creating compensation plans 20. Using the graphical user interface 50 shown in FIG. 19, the user may define the calculation for a selected plan metric 24 at any level of detail that is required, either for purposes of showing details in metric results (e.g., where the metric 24 is calculating attainment, and the user wants attainment results for each product sold by each employee), or because the level of detail is required for calculating earnings by a plan component that the metric results feeds into (e.g., where the metric's results is used as the input for a plan component 26, the plan component 26 may calculate earnings differently depending on the product, such as when there is a different parameter value, like target earnings, for each product that is used in the earnings calculation).

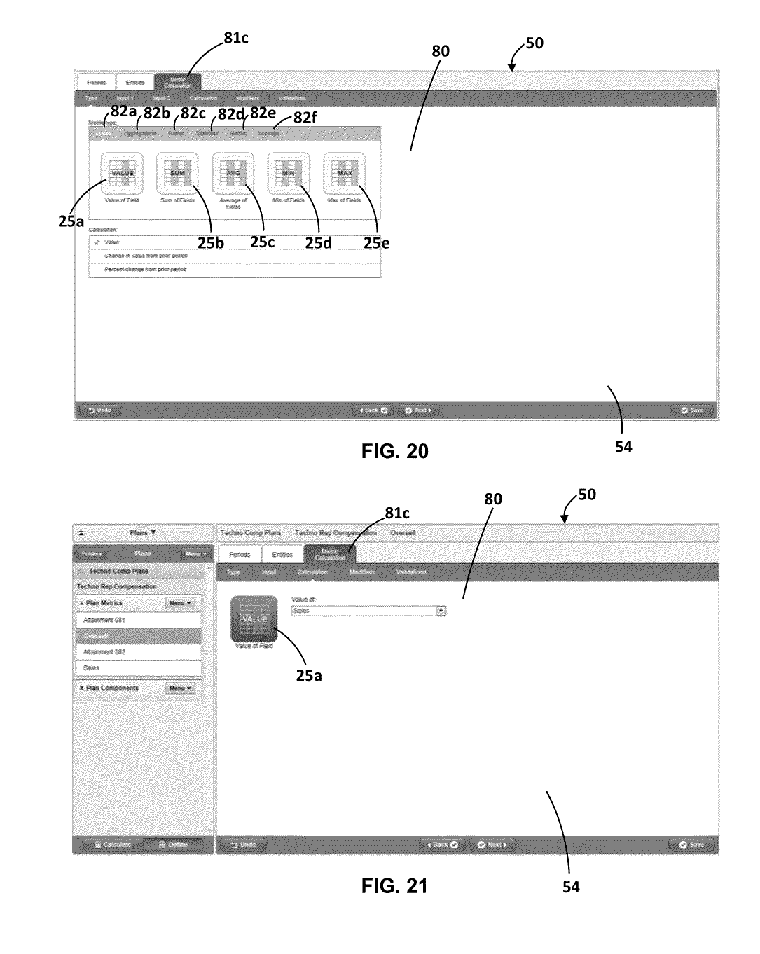

After specifying the metric calculation period and metric calculation entities, the user may be guided to defining the specific calculation to be performed on input data by the selected plan metric 24, using the “Metric Calculation” tab 81c of the metric definition element shown in FIG. 20. The CPM system 10 may be configured to present different types of metric calculations by category to aid the user in specifying the desired calculation. Furthermore, the metric result may be calculated as a value, a change in value, or a percent change in value, which are formats that are desirable to be used as input data for a plan component 26. The user may further define one or more “modifiers,” which are calculations defined to modify the metric result before it is used as an input to a plan component 26. The user may also define one or more validation conditions to be performed on the metric result data. In this manner, the CPM system 10 breaks down the definition of a plan metric 24 into logical parts, each part being presented in the graphical user interface 50 in a way that guides the user through the steps needed to define the metric. As with other results calculated by elements of the compensation plan 20, the tables that store the results of plan metric 24 calculations are dynamically created and structured by the CPM system 10 as the plan metric 24 is defined and/or processed, based on the user's specifications when defining the plan metric 24. Unlike known systems, the present CPM system 10 does not force the user to use a fixed data model, or to perform complex backend alterations of existing system tables to support the compensation plan 20 being defined. This allows the user to define an entire compensation plan 20 without having to preprocess any data or create the necessary data tables, or leave the CPM system's graphical user interface 50 and set of compensation plan creation and processing elements 35a, 35c, leading to an efficient, business-oriented, and user-friendly system of configuring and processing compensation plans 20.

Plan metrics 24 in the present CPM system 10 may be organized by type based on the type of calculation to be performed by the plan metric 24. For example and without limitation, the following categories of plan metrics 24 may be presented to the user to choose from when defining the metric calculation: values metrics 82a, aggregations metrics 82b, ratios metrics 82c, statistics metrics 82d, ranks metrics 82e, and lookups metrics 82f. One of ordinary skill in the art would appreciate that these metric types may be categorized differently, and that additional categories may be presented to the user for other types of calculations, without departing from the spirit of the present application. Each of the above categories of metrics types may be presented to the user within a “Type” sub-tab of the metric definition element 80 of the graphical user interface 50, as shown in FIG. 20. Depending on the type of metric calculation selected by the user, the contents of the other sub-tabs relating to inputs, calculations, modifiers, and validations may dynamically change to fit the type of metric being defined. Each type of plan metric 24 will be discussed in detail below.

As shown in FIG. 20, the metric calculation tab 81c of the plan metrics definition element 80 of the graphical user interface 50 my include additional sub-tabs, including a “Type” sub-tab that is configured to provide guidance, present options, and receive user input related to what type of calculations are performed by the plan metric 24 being defined. Metrics 24 grouped in the “values metric” category 82a perform calculations on one or more fields within a record for each instance of the one or more metric calculation entities defined for the plan metric 24. The values metric category 82a includes, for example and without limitation, the following specific metric types as shown in FIG. 20: value of field metric 25a, sum of fields metric 25b, average of fields metric 25c, minimum of fields metric 25d, and maximum of fields metric 25e. The user may then specify the calculation for each metric 24 as being based on a value in a field, or a change in a value in a field compared to a prior period for the compensation plan 20, or a percent change in a value in a field compared to a prior period for the compensation plan 20. When a data table is used as the input to a plan metric 24, the user may specify one or more filters to limit the records that are used as the input to the metric 24, which will be discussed in further detail below.

The value of field metric 25a simply returns the value of a numeric field for each instance of the metric calculation entity, and is intended to be used when a modifier or validation needs to be applied to the input data (i.e., the value of the numeric field), but no calculation needs to be performed on the data itself. FIG. 21 illustrates an example of when a value of field metric 25a is defined, where the user may use the “calculation” sub-tab to specify the data field of the input data table to be used to obtain values from. The sum of fields metric 25b calculates the sum of two or more numeric fields' values for each instance of the metric calculation entity, and when run, values from the appropriate fields are summed for each unique metric calculation entity. For example, if the input data table contains values for the calculation entity “territory” and three months of sales data from January to March. Total sales can be calculated for each instance of the territory entity by selecting “territory” as the metric calculation entity, and selecting the sales data from January, February, and March as the fields to be summed by the sum of fields metric 25b. The average of fields metric 25c calculates the average of two or more numeric fields' values for each instance of the metric calculation entity, and when run, the appropriate fields are summed for each unique instance of the metric calculation entity. Using the pervious territory and sales data example, the average of fields metric 25c may be used to calculate the averages sales per month for each territory. The min of fields metric 25d returns the minimum value from two or more numeric fields for each instance of the metric calculation entity, and when run, determines the minimum value of the appropriate fields for each unique metric calculation entity. Similarly, the max of fields metric 25e returns the maximum value from two or more numeric fields for each instance of the metric calculation entity, and when run, determines the maximum value of the appropriate fields for each unique metric calculation entity. Continuing with the above example, the min of fields metric 25d or max of fields metric 25e can be used to return the minimum or maximum sales value of the quarter for each territory by obtaining the minimum or maximum sales value from the January, February, and March sales data fields.

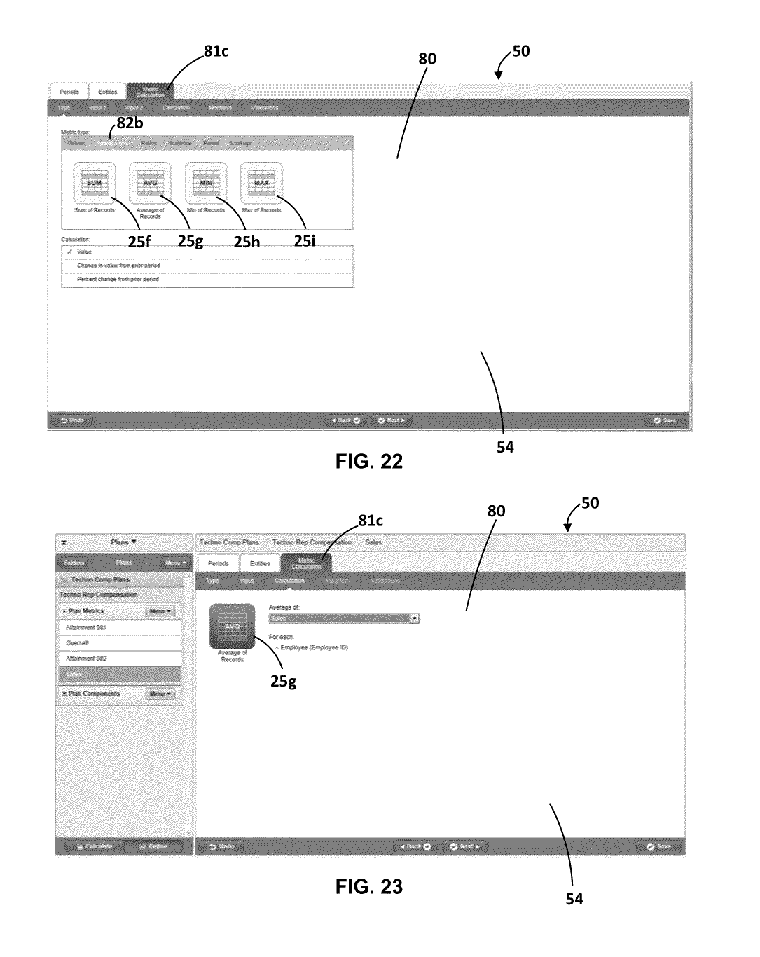

Metrics grouped in the “aggregation metric” 82b category perform calculations on a specified field across groups of records for the one or more metric calculation entity defined for the plan metric 24. The records are grouped and values aggregated by unique instances of the metric calculation entity. The aggregation metric category 82b includes, for example and without limitation, the following specific metric types as shown in FIG. 22: sum of records metric 25f, average of records metric 25g, min of records metric 25h, and max of records metric 25i. As described above, the user may specify the calculation for each metric 24 as being a value, or a change in a value compared to a prior period for the compensation plan 20, or a percent change in a value compared to a prior period for the compensation plan 20. When a data table is used as the input to a plan metric 24, the user may specify one or more filters to limit the records that are used as the input to the aggregation metric 25f-25i. The sum of records metric 25f calculates the sum of a numeric field's value for each instance of the metric calculation entity, the records being grouped based on the fields that form the metric calculation entity or entities. When a sum of records metric 25f is run, the input records are aggregated into a single record for each unique combination of fields that form the metric calculation entity, and the appropriate field is summed across aggregated records for each entity. For example, if the input data contains fields containing values related to “territory,” “product,” and “sales.” The total sales may be calculated for each territory when “territory” is the metric calculation entity, and the “sales” field is selected as the field to sum. The average of records metric 25g calculates the average of a numeric field for each instance of the metric calculation entity. When the average of records metric 25g is run, the input records are aggregated into a single record for each unique set of values in the fields that form the metric calculation entity, and the average value is calculated for the appropriate field across aggregated records for each entity. For example, if the input data table includes the fields “territory,” “transaction date,” and “sales,” the user may use the average of records metric 25g to calculate the average sales for each territory when “territory” is the metric calculation entity, and the “sales” field is selected as the field to average. An example of an average of records metric 25g is shown in FIG. 23, where the user is guided to select the field for which the average value should be calculated for, and displays the metric calculation entity as “employee.” The min of records metric 25h returns the minimum value of a numeric field's values for each instance of the metric calculation entity. When run, the input records are aggregated into a single record for each unique set of values in the fields that form the metric calculation entity, and the minimum value is determined for the appropriate field across aggregated records for each entity. The max of records metric 25i operates in a similar fashion to return the maximum value of a numeric field's values for each instance of the metric calculation entity. For example, if the input data table includes the fields “territory,” “product,” and “sales,” the user may utilize the min of records or max of records metric 25h, 25i to return the minimum or maximum sales value for each territory when “territory” is the metric calculation entity and the minimum or maximum value of the “sales” field is being determined.

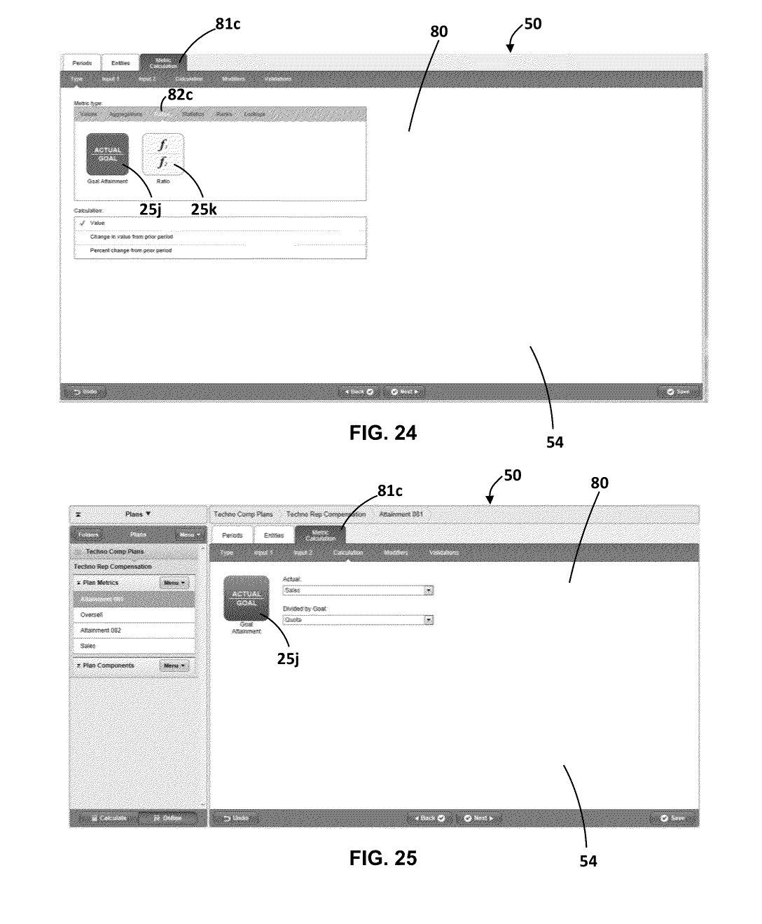

Metrics grouped in the “ratio metric” category 82c calculate a ratio for each instance of the metric calculation entity, and may include, for example and without limitation, the goal attainment metric 25j and the ratio metric 25k, as shown in FIG. 24. The calculations performed by the goal attainment metric 25j and the ratio metric 25k may be the same, but the goal attainment metric 25j exists for a specific business usage as goal attainments are often an important part of sales-related compensation plans. Two different inputs are specified by the user for a ratio plan metric 25k. The first input contains the field used as the numerator in the ratio calculation, while the second input contains the field used as the denominator in the ratio calculation. Both inputs may be from the same input data table, or may be from different data tables. FIG. 25 illustrates an example of a goal attainment plan metric 25j configuration, where data from the “sales” field of a data table is selected as the numerator (i.e. actual sales) of the ratio calculation, and data from the “quota” field of a data table is selected as the denominator (i.e. goal sales) of the ratio calculation.

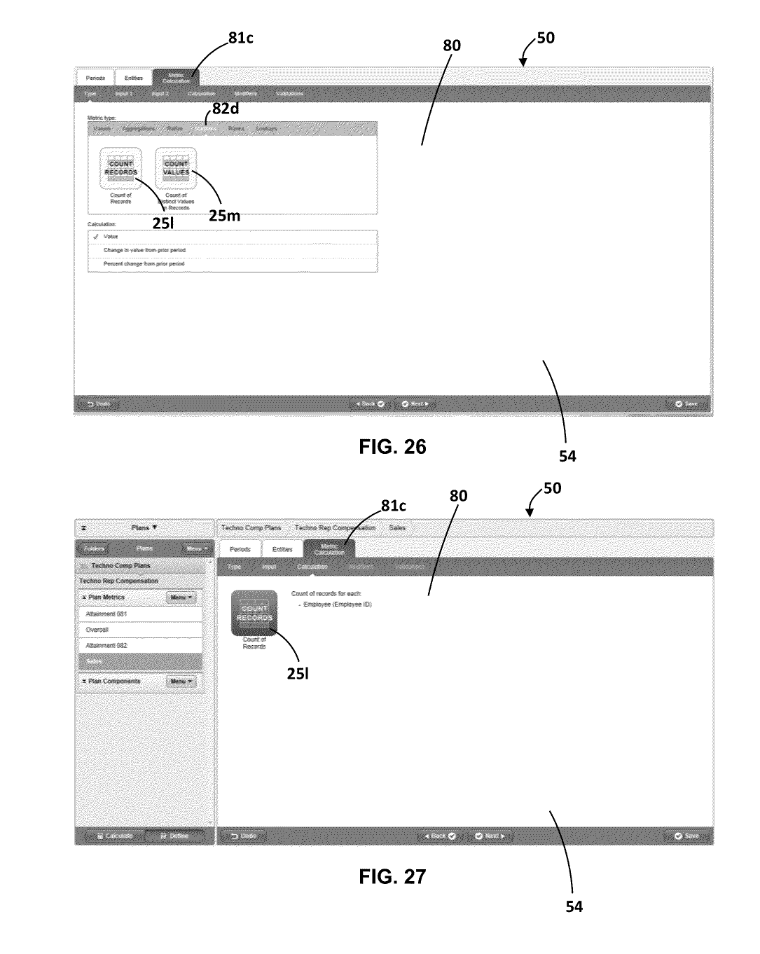

Metrics grouped in the “statistics metrics” category 82d are used to perform a calculation for the purposes of statistical analysis across groups of records, which are grouped by unique instances of the metric calculation entity. The statistics metrics category 82d includes, for example and without limitation, the following specific metric types as shown in FIG. 26: count records metric 25l, count distinct values in records metric 25m, standard deviation (population of records) metric, and standard deviation (sample of records) metric (standard deviation icons not shown in FIG. 26). When a statistics metric 25l, 25m is run, if a group to calculate within is specified by the user, the calculation is performed for each unique group of specified field values in the input. If a group to calculate within is not specified, then the calculation is performed once using all records in the input. The count records metric 25l is relatively simple, and counts the number of records for each instance of the metric calculation entity. When run, the input records are grouped for each unique set of values in the fields that form the metric calculation entity, and the count is determined across those records for each entity. For example, if the input table contains the fields “territory,” “transaction number,” “product,” and “sales,” the count records metric 25l may be used to count the number of records for each territory where “territory” is the metric calculation entity. An example of setting up a count records plan metric 25l is shown in FIG. 27. The count distinct values in records metric 25m counts the number of distinct values in a specified field for each instance of the metric calculation entity, and when run, groups the input records for each instance of the metric calculation entity and counts the number of distinct values in the specified field across those records for each entity. The standard deviation (population) of records metric may be used to calculate the variance from the mean value within a population, while the standard deviation (sample) of records metric may be used to calculate the variance from the mean value within a sample set of data.

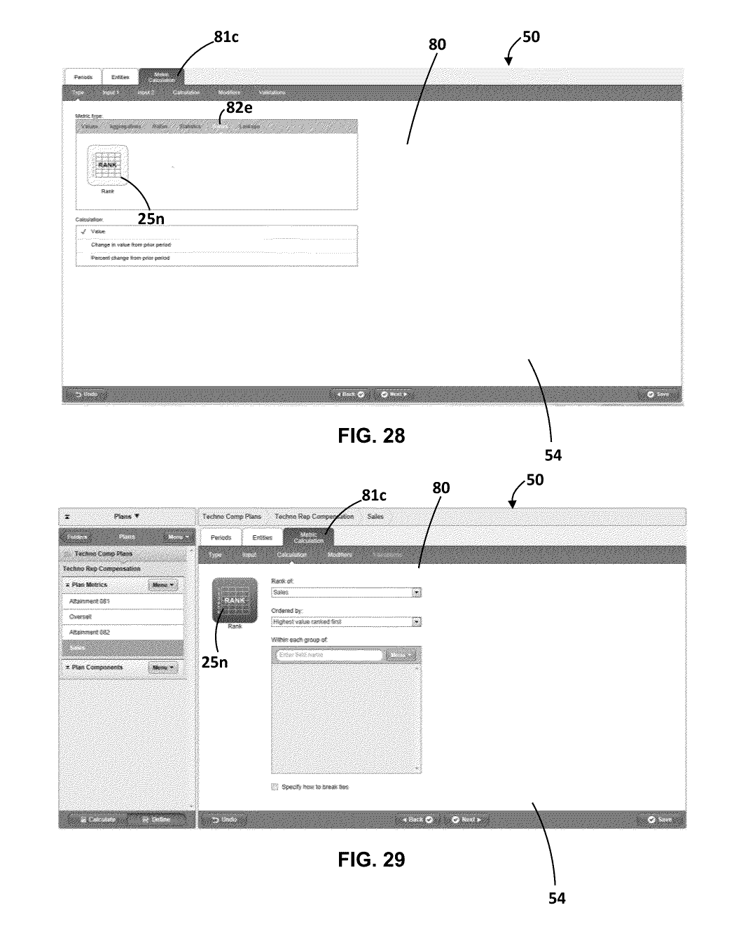

Metrics grouped in the “ranks metrics” category 82e are used to calculate the relative standing of each record within a group of records, which are grouped by unique instances of the metric calculation entity. The ranks metrics category 82e includes, for example and without limitation, the following specific metric types as shown in FIG. 28: rank metric 25n, rank (N tile) metric (icon not shown in FIG. 28), and rank (percentile) metric (icon not shown in FIG. 28). As shown in FIG. 29, the rank metric 25n may be used to calculate the relative ranking of each record within a group of records. Records in the input data table may be all ranked against each other, or the records can be grouped by one or more fields in order to yield rankings within groups. In the example shown in FIG. 29, the user has selected “sales” as the field for which records should be ranked, and selected to rank the records by highest value ranked first. The user may further specify whether the records should be ranked within a group by one or more fields, and how to break ties. In the calculation performed by a rank metric 25n, any numeric field from the input data table may be selected as the “rank of” field shown in FIG. 29. The rank order (1 to n) may be specified using the “ordered by” field, and values can be ranked from highest to lowest where the highest value is ranked 1, or alternatively from lowest to highest where the lowest value is ranked 1. When specifying the “within each group of” section of the rank metric definition element shown in FIG. 29, the user may select one or more fields that form the metric calculation entity to form groups. The tie breaker field option is only displayed if the user selects the checkbox next to “specify how to break ties,” and allows the user to select a numeric or date field to be used to break ties that occur during ranking. If no tie breaker field is specified, then tied records are assigned the same ranking and subsequent records are ranked as if there is no tie before them. The rank (N tile) metric operates similarly to the regular rank metric 25n, but further defines how many “buckets” the records are being ranked across. The rank (percentile) metric also calculates the relative standing of each record within a group of records, but returns the rank result as a percentile instead of a 1 to n rank order.

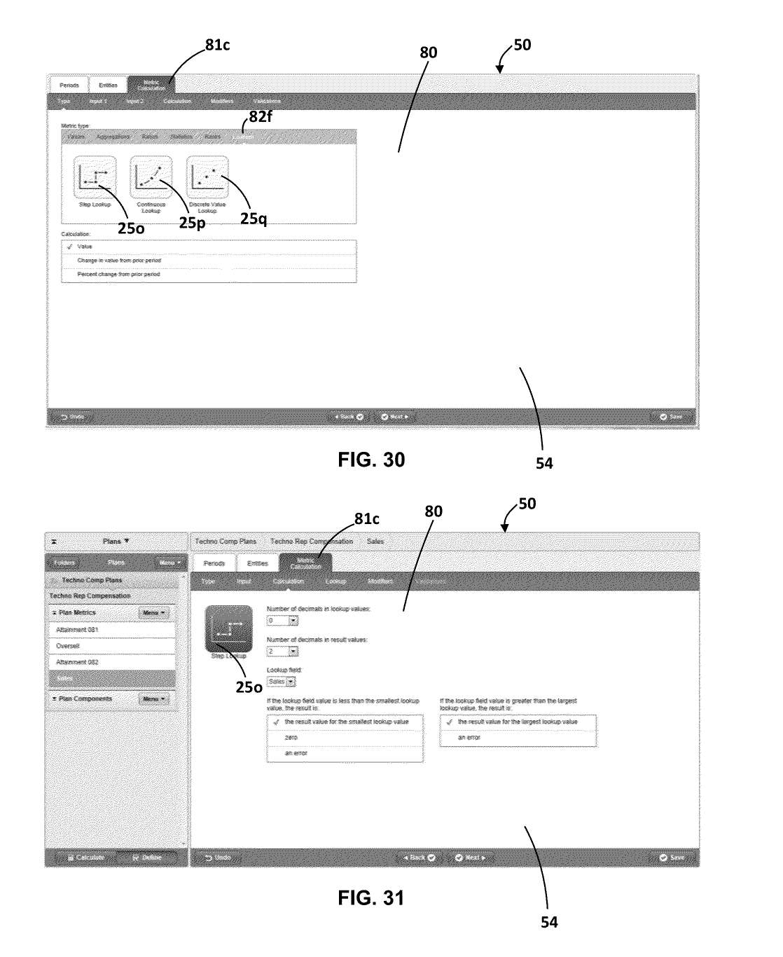

Metrics grouped in the “lookup metrics” 82f category are used to look up an input field value and dynamically return a result for each instance of the metric calculation entity by using a lookup table. The lookup metrics category 82f includes, for example and without limitation, the following specific metric types as shown in FIG. 30: step lookup metric 25o, continuous lookup metric 25p, discrete value lookup metric 25q, and matrix lookup metric (icon not shown in FIG. 30). In order to utilize one of these lookup metrics 25o-25q, the user is guided to enter data points into a lookup table that includes a lookup value field and a result value field, which are graphically displayed in relation to each other on a curve. The lookup table is an example of a parameter table in the present CPM system 10, which is created dynamically by the system and populated with data specified by the user through manual inputs or a data load. As the user defines a lookup metric 25o-25q, the CPM system 10 also guides the user through creating the necessary lookup table for the type of lookup metric being defined, without requiring the user to create the table outside of the CPM system 10 or leave the plan metric definition element 80 of the graphical user interface 50. The manner in which a lookup metric 25o-25q handles lookup values if the input data is outside the range of lookup values from the lookup table varies, depending on the metric type and other user specifications. For example, if it is for a discrete value lookup metric, the process would fail and no metric result value is returned. During the metric definition step, testing may be performed where a lookup value is entered and the result value is calculated based on the metric's specifications to ensure that the metric and associated lookup table has been properly defined.

FIGS. 31-32 illustrate an exemplary configuration of a step lookup metric 25o and the associated graphical user interface elements that guide the user through the process and receive input necessary to defining the plan metric 24 and the associated lookup table 83a. A step lookup metric 25o maintains one possible result value for the interval between each lookup value and the next lookup value in the lookup table 83a, resulting in a series of “steps” between the data points on the curve when the lookup table 83a is visualized graphically. The lookup table 83a in a step lookup metric 25o includes one lookup value field and one result value field. The lookup value field may be plotted on the x-axis, while the result value field is plotted on the y-axis of the lookup curve. A data table containing the desired lookup field is selected as the input to the step lookup metric 25o, which then compares the values in the lookup field of the input table to the values in the lookup field of the lookup table 83a. As shown in FIG. 31, the user may define the calculation performed by the step lookup metric 25o by specifying the number of decimal places in the lookup value field of the lookup table 83a, the number of decimals places in the result value field of the lookup table 83a, and the numeric field from the input table to be used as the lookup field. If a lookup field value from the input table is smaller than the smallest value from the lookup value field in the lookup table 83a, the user may specify whether to utilize as the result value either the result value for the smallest lookup value in the lookup table 83a, a value of zero, or to return an error with no result. Similarly, if a lookup field value from the input table is greater than the largest lookup value from the lookup value field in the lookup table 83a, the user may specify whether to utilize as the result value either the result value for the largest lookup value in the lookup table, or to return an error with no result. FIG. 32 illustrates the lookup table 83a created by the CPM system 10 to be used with the selected step lookup metric 25o being defined, the values in the lookup table 83a being supplied by the user. In the lookup table 83a shown in FIG. 32, the step lookup metric 25o would return a results value of 0.45 for any lookup values that fall between 1000 and 1300, and the user may utilize the “Lookup Test” tool to insert a lookup value and return the result value from the lookup table 83a. When the step lookup metric 25o is run, the following are performed for each instance of the metric calculation entity: each value from the lookup field in the input table is compared to the lookup value field in the lookup table 83a; and a result value is calculated based on the metric's specifications by looking to the lookup table 83a.

A continuous lookup metric 25p calculates a sequence of possible result values for the interval between each lookup value and the next highest lookup value specified. This calculation is known as interpolation, which creates a continuous line between specified points on a curve. The lookup table for a continuous lookup metric 25p includes a lookup value field and a result value field, which are plotted on the x-axis and y-axis of the lookup curve, respectively. A data table containing the desired lookup field is selected as the input to the continuous lookup metric 25p, and values from the lookup field of the input data table is compared to the values in the lookup value field of the lookup table. When defining the calculations performed by the continuous lookup metric 25p, the user may be presented with the same options as discussed above and shown in FIG. 31. When the continuous lookup metric 25p is run or processed, each value from the lookup field in the input table is compared to the lookup value field in the lookup table, and a result value is calculated based on the metric's specifications by using an interpolation between two points on the payout curve via the following formula: y=y1+((y2−y1)/(x2−x1))*(x−x1). In this formula, y is the result value; x1 and y1 are the corresponding lookup and result values for the start point of interpolation; x2 and y2 are the corresponding lookup and result values for the end point of interpolation; and x is the value from the lookup field in the input table.

A discrete value lookup metric 25q returns one possible result value for each lookup value, and contains a similar lookup table as the step lookup metric and continuous lookup metric. However, instead of a step-like graph or a curve, the visualization of the lookup table is a graph containing the individual points to represent the discrete values in the lookup table. An input table that contains the desired lookup field is selected by the user as the input table, and the values in the lookup field of the input table are compared to the values in the lookup field of the lookup table. There must be a match between the input table's lookup field value and the lookup table's lookup field value in order for a result value to be returned, since this lookup metric 25q is comparing discrete values. Using the metric definition element 80 presented in the graphical user interface 50, the user may specify the number of decimals in the lookup value field of the lookup table, the number of decimals in the result value field of the lookup table, and the numeric field from the input table to be used as the lookup field. When the discrete lookup metric 25q is run or processed, each value from the lookup field in the input is compared to the lookup value field in the lookup table, and the system looks for matching values. If a match is found, the appropriate result value from the lookup table is returned as the metric result. If no match is found, then the metric process fails and an error message may be displayed.

After selecting the type of plan metric 24, the user may be guided to specify one or more data tables to be used as inputs for the metric calculation. These input data tables may be maintained in the CPM system 10 or within an associated SPM system 14 or other source, and often contain data that is used by other applications 16 of the SPM system 14. The data table or tables selected as the input to a metric 24 must contain all of the fields and entities that were selected as the metric calculation entity. The data table may contain the field that was selected as the entity ID field for the entity, instead of the entity itself, but processing speed may be optimized by using the entity itself in the data table. The input data table or tables should not contain duplicate records for an instance of a metric calculation entity unless the calculation type is performed across records (e.g., aggregation metric types 82b and statistics metrics types 82d). The CPM system 10 may be configured such that only data tables may be used as inputs to plan metrics 24, or may be configured to also allow a plan metric's results to be used as the input to another plan metric 24 in the same compensation plan 20 or a different plan.

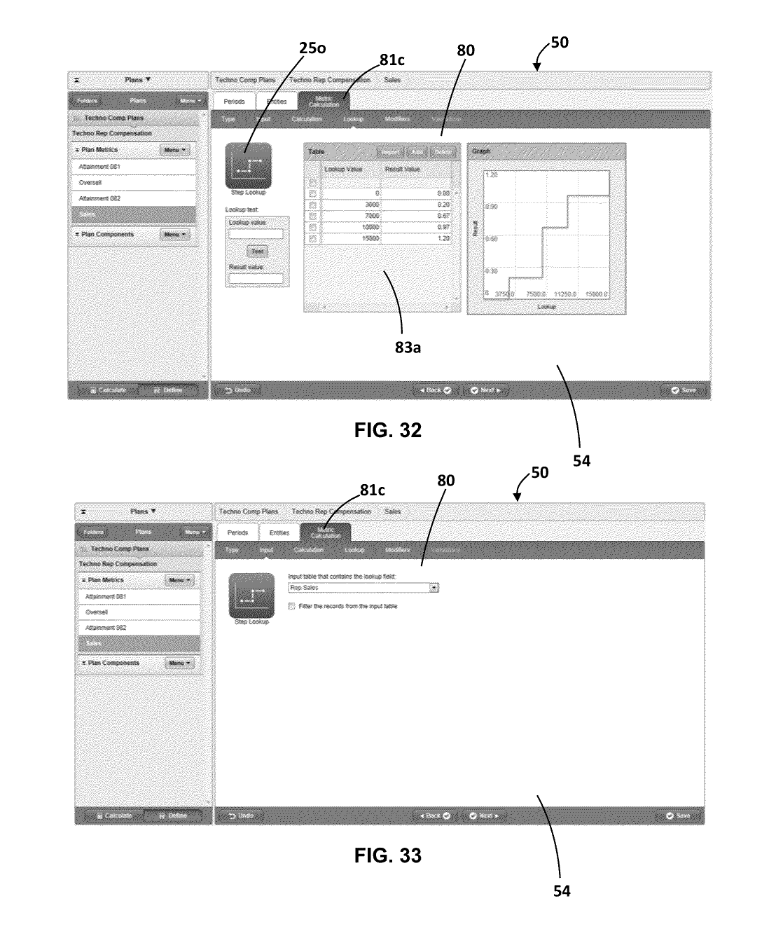

As shown in FIG. 33, when defining a plan metric 24 the user is guided to specifying the input for the plan metric 24, and is given the option of filtering the records from the input table by selecting a checkbox. If the user elects to use filter conditions, the input sub-tab of the metric calculation tab 81c may dynamically display additional options to the user to specify the filter conditions. For example and without limitation, if the data table used as the input contains an effective date or effective period field, the present CPM system 10 may be configured to only utilize data values with a date, period, or range that falls within the period in which the metric 24 is being run is used in the metric calculation. Alternatively, this may be an optional filter condition that is specified by the user, along with other filter conditions based on the data contained in other fields in the input data table. The effective date or period of the input data table's records should correspond to the period for which the plan metric 24 may be processed or run. If a plan metric 24 is included in projected payments for a compensation plan 20, the data for a period being run should be cumulative for the plan payment period. For example, if projected payments are being calculated monthly, and actual payments are calculated quarterly, records for March should contain data for the entire payment period. If the input data table does not contain an effective date or period field, all data may be used in the metric calculation.

As discussed above, the results of a plan metric 24 calculation may be presented as a value, a change in value from a prior period, or a percent change in value from a prior period, which may be specified by the user during configuration of the plan metric 24. A change in value is determined by subtracting the result of the metric calculation for a prior period from the result of the metric calculation for the current period that the metric 24 is being run for. A percent change is determined by dividing the change in value by the result of the metric calculation from the prior period. As shown in FIG. 34, where the user specifies the metric calculation result to be a change in value or percent change, the metric definition element may dynamically present additional options that allow the user to specify what period should be used as the prior period to calculate the difference. The use may specify the prior period as: the prior period that the metric 24 was run for (e.g., if the metric is run monthly, then the previous month); the current period, but x periods ago (e.g., current month, 5 quarters ago); or an absolute period (e.g., January 2013). If the prior period specified by the user is on or after the compensation plan's start period, the prior period value to use in the change calculation is obtained from the appropriate period's record in the metric result table. If the prior period specified by the user occurs before the compensation plan's start period, then the CPM system 10 may obtain the prior period value from the appropriate period's record in a baseline prior period values table, which contains values to be used for comparison purposes. The baseline prior period values table is another example of a parameter table that is created on an as-needed basis by the present CPM system 10 to store prior period values required to calculate change or percent change from periods prior to the start of the compensation plan 20. The baseline prior period values table may include fields for all entities and fields specified for the metric calculation entity, the time unit specified as the metric calculation frequency, and the baseline values. The user is requested to provide or upload a record for each instance of the metric calculation entity that the plan metric 24 will be run for. FIG. 35 illustrates an exemplary baseline prior period values table 83b, which may be displayed to the user within the metric calculation definition element 80 of the graphical user interface 50.

After a plan metric 24 is run to produce metric results, the user may wish to modify that metric result before it can be used as the input to a plan component 26 for earnings calculations. Plan modifiers are used to perform an operation on the results of a plan metric or plan component calculation. If more than one modifier is defined, they may be performed in the order in which they are defined (i.e., first modifier is applied to the metric calculation result, the second modifier is applied to the result of the first modifier, and so on until the result of the last modifier is used as the final metric result). A plan metric's initial metric results may be stored in a metric result table, and a separate results table may be created for each modifier applied to the initial metric results to store the modified metric results. Alternatively, all metric results associated with a plan metric may be stored in a single metric results table, with a field or other table element that differentiates the initial metric results from each set of modified metric results. If a single metric results table is used, the table may further include support for different “versions” of a compensation plan, such that metrics results values from different versions of the same plan are differentiated from each other and may be recognized by the system when used in other system processes or outside applications.

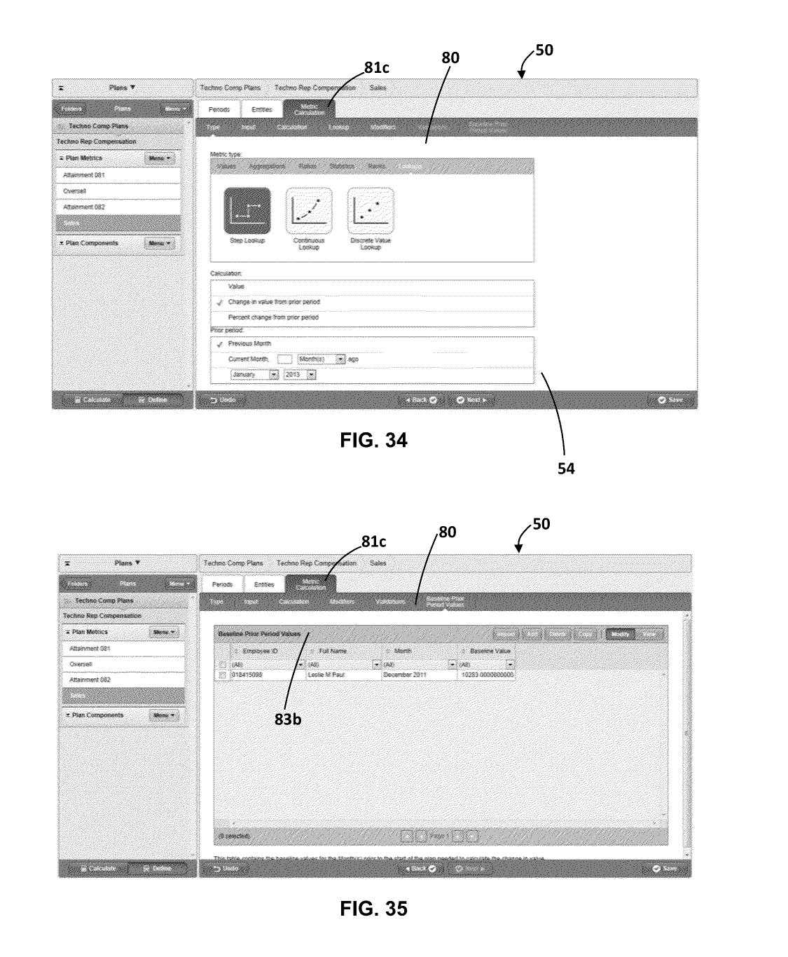

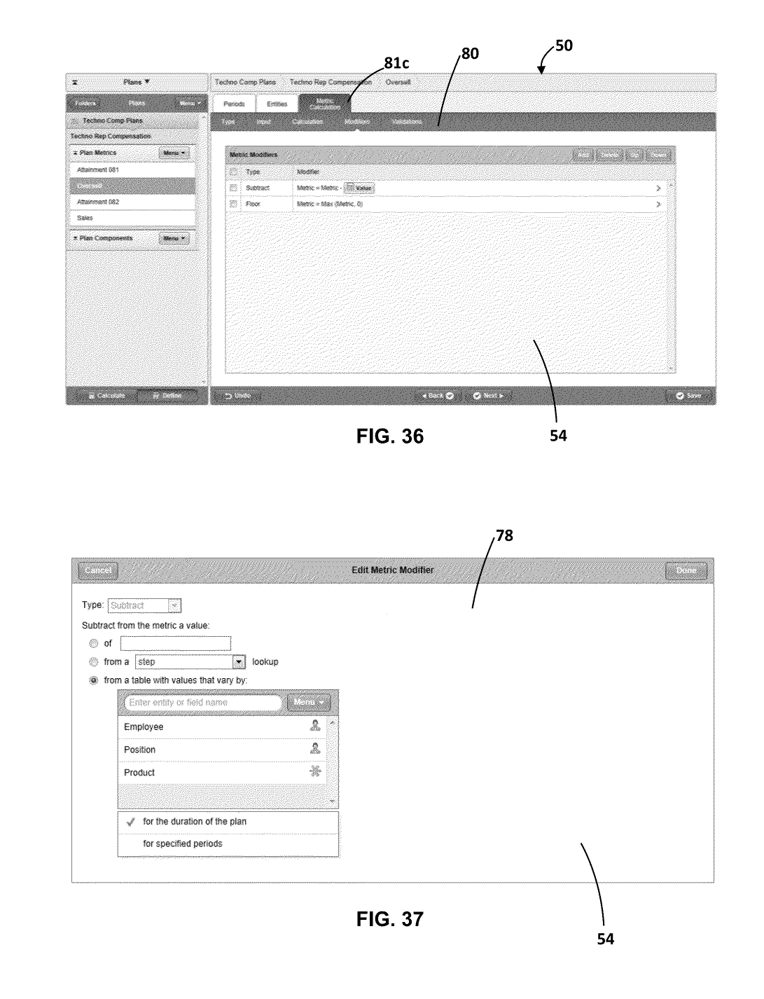

As shown in FIG. 36, the metric calculation tab 81c of the metric definition element 80 may include a “Modifiers” sub-tab configured to present guidance, provide options, and receive user inputs related to one or more modifiers to be applied to the results of the selected plan metric 24. There are a large number of different modifier types, and the choices made available to the user may vary depending on the type of plan metric 24 being configured. For example and without limitation, modifier types that may be applied to metric results may include: floor, cap, hurdle, qualifier, accelerator, decelerator, round, round up, round down, add, subtract, multiply, divide, and split. One of ordinary skill in the art would understand that the types of mathematical operations performed these specific modifier types are commonly understood, and are provided to the user because they are frequently used in sales compensation plans and have defined businesses meaning for the user. The present CPM system 10 may also permit the user to define custom modifiers, which may be any calculation to be performed on metric results or earning results from plan components.

Although the user may select a modifier type from the list of available types discussed above, the present CPM system may still require the user to specify the details of each modifier to be applied. For example, FIG. 37 shows a modifier definition element 78 for configuring a subtraction modifier to be applied to a metric's results, which may be displayed in the right hand pane 54 of the graphical user interface 50. Based on the user's selection of the modifier “type,” as shown in FIG. 37, the modifier definition element 78 may dynamically display the corresponding options and menus for that specific modifier type. The subtraction modifier being defined in FIG. 37 is a relatively simple modifier, which is used to subtract a specified value from the metric's calculation result. The user may specify the value to subtract as a specific constant value, from a lookup table, or from another parameter table in the CPM system 10, in which the modifier value is identified by one or more fields that do not necessarily include numeric data. In FIG. 37, the value to be subtracted from the metric calculation result is maintained in a parameter table because the value to be subtracted varies for each instance of the metric calculation entity. The user may further filter the results in the parameter table by selecting a time period, such as for the duration of the compensation plan 20, or for specific specified periods. If the parameter table does not already exist in the CPM system 10, the user would be guided through defining and populating the parameter table with the appropriate data values. Similarly, if the user had selected to subtract a value by using a lookup table that does not already exist in the system, the user would be guided through defining a lookup table as discussed above with respect to metric types.

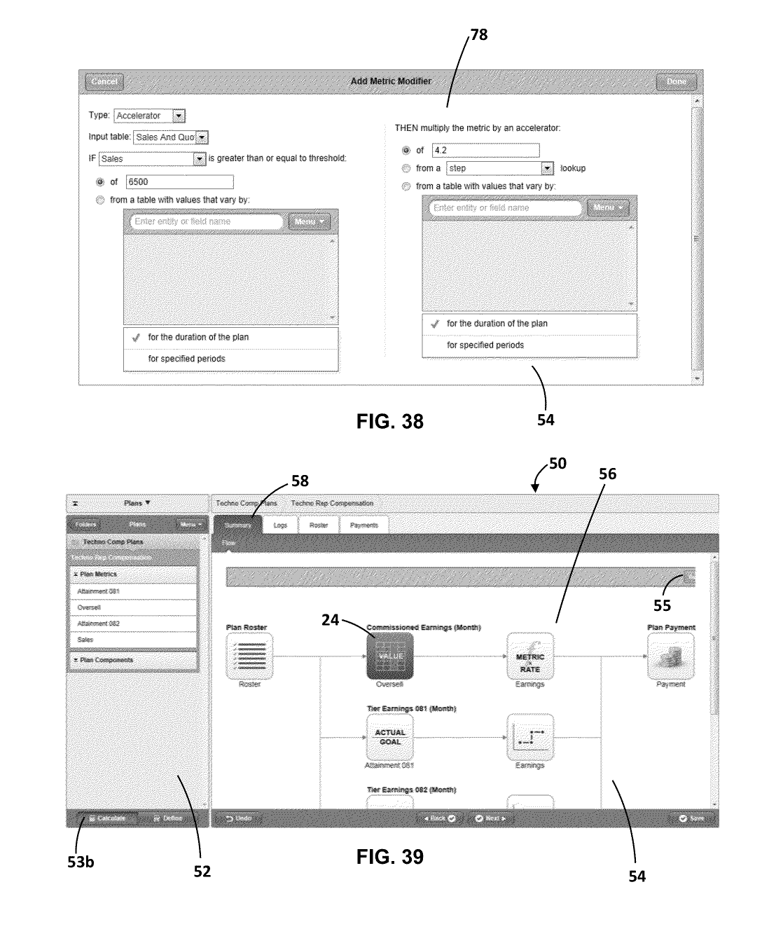

FIG. 38 shows an exemplary configuration of an accelerator modifier, the modifier definition element 78 being configured to guide the user to specify an input table and a field from the input table to compare to a threshold value (in this example, the field “sales” from a “sales and quota” input table has been selected). If a value from the selected input data table field is greater than or equal to the a user specified threshold value, then the metric result is multiplied by another value, referred to as an accelerator. If the field value is not greater than or equal to the threshold, the metric result will remain the same. One of ordinary skill in the art would appreciate that although this specific accelerator modifier shown in FIG. 38 and described herein utilizes a greater than or equal comparison and a multiplication operation, other accelerator modifier may easily be configured to include different conditions and mathematical operations to achieve a desired acceleration modifier. All modifiers within the present CPM system 10 may require the user to specify one or more values to use within the modifier's operation. Depending on the specific modifier type and the specific value required for the operation, the value may be provided from a constant value entered by the user, a lookup table, or another parameter table. The value to be used as the accelerator may also be provided from a constant value, a lookup table, or another parameter table. Some modifiers, like the accelerator modifier shown in FIG. 38, require the selection of an input data table and/or field, which provides the values to use in a comparison. In a metric modifier, where the user selects an input data table and a field from that table, the table must contain fields that form the metric calculation entity. In an earnings modifier, where the user selects a plan metric 24 or plan metric result table, the plan metric 24 or metric result table must have the same calculation entity as the plan component performing the earnings calculation. As is the case with other elements of the compensation plan configuration process, the user may filter the values to be used from the selected data table/metric by using filter conditions.

Similar to the plan roster 22, a plan metric 24 may be processed or run individually or as part of the entire compensation plan 20. As shown in FIG. 39, a user may run a plan metric 24 individually by selecting the “Calculate” option 53b in the left hand pane 52 of the graphical user interface 50, then selecting the icon representing the plan metric 24 in the summary flow diagram 56 so that the desired metric 24 is highlighted, then clicking on the “Run” button 55 to process the metric 24. Running a plan metric 24 individually may be helpful for testing or trouble-shooting during the compensation plan configuration stage, to ensure that the metric 24 has been defined correctly and returns the appropriate plan metric results. Processing or running of a plan roster 22 may be a predecessor to each plan metric 24. A plan metric 24 is automatically submitted to run for the period of the metric calculation frequency that corresponds to the period being run for the compensation plan 20.

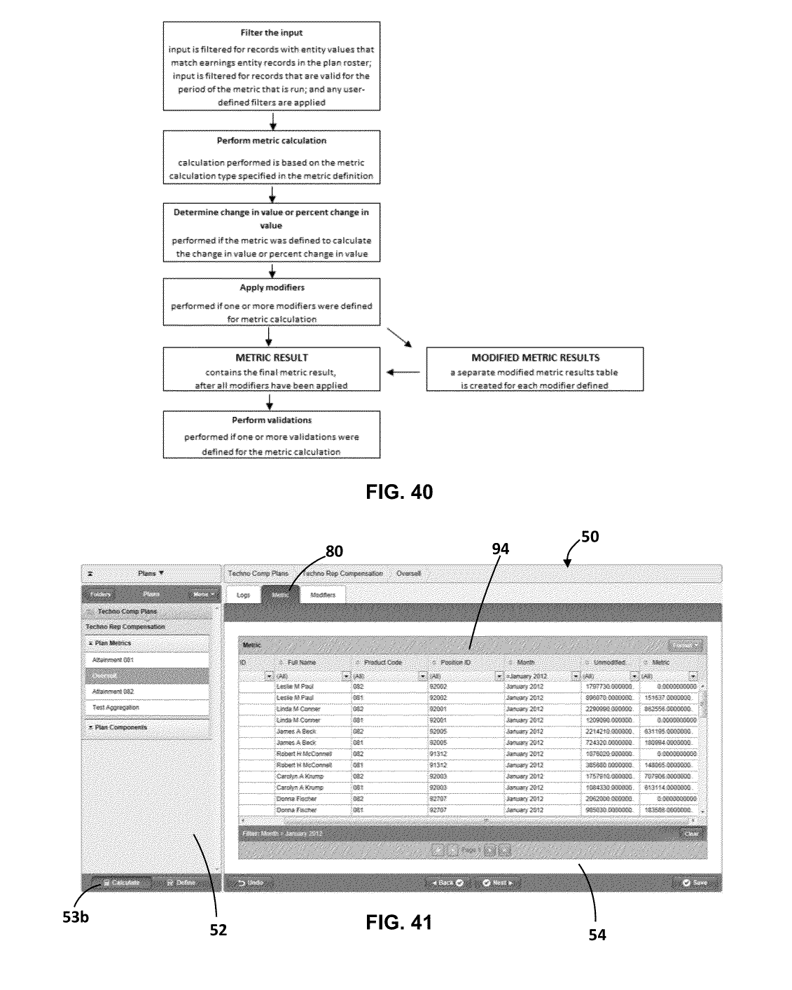

The diagram shown in FIG. 40 illustrates the steps associated with processing or running a plan metric 24. First, the inputs to a plan metric 24 are filtered for the following: records that can be matched to earnings entity values using the same entity in the records or using the field that contains the entity ID for the earnings entity; records that are valid for the period that the plan metric 24 is being run (i.e., via effective dating of records); and records that satisfy any filter conditions defined by the user when defining the plan metric 24. The plan metric 24 then performs the metric calculation on the filtered records from the input data table, the calculations being based on the metric calculation type and other options specified during the metric definition stage. If the plan metric 24 was defined to calculate the metric result as a change in value or percentage change in value from a previous metric processing period, then the CPM system 10 determines what the change or percent change in value should be. If the user has specified one or more modifiers for the selected plan metric's results, then the modifier or modifiers are performed on the metric's initial results. As discussed above, a separate modified metric results table may be created for each modifier that is applied to the metric results, and the final metric result after all modifiers have been applied may be stored in a final metric results table created by the CPM system 10. Alternatively, a first metric results table may be created and maintained by the CPM system 10 to store all final metric results in a compensation plan 20, and a separate second metric results table may be created and maintained to store all modified metric results after each modifier is applied. As a further alternative, a single metric results table may be created and maintained by the CPM system 10 to store each set of metric results, including the initial metric results before any modifiers are applied, the modified metric results after each metric modifier is applied, and the final metric results. Finally, the CPM system 10 may perform any user-specified validations on the metric results data to ensure validity before they can be used for any subsequent plan component's earnings calculations or other purposes.

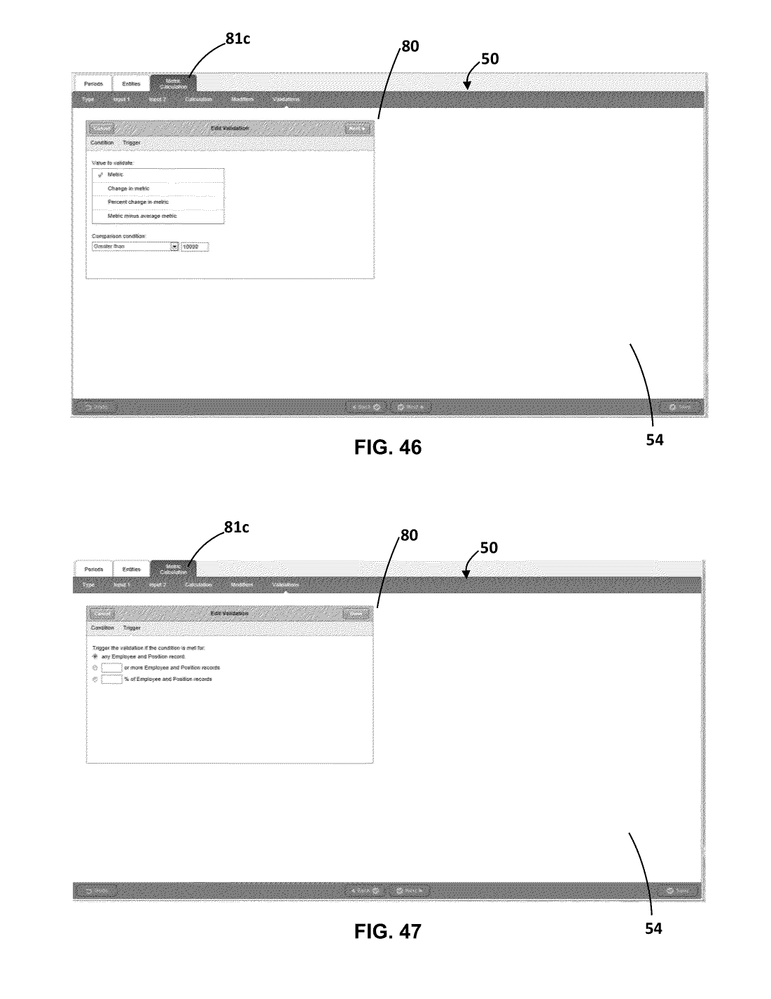

As shown in FIG. 45-47, the plan metric definition element 80 may include a “Validations” sub-tab configured to provide guidance, present options, and receive user input related to one or more validations to be performed on the calculated metric result values, including any modified metric result values. The validations specified for a plan metric 24 may result in messages being written to a log when the metric 24 or overall compensation plan 20 is processed, and the user may specify whether each failed validation results in a warning (in which case the plan processing will continue and the warning written to the log), or in an error (in which case the plan processing will fail). As shown in FIG. 45, the user may add, delete, or reorder validation conditions by using the buttons presented in the “Validations” box, and set the severity level for each condition (whether a triggered validation results in a warning or error). For each validation condition that is added or being edited, the user may be presented with the “Edit Validations” element shown in FIG. 46, where the user selects what type of value is to be validated, and the comparison condition, which may be a mathematical condition such as comparing the value to validate against a set value. As shown in FIG. 47, the user may also set a validation trigger, which indicates how many records must meet the validation condition in order to trigger the validation warning or error.

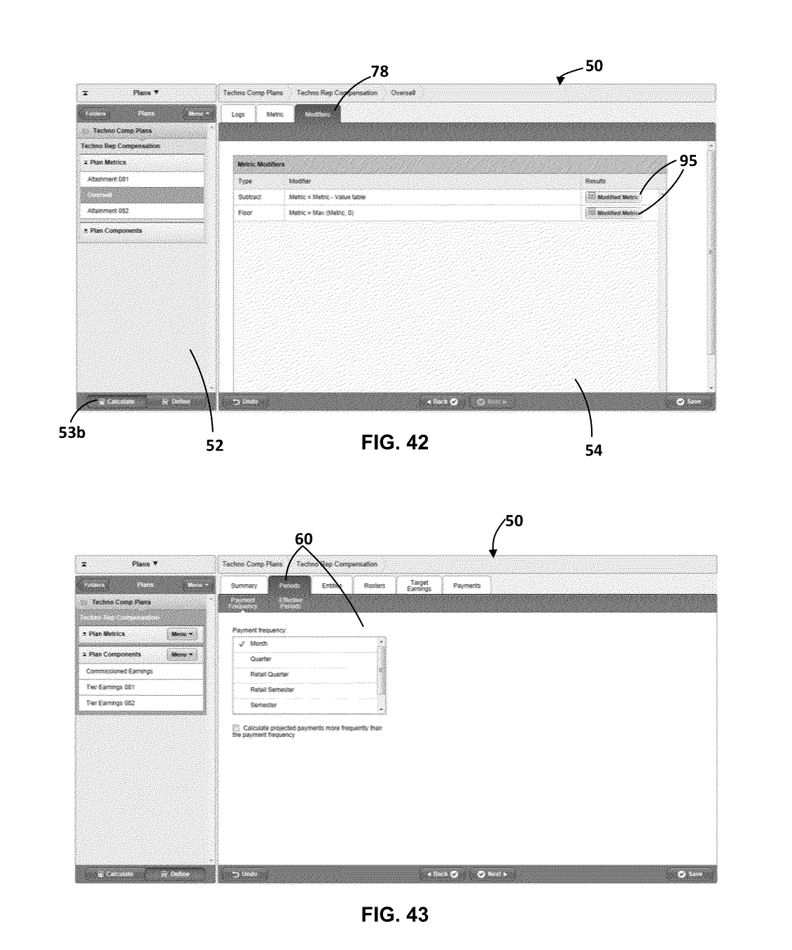

The results of a plan metric 24 are stored and maintained in one or more metric results tables 94 created by the CPM system 10, which are automatically created with the proper table structured based on the user's definition of the plan metric 24. The CPM system 10 may be configured to create a metric results table 94 for each plan metric 24 the first time the metric 24 is defined or run, to populate the table 94 with metric results when the plan metric 24 is run, to replace the metric results data if the metric 24 is rerun for the same period, and to append additional data for each subsequent period the metric 24 is run. Alternatively, the CPM system 10 may be configured to create a single metric results table 94 for every plan metric 24 within a compensation plan 20, with a field that differentiates metric results for different plan metrics 24 and/or modifiers from each other, so as to provide a central table that can be accessed for all metric results of a compensation plan 20. FIG. 41 illustrates an exemplary plan metric results table 94 displayed to the user when the user selects the “Calculate” setting 53b in the left hand pane 52 of the graphical user interface 50.

Where the CPM system 10 is configured to create separate modified metric results tables, or a single metric results table for all of a plan metric's results, or a first metric results table for unmodified and final metric results and a second metric results table for all modified metric results, the structure of the metric results tables 94 may be created as soon as the plan metric 24 and any modifiers are defined by the user (and updated accordingly with additional user specifications) and left empty until the plan metric 24 is run, or the metric results tables 94 may be created the first time a plan metric 24 is run and immediately populated with metric results. The metric results tables 94 contain records for each unique instance of the metric calculation entity and the metric period being run. As discussed above, the metric results tables 94 associated with a particular plan metric 24 may include one or more modified metric results tables 95, which stores the results of applying a modifier to the initial metric results. The metric results tables 94 also include a metric results (or final metric results) table that stores the final results of a plan metric 24 (after all modifiers, if any, have been applied). The CPM system 10 may or may not create an initial metric results table, which stores the initial metric results before any modifiers have been applied. As shown in FIG. 42, the user may access each modified metric results table 95 by selecting the “Calculate” setting 53b and then navigation to the “Modifiers” tab presented in the right hand pane 54 of the graphical user interface 50, which lists each modifier defined for the selected plan metric 24, and includes a “Results” column that allows the user to access the modified metric results table 95 associated with each listed modifier. Once the user selects the desired results table 95, the full modified metric results table 95 may be displayed to the user via a “drill-down” view where the contents of the “Modifiers” tab 78 shown in FIG. 42 is replaced with a view of the modified metric results table 95.

The following discussion provides an overview of plan components 26. A plan component 26 is an element of a compensation plan 20 used to calculate earnings results using as input the results from one or more plan metrics 24. Alternatively, a plan component 26 may also utilize input data from other data tables, provided they are in the right format. The earnings result calculated by a plan component 26 is the “initial” compensation calculated for a plan entity, before applying other factors such as eligibility, draws, etc. Earning calculations across different plan components 26 in a compensation plan 20 may be summed to produce a total earnings value for each instance of the earnings entity, which is then used in plan payment 28 calculations. The compensation plan creation element 35a of the software 34 may operate in conjunction with the graphical user interface 50 to present a plan component definition element 84 configured to provide guidance, present options, and receive user input related to creating and configuring a plan component 26. The user specifications for a plan component 26 may include, for example and without limitation, the following: the earnings calculation frequency, which determines the periods for which earnings are calculated and included in plan payments 28; the earnings calculation entity, which determines who or what earnings are calculated for in addition to the earnings entity specified for the plan; the earnings calculation type, which determines the input data for the plan component 26 and the specific earnings calculations to perform; and other optional settings that may be provided based on the definition of the overall compensation plan 20, such as target earnings and eligibility. Using the compensation plan creation element 35a, a user may define one or more plan components 26 as separate objects within a compensation plan 20. A compensation plan 20 may include many different plan components 26, based on the number of distinct earnings calculations to be performed and the overall complexity of the plan. For example, one plan component 26 may be used to plot attainment values on a curve to determine earnings, while another plan component 26 may multiply sales by a fixed commission rate to calculate earnings.

Similar to the definition of a plan metric 24, the component definition element 84 may include additional elements presented as tabs and sub-tabs for defining the plan component's periods, entities, calculations, and other specifications. As shown in FIG. 49, the component definition element 84 may include a “Periods” tab 85a configured to receive user input relating to the earnings calculation frequency. By default, the earnings of a plan component 26 are calculated at the same frequency as the plan payment frequency specified for the overall compensation plan 20 (or projected payment frequency, if applicable). However, the user may utilize the interface 85a shown in FIG. 49 to define a plan component 26 as calculating earnings that are included in plan payments 28 at a lesser (but corresponding) frequency than the plan payment calculations. For example, a plan 20 may calculate payments monthly, but a specific plan component 26 may be run and included in payments only once a year to calculate an annual bonus.

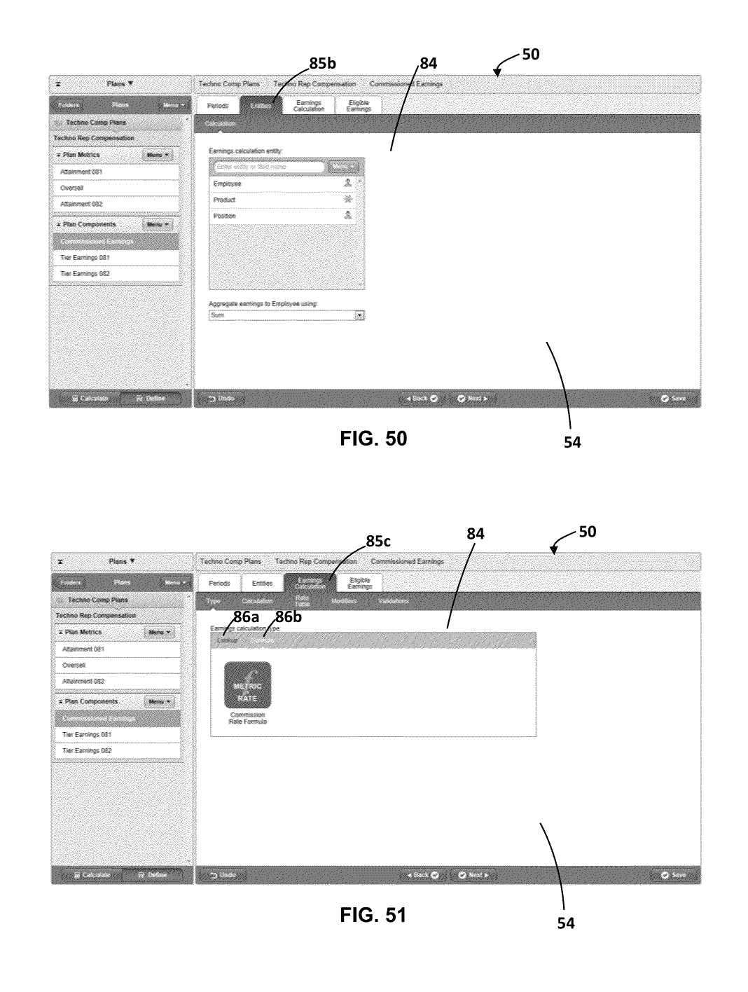

FIG. 50 illustrates the “Entities” tab 85b of the compensation plan component definition element 84, which is configured to receive user input related to the entities for which a plan component's earnings are calculated. Like plan metrics 24 described above, a plan component's earnings calculations are performed for the plan's earnings entity by default, but the user may specify additional earnings calculation entities so earnings calculations are performed on a more detailed level. If a plan component 26 calculates earnings at a more detailed level than the plan's earnings entity, the component's earnings results are aggregated for each instance of the plan's earnings entity using specified mathematical operations (e.g., sum, average, min, max). The earnings calculation entity or entities specified for a plan component 26 should be identical to the metric calculation entity or entities specified for the plan metric 24 for which the metric results are used as the input to the plan component's earnings calculation. In the example shown in FIG. 50, the earnings entity is “employee” and the user has selected the entities or fields “product” and “position” as additional earnings calculation entities, so that the selected plan component 26 does not only calculate earnings by employee, but also breaks it down for each employee by product and by position. The user has also specified to aggregate the earnings results for each employee by summing the more detailed level calculations.

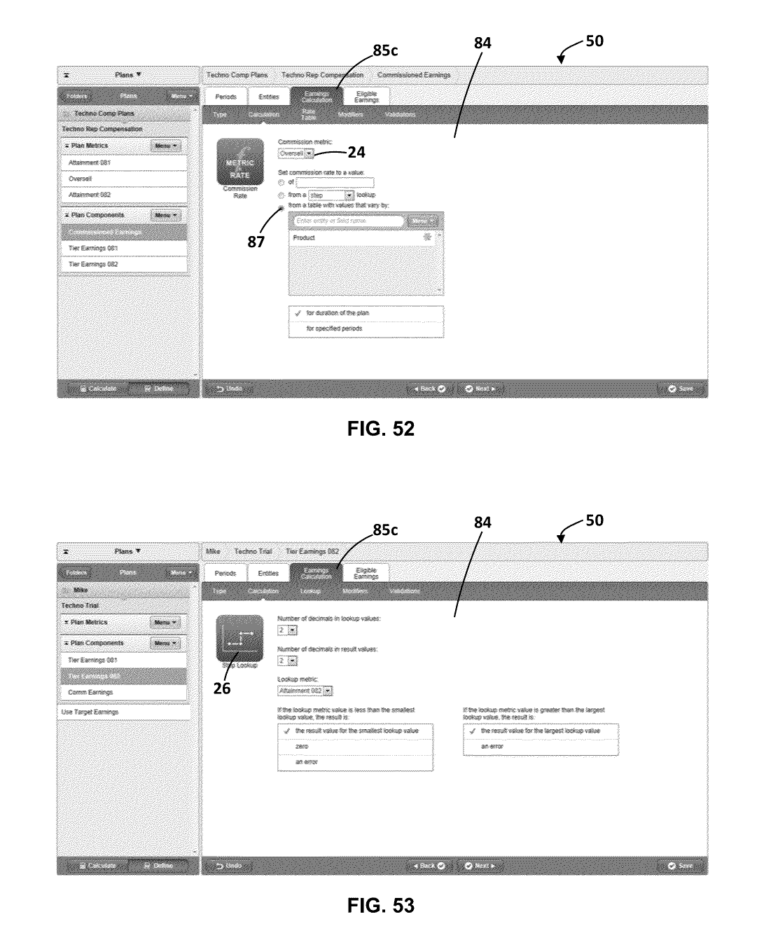

As shown in FIG. 51, the user may be guided to define the calculations performed by the selected plan component 26 to obtain earnings results. The earnings calculation determines the specific calculation to be performed on input data, which may be specified from one or more plan metrics' metric results. Like plan metrics 24, different types of available earnings calculations may be organized by category and presented to the user in a “Type” sub-tab shown in FIGS. 51 and 52. After the plan component 26 performs the specified calculation, the earnings results data may be modified using one or more modifiers as described above with respect to plan metrics 24. Earnings modifiers may include, for example and without limitation, floor, cap, hurdle, qualifier, accelerator, decelerator, round, round up, round down, and factor. Earnings results may be calculated as a numerical amount (such as a dollar amount), or alternatively may be calculated as a percent of a target amount, if target earnings are used in the plan 20. Furthermore, the user may define one or more validation conditions to be performed on the earnings results in a similar manner as described above with respect to plan metrics 24. Each plan component 26 performs a specified calculation on input data to return an earnings result. If different types of calculations must be performed on input data to calculate earnings in the same compensation plan 20, then multiple plan components 26 may be defined to each perform a specific earnings calculation. Multiple plan components 26 may also be required if earnings need to be calculated at different levels of detail in the same compensation plan 20.

When defining a plan component 26, the user may first be guided to define the plan component's earning calculation type, as shown in FIG. 51. Earnings calculations performed by plan components 26 may be categorized into, for example and without limitation, two different types: lookup calculations 86a, which utilizes a set of lookup values (i.e., the metric result inputs) and corresponding result values (i.e. the earnings result outputs) that are contained in a lookup table and plotted on a curve; and formula calculations 86b, which utilizes a metric result in a mathematical equation to return an earnings result. In the example shown in FIG. 51, the user has selected a formula calculation as the earnings calculation type. The present CPM system 10 may be configured to provide the user with a list of preset mathematical equations for commonly used compensation plan 20 earnings calculations, such as a commission rate calculation, and may also provide the user with the ability to specify custom formulas. One of ordinary skill in the art would recognized that there are a wide variety of interfaces that may be used to specify custom mathematical equations, thus a specific interface is not illustrated here for sake of simplicity. In the example shown in FIG. 52, the user has selected a commission rate calculation as the specific formula calculation 86b to be performed by the plan component 26. The commission rate calculation multiples a metric result used as the input (in this case, results from the “oversell” metric) by a commission rate to calculate earnings. The commission rate can be set as a constant value entered by the user, from a lookup table defined by the user or that already exists within the CPM system 10, or from another parameter table defined by the user or in the CPM system 10.

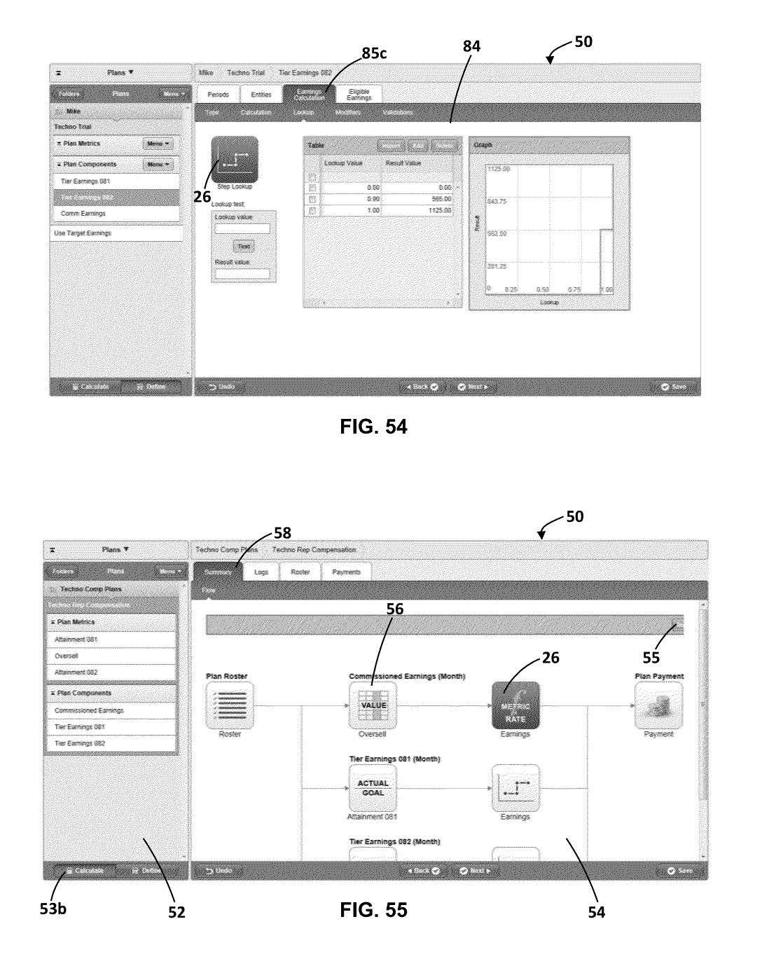

If the user selects a lookup calculation 86a as the type of earnings calculation to be performed by the selected plan component 26, the plan component definition element 84 may present the user with different interfaces and options for specifying the details of the calculation, as shown in FIGS. 53 and 54. Lookup calculations 86a are used to look up a metric result and dynamically return an earnings value for each instance of the earnings calculation entity. Different types of lookup calculations 86a may include, for example and without limitation, continuous lookup, step lookup, discrete lookup, or matrix lookup, and each may be represented by an icon displayed in the “Type” sub-tab of the earnings calculation tab 85c. A continuous lookup calculation interpolates a sequence of possible result values for the interval between each lookup value and the next highest lookup value specified, similar to the continuous lookup metric type 25p described above with respect to plan metrics 24. A step lookup maintains one possible result value for the interval between each lookup value and the next lookup value in the lookup table. A discrete lookup contains one possible result value for each lookup value. A matrix lookup maintains two lookup values fields in a grid, and the intersection of the two lookup values contains the result. One of ordinary skill in the art would appreciate that other types of lookup calculations 86a may be provided in additional to the specific examples described above. As discussed above with respect to plan metrics 24, a lookup table contains data points that are provided by the user and includes a lookup value field and a result value field, which may be graphically displayed in relation to each other on a curve. The manner in which a lookup calculation handles lookup values from the input data that are outside the range of lookup values from the lookup table varies depending on the specific lookup calculation type and other user specifications (such as shown in FIG. 53). Like the lookup plan metric types 250-25q, lookup calculations for plan components 26 may include a testing feature that allows the user to enter a lookup value and check the result value while configuring the plan component 26, as shown in FIG. 54.

After specifying the type of calculation to be performed by the plan component 26, the user may be guided to define the inputs to the plan component 26 for the earnings calculation, using the options shown in FIG. 52. The user may specify one or more plan metric's metric results as the inputs to the earnings calculation, as shown by the “Oversell” plan metric 24 results selected in FIG. 52. The CPM system 10 may be configured to only allow the user to select as inputs results from plan metrics 24 that have the same calculation entity or entities as the selected plan component 26, and the same calculation frequency as the selected plan component 26. The records in the metric results that are used as inputs for an earnings calculation may be automatically filtered to include records that match the plan roster records, based on the earnings entity value and the period the plan component 26 is being run for. If the earnings calculation utilizes multiple plan metrics 24, a valid record for each instance of the earnings calculation entity must exist in each plan metric 24 used as the input. The modifiers and validations that may be specified for a plan component's earnings calculation are substantially similar to what has already been described above with respect to plan metrics 24. The validations sub-tab of the plan component definition element 84 may present similar options to the validations a user may specify for a plan metric 24, as discussed above and shown in FIGS. 45-47, such as the ability to set validation severity levels, types of values to validate, and triggers for the validation.

Like other compensation plan 20 elements, a plan component 26 may be run individually or along with other plan elements when the entire plan 20 is run. Plan metrics 24 for which metric results are used as inputs to a plan component 26 are predecessors to the plan component 26, and thus must have been run for the same period that a plan component 26 is being run for. A plan component 26 is automatically submitted to be run for the period of the earnings calculation frequency that is the same or corresponds to the period being run for the overall compensation plan 20. For example, if a compensation plan 20 is being run for the month of December 2012, and the plan component's frequency is set to “quarter,” then the plan component 26 will be run for Quarter 4 of 2012. As shown in FIG. 55, a user may manually run an individual plan component 26 by itself by selecting the “Calculate” button 53b from the left hand pane 52, and then selecting the desired plan component 26 from the summary flow diagram 56, and then clicking the “Run” button 55 to process the highlighted plan component 26.

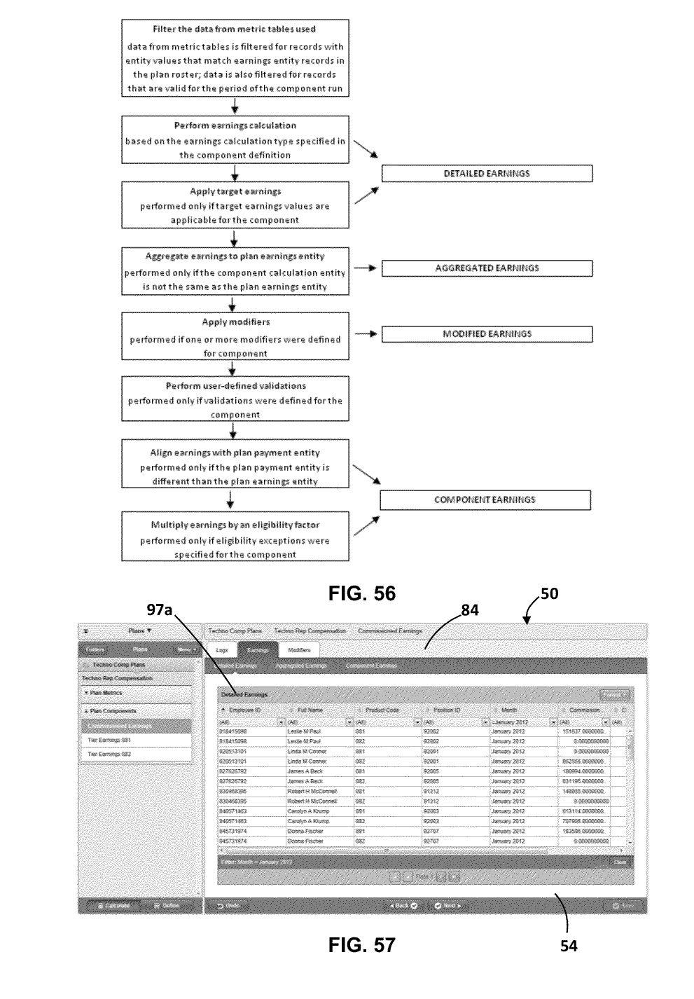

The diagram shown in FIG. 56 illustrates the steps associated with processing or running a plan component 26. First, the metric results data from the metric results table or tables 94 used as the input to a plan component 26 is filtered for records that have entity values that match the earnings entity records in the plan roster 22, and/or filtered for records that are valid for the period that the plan component 26 is being run. The CPM system 10 then utilizes the filtered input metric records to perform the earnings calculation based on the earnings calculation type and other specifications made by the user during the plan component definition. The earnings results from the earnings calculation are then stored in a detailed earnings results table created dynamically by the CPM system 10 with the proper table structure. If the user has specified target earnings values for the plan component 26, then target earnings are applied to the earnings calculation and the results stored in the detailed earnings results table. If the plan component 26 calculated earnings at a more detailed level than the earnings entity, the CPM system 10 then aggregates earnings for each instance of the plan earnings entity, and stores the aggregated earnings results in an aggregated earnings results table, which is also created dynamically by the CPM system 10 when the plan component 26 is defined or run for the first time. If the user has specified one or more modifiers for the plan component 26, the modifiers are applied in the order specified by the user to the earnings results, and the modified earnings results values are stored in one or more modified earnings results tables created dynamically by the CPM system 10. The system then performs any user-defined validations on the earnings results. If the plan payment entity is different from the plan earnings entity, the system may then align the earnings with the plan payment entity and store the results in a component earnings results table, also created dynamically by the CPM system 10. Where eligibility exceptions are specified for the plan component 26, the system also multiplies the earnings results by an eligibility factor specified by the user and stores the final earnings results in the component earnings results table, as specified as part of the plan payment settings, which are described below.

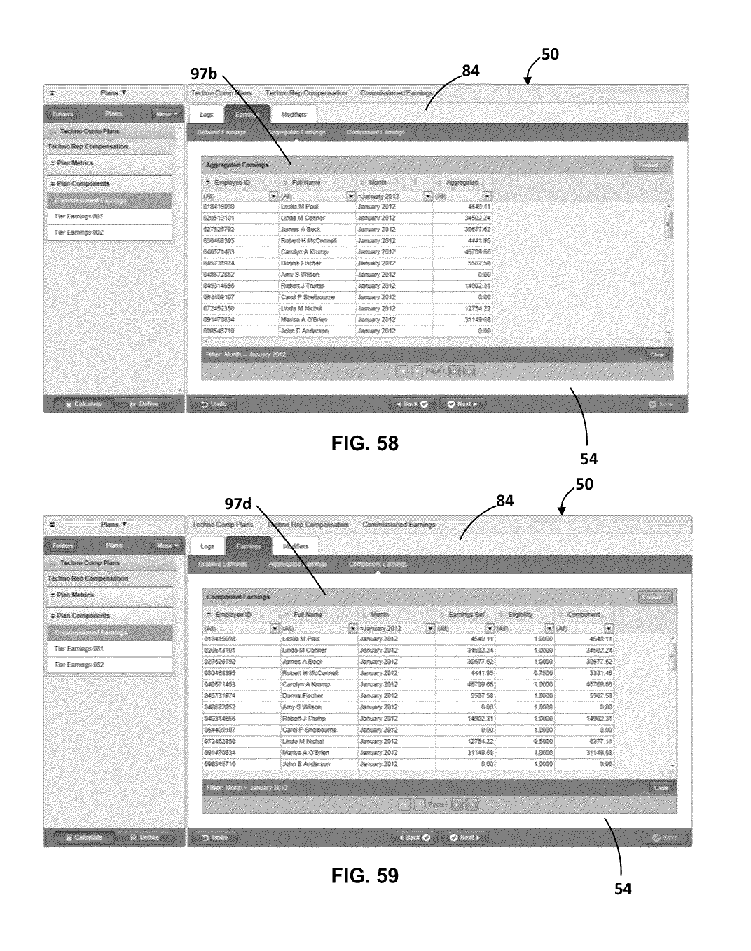

As described above with respect to plan metric results tables 94, a plan component 26 may be associated with multiple component results tables each created, populated, and maintained by the CPM system 10 dynamically as the plan component 26 is defined or processed for the first time. For example and without limitation, the following separate results tables may be created by the CPM system 10 for each plan component 26: a detailed earnings results table 97a that contains results of performing earnings calculations (including target earnings, if applicable), such as shown in FIG. 57; an aggregated earnings results table 97b that contains earnings aggregated to the plan's earnings entity (used if earnings were calculated at a more detailed level than the earnings entity), such as shown in FIG. 58; a separate component modifier results table 97c for each modifier applied to the earnings calculation results (the component modifier results table that contains the final modifier applied may be thought of as the modified earnings results table for calculating final earnings); and a component earnings results table 97d that contains the final earnings results, after the earnings have been aligned to the payment entity and any eligibilities applied, such as shown in FIG. 59. The component earnings results table 97d contains the result of all plan component earnings operations, and the results from this table are summed for all plan components 26 in a plan 20 for each instance of the earnings entity to produce total earnings data that is used as the input to a plan's payment calculations. As discussed above with respect to plan metric results tables 94, the present CPM system 10 may be configured such that a single earnings results table 96 is created and used to store all earnings results for a compensation plan 20, including the detailed earnings results, aggregated earnings results, modified earnings results, and final earnings results. As a further alternative, the modified earnings results may be saved in a separate table from the other earnings results data.

An aggregated earnings results table 97b is only created by the present CPM system 10 if the earnings calculation entity consists of at least one entity or field in addition to the earnings entity, and preferably contains the following data fields: the earnings entity; the payment period; the projected payment period; the component payment period; the projected indicator field; and the aggregated earnings. Similarly, a component modifier results table 97c is only created if one or more modifiers are applied to the earnings results of a plan component 26, and preferably contains the following data fields: the earnings entity; the projected payment period, the component payment period, the projected indicator field; the modifier metric value (if applicable); the threshold (if applicable); the qualifier (if applicable); the hurdle (if applicable); the unmodified earnings; the floor (if applicable); the cap (if applicable); the accelerator (if applicable); the decelerator (if applicable); the factor (if applicable); the modifier value (if applicable); and the modified earnings. The modified earnings results table 97c that contains the final earnings results after all modifiers have been applied preferably includes the following data fields: the earnings entity; the projected payment period; the component payment period; the projected indicator field; the unmodified earnings; and the modified earnings. Finally, the component earnings results table 97d, which is always created by the CPM system 10 when a plan component 26 is defined or processed for the first time, preferably includes the following data fields: the earnings entity; the payment entity; the projected payment period; the component payment period; the projected indicator field; the earnings before eligibility (if applicable); the eligibility factor applied (if applicable); and the component earnings.

As an alternative to creating and maintaining the separate earnings results tables 97a-97d discussed above, the present CPM system 10 may be configured to create a single earnings results table 96 for each compensation plan component 26, such as described with respect to plan metrics 24, so that the detailed, aggregated, modified, and component earnings results may all be maintained in one table and differentiated from each other using data fields. Alternatively, the present CPM system 10 may create a first earnings results table for all detailed, aggregated, and component earnings results for all plan components 26 in a given compensation plan 20, and create a separate second modified earnings results table that contains all modified earnings results for that plan 20. As a further alternative, the present CPM system 10 may create a single earnings results table for all plan components 26 in a given plan 20, to further reduce the number of data tables and provide a central repository for all earnings results data. In both of these instances, the collective earnings results table may offer support for different “versions” of a compensation plan 20, as will be discussed in detail below, such that earnings results from different versions of a compensation plan 20 are differentiated from each other and may be recognized by the system when used in other processes or applications.

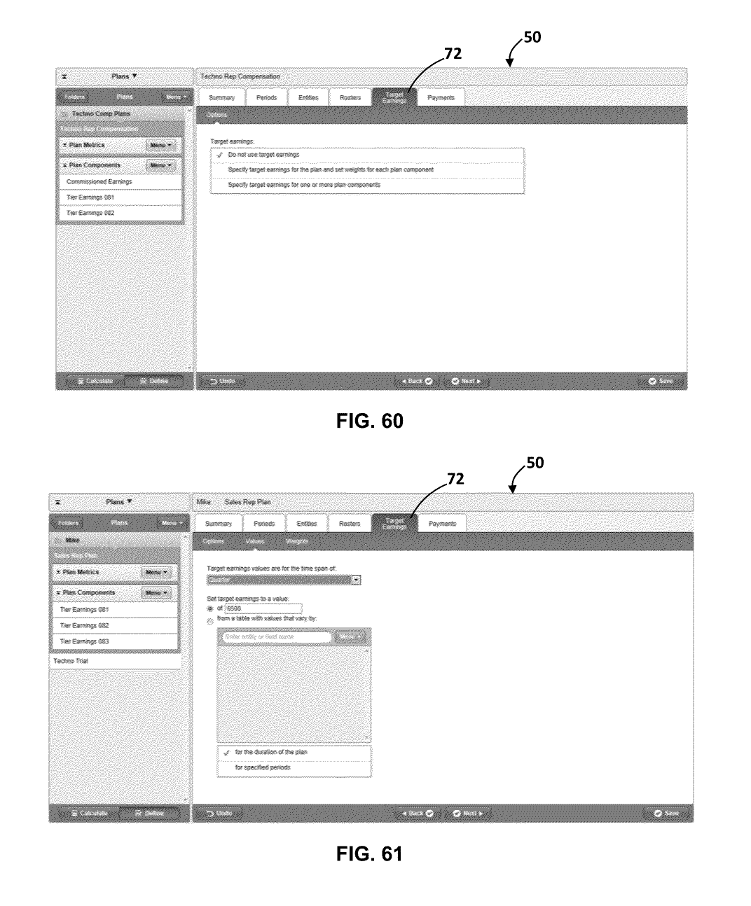

The following discussion provides an overview of target earnings. The present CPM system 10 supports the use of target earnings in a compensation plan 20 for plan components' earnings calculations. Instead of earnings calculations that result in a numerical value, which are aggregated across each of a compensation plan's plan components 26 to arrive at a final earnings result, target earnings calculate earnings results as a factor, which is multiplied by a target earnings value to determine an earnings amount. As shown in FIG. 61, the user may specify a single target earnings value, or choose to store multiple target earnings values in a parameter table, which is created by the CPM system 10 on an as-needed basis. If the necessary target earnings parameter table does not already exist in the system, the user is guided to provide the data records in the table during the plan or plan component definition stage by selecting fields by which target earnings values will vary and/or selecting to vary target earnings values by specified periods. The user may enter target earnings values into the parameter table directly, import values, or load them using a data load process. Target earnings may be set by the user on a plan “level” such that the entire compensation plan 20 utilizes target earnings, and each plan component 26 is assigned a specific weight (which represents the percent of the total target earnings amount allotted to that component). Alternatively, the user may specify target earnings within individual plan components 26. As shown in FIG. 60, a target earnings definition element 72 may be made available to the user as part of the plan definition elements of the graphical user interface 50, and the user may select whether target earnings should be used for the entire compensation plan 20 and specify the weights to be assigned to each plan component 26, or whether target earnings should be specified for one or more specific plan components 26. Target earnings may also be associated with a time span, which may be the same as the plan payment frequency or for a lesser frequency (e.g., payment frequency is month and target earnings are set by quarter). If the time span for a target earning is less frequent than the plan's payment frequency or the plan component's earnings calculation frequency in which the target earning values are specified, the CPM system 10 may automatically determine the fraction of the target earnings value to use in the earnings calculations for each payment period. For example, if a compensation plan's payments are made monthly, but a target earnings value is specified for a time span of quarter, then the target earnings value is divided by 3 to produce a target earnings value for each month of the quarter.

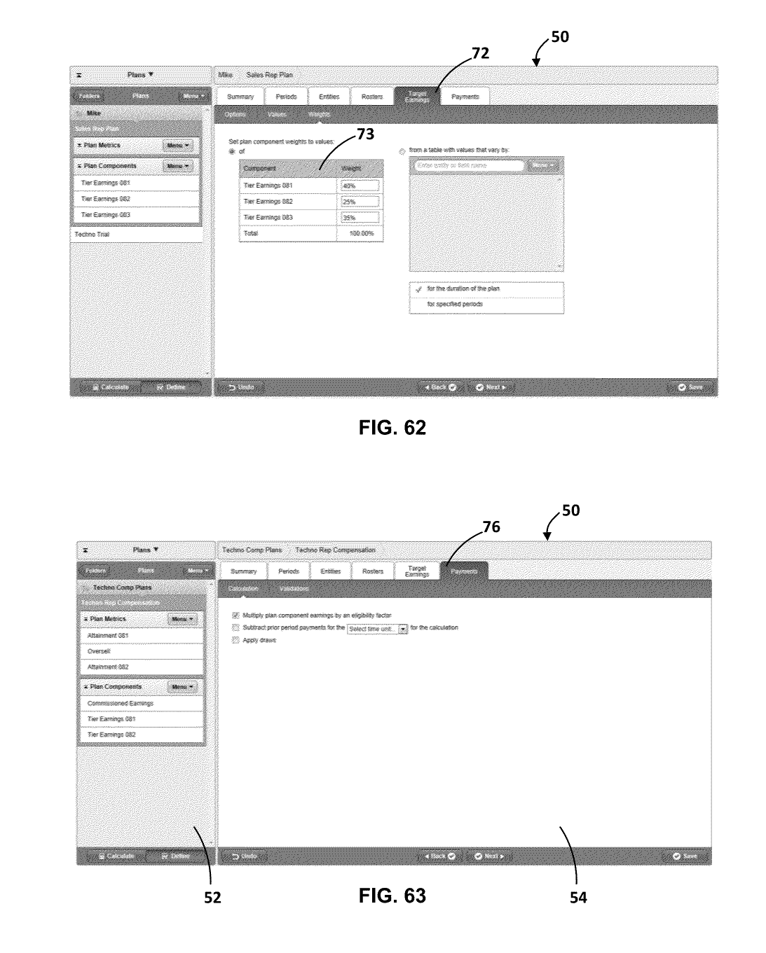

If the user elects to use target earnings on a plan level and specify weights for each plan component 26, each weight must be between the values of 0 to 100, and the total of all weights for all plan components 26 within in a plan 20 should add up to 100. The weights for each plan component 26 may be specified as a constant value or as multiple values that vary by entity and/or period, which may be stored in a parameter table 73, as shown in FIG. 62. Like other parameter tables in the present CPM system 10, the user may be guided by the system into setting up the target earnings weight parameter table 73 and providing the necessary entities, fields, or time periods by which weight values will vary. When target earnings are set for a compensation plan 20, the CPM system 10 may use the following formula to determine the portion of the plan target earnings value to use in each plan component's earnings calculation:

$$( plan target earnings ) \times ( component weight ) \times ( \frac{number of plan periods corresponding to component period}{ \begin{matrix}number of plan periods corresponding to time span for \\ target earnings\end{matrix} } ) .$$

If the user elects to use target earnings for a specific plan component 26, the CPM system 10 may use the following formula to determine the portion of the plan target earnings to use in each component's earnings calculation:

$$\frac{component target earnings value}{\begin{matrix}number of component periods corresponding \\ to time span for target earnings\end{matrix}} .$$

The following discussion provides an overview of plan payments 28. A compensation plan's payment calculation utilizes total earnings results from the plan's components 26 as the initial basis for determining the final payment due to the plan payment entity (which may be the same as or different from the plan earnings entity). The payment calculations may perform additional payment-related operations to the total earnings results data, including for example and without limitation: subtracting prior period payments; applying draws; making manual adjustments; and overriding payments. The plan payments definition element 76, as shown in FIG. 63, may be configured to provide guidance, present options, and receive user input related to these payment-related operations to be applied to the earnings results data to return payment results. Once the compensation plan 20 has been processed or run to produce final calculations, the final payment results may be stored in a payment results table 98 created dynamically by the system 10 the first time the plan payment 28 is defined or run, and additional payment results values appended for each subsequent period the plan 20 is run. As discussed above with respect to running plan rosters 22, metrics 24, and components 26, the user may manually select a compensation plan 20 to run by using the “Calculate” option 53b displayed in the left hand pane 52 of the graphical user interface 50. Since a valid plan roster table 69, plan metric result, and plan component earnings result are required for a plan payment 28 calculation, the plan payment 28 should not be processed individually but rather should be processed as part of the entire compensation plan 20 to generate plan payment results.

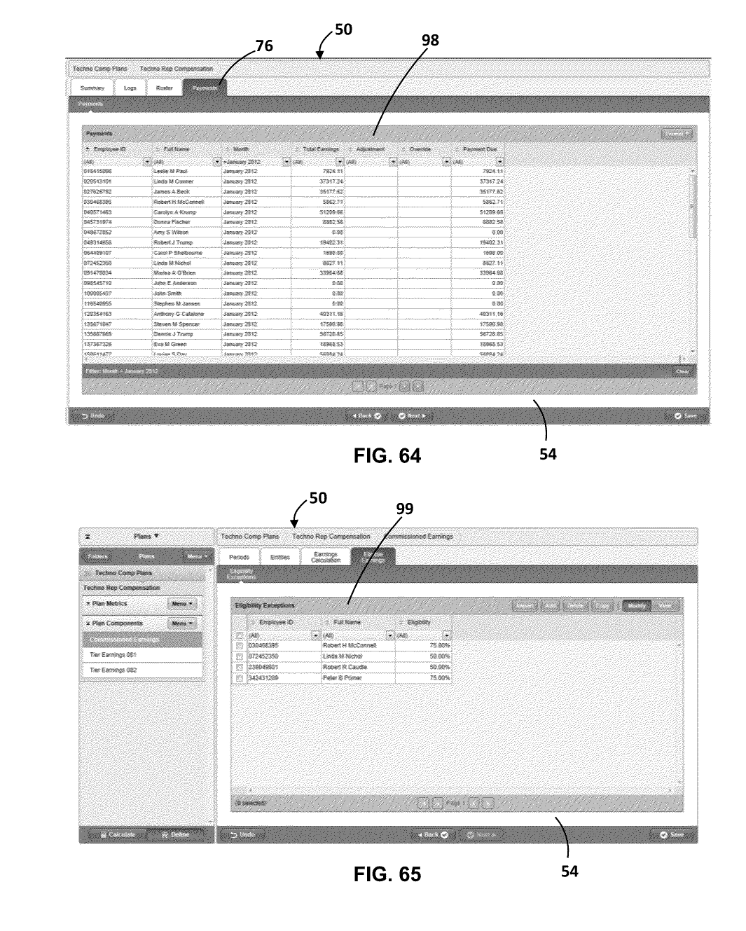

In the example shown in FIG. 64, the payment results table 98 shows the calculated payment results for each instance of the “Employee” entity for each month, which is the payment frequency for the compensation plan 20. As is the case with the plan roster tables 69, plan metric results tables 94, and plan earnings results tables 96 discussed above, the payment results table 98 for a compensation plan 20 may be configured so that a user cannot edit values in the table manually. Instead, the present CPM system 10 may be configured so that the only way to update values in a plan roster or results table is by rerunning the compensation plan 10 or specific plan element. This restriction on editing results tables ensures that no one can edit records in a results table to affect compensation payments, or makes changes that may affect a subsequent plan element and result in incorrect calculations. Instead of allowing for manual edits to a results table, a compensation plan 20 may be configured to incorporate payment adjustments or overrides (as would be reflected in those fields in the payments results table 98 illustrated in FIG. 64) by defining them as part of the payments calculation as discussed below. These payment adjustments and overrides may be maintained in parameter tables provided by the present CPM system 10 within a feature for managing payments. The values from the payment adjustments and overrides parameter tables are specified by the user, and may then be used by the CPM system 10 when calculating payments 28 for a plan 20.

As shown in FIG. 63, a compensation plan's payment calculation may include multiplying component earnings results by an eligibility factor, which is expressed as a percentage. Eligibilities are used when one or more instances of the earnings entity are eligible to receive only a percentage of their earnings as actual payments. Using an eligibility exceptions table 99, as shown in FIG. 65 the user may specify exceptions to 100% earnings eligibility for a specific plan component 26. The eligibility percentage for each instance of the earnings entity is then multiplied by the earnings result value for that instance as the final step of calculating final earnings for the earnings entity.

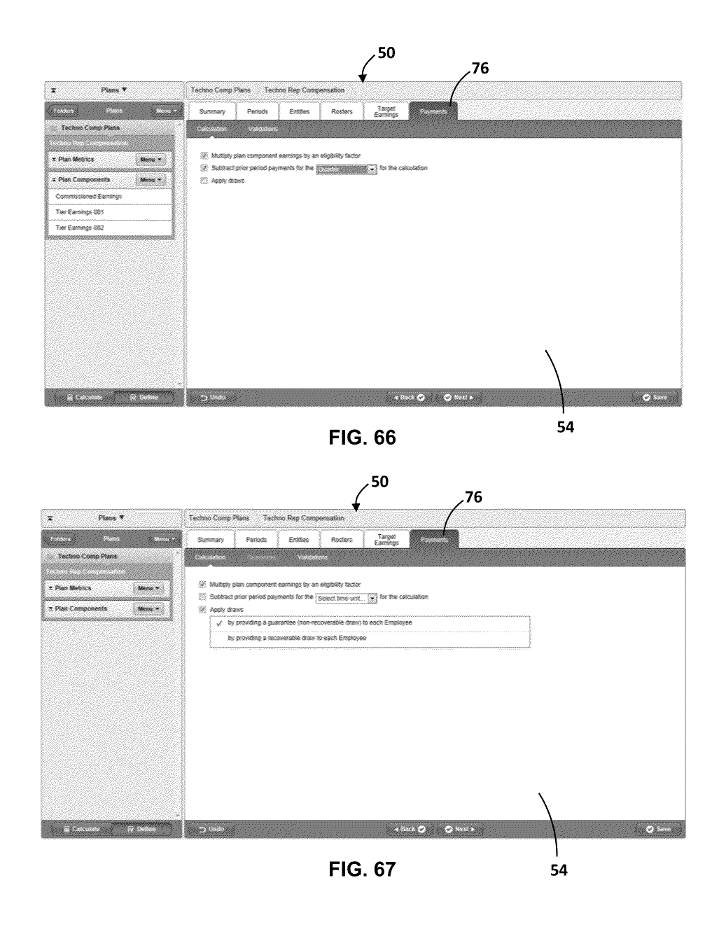

In addition to applying eligibility factors, a user may also elect to subtract prior period payments from earnings results to calculate payments 28, as shown in FIG. 66. The payment calculation where prior payment data is subtracted may be performed using the following formula: MAX (total earnings−sum of prior period payments, 0). Any calculated projected payments are not used to determine the sum of prior period payments, only actual payments that were calculated for the previous plan payment period. The user may specify how far back the plan payments 28 are summed by limiting the time frame selection, as indicated by the second checkbox option shown in FIG. 66, where payments already made within the current quarter would be subtracted from the total earnings value. If the plan payment period is the first period of the specified time frame or if a payment entity value doesn't have any prior payments, the sum of prior period payment would be zero. A further example of subtracting prior period payments is shown below in Table 4, where the compensation plan 20 is run each month to calculate projected payments, but actual payments are only made on the last month of each quarter.

TABLE 4

| | | Prior | | Current |
|---|---|---|---|---|
| | Total | Payment | Projected | Period |
| Month | Earnings | Calculation | Payment | Payment |
| January | 300 | 300 − 0 | 300 | |
| February | 250 | 250 − 0 | 250 | |
| March | 500 | 500 − 0 | 500 | 500 |
| April | 1540 | 1540 − 500 | 1040 | |
| May | 1230 | 1230 − 500 | 730 | |
| June | 1400 | 1400 − 500 | 900 | 900 |
| July | 2350 | 2350 − | 950 | |
| | | (500 + 900) | | |
| August | 1200 | 1200 − | 0 | |
| | | (500 + 900) | | |
| September | 1350 | 1350 − | 0 | 0 |
| | | (500 + 900) | | |

In January, February, and March, there are no prior payments to subtract from total earnings, so using the formula above, the maximum value is the total earnings amount and the projected payment for each month is the same as the total earnings amount. In April, May, and June, the prior quarter's payment (the payment made in March under the “Current Period Payment” field) is subtracted from the corresponding monthly total earnings amount. In each month, the result of this calculation is greater than 0 and thus is used as the projected payment or actual payment. For example, in June the prior quarter's payment of 500 is subtracted from the total earnings value of 1400 to produce a result of 900. Since 900 is greater than 0, the payment result for June is 900. In July, August, and September, the two prior quarter's payments (from March and June) are summed and then subtracted from the corresponding monthly total earnings amount. In July, the result of this calculation is greater than 0 and becomes the projected payment. However, in August and September, the result of the calculation is a negative value, since the total earnings for each month is less than the sum of the previous two payments in March and June. As a result, the project payment for August and the actual payment for September are both 0.

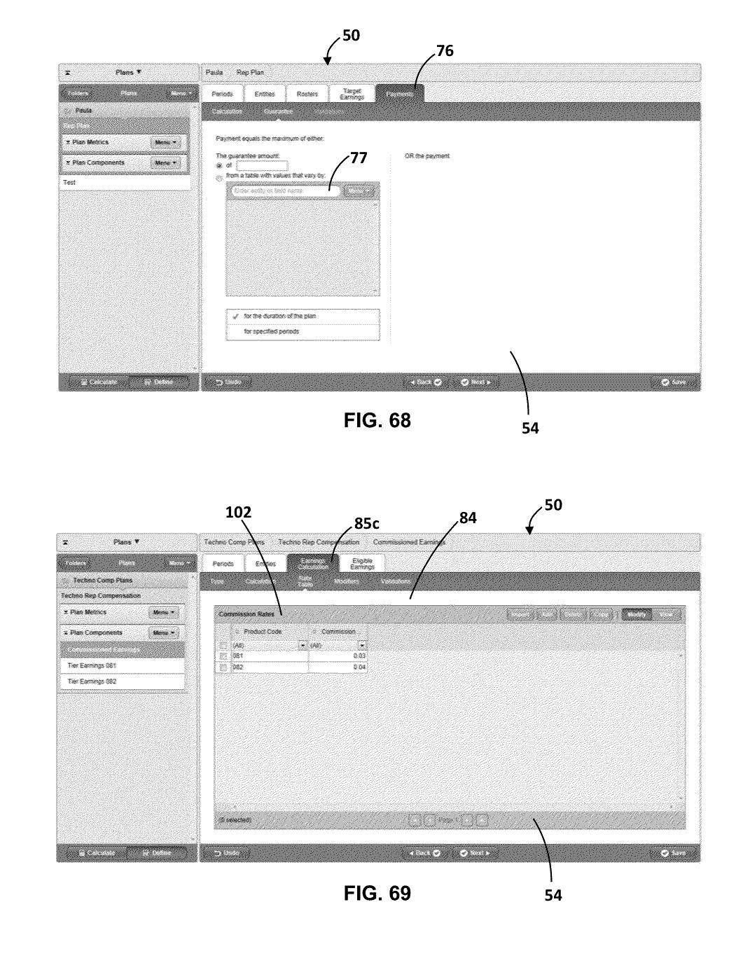

A compensation plan 20 may also be configured to calculate payments by applying a draw, which is a minimum payment that an instance of the payment entity receives in a payment period if its current payment does not exceed a specified amount. Draws are commonly used in sales compensation plans, and may be applied by: providing a guarantee, which enables entities to be paid a minimum guaranteed amount each payment period and not owe any money; or providing a recoverable draw, which enables entities to be paid a minimum amount each payment period by drawing against future earnings. Optimally, a user would only specifying one type of draw within a given compensation plan 20. If both a guarantee and a recoverable draw need to be used to calculate compensation, the user should preferably define two separate compensation plans 20 to do so. As shown in FIGS. 67-68, the payment definition element 76 may present a checkbox option for the user to indicate that a plan payment 28 should apply draws by providing a guarantee (i.e., a non-recoverable draw) or a recoverable draw. For a guarantee, the present CPM system 10 may be configured to calculate payments as the maximum of either the guarantee amount or the current period's calculated payment result. If the guarantee amount is greater than the calculated payment results, the difference does not have to be paid back by the instance of the payment entity. As shown in FIG. 68, the user may specify the guarantee amount as a constant value or from a parameter table 77 where the guarantee amount varies by values in another field, and may further specify whether the guarantee should be applied for the duration of the compensation plan 20 or only for a specified period.

If the user indicates that a plan payment 28 should apply draws by providing a recoverable draw, a different set of rules is applied to the plan payment calculation. If a specified draw amount is greater than the calculated payment, the difference between the two values is maintained in the CPM system 10 as a “draw balance.” The payment to each instance of the payment entity is determined as the maximum of either the recoverable draw amount or the current period's calculated payment result minus the previous period's draw balance. The draw amount may be reimbursed in the future from one or more payments that exceed the draw amount. If a compensation plan 20 is calculating projected payments, the previous period's draw balance is that from the previous payment period, not the previous projected payment period. The user may also limit the subtraction of prior period draw balance to a specified period of time, such that the draw balance is reset to zero after some specified time (e.g., after each quarter). The user may also specify the recoverable draw amount as a constant value or within a parameter table, known as an adjustment table, and specify whether the recoverable draw should be applied for the entire duration of the plan 20 or only for certain periods. An example of how a recoverable draw operates in plan payment calculation is illustrated below in Table 5, where the draw balance repayment is limited to the current quarter.

TABLE 5

| | | | Recoverable | Prior Period | Payment | |
|---|---|---|---|---|---|---|
| Quarter | Month | Payment | Draw Amount | Draw Balance | After Draw | Draw Balance |
| 1 | January | 8000 | 5000 | 0 | 8000 | 0 |
| 1 | February | 3000 | 5000 | 0 | 5000 | 2000 |
| 1 | March | 4000 | 5000 | 2000 | 5000 | 3000 |
| 2 | April | 3000 | 5000 | 0 | 5000 | 2000 |
| 2 | May | 6000 | 5000 | 2000 | 5000 | 1000 |
| 2 | June | 5500 | 5000 | 1000 | 5000 | 500 |
| 3 | July | 8000 | 5000 | 0 | 8000 | 0 |
| 3 | August | 2000 | 5000 | 0 | 5000 | 3000 |
| 3 | September | 9000 | 5000 | 3000 | 6000 | 0 |

Assuming that the payment frequency is monthly for the compensation plan 20, in January the employee's payment result is 8000 and there is no prior period draw balance, so the payment after draw is 8000 and the draw balance is 0. In February, the employee's payment is 3000, and the employee has no prior period draw balance, so in this month the maximum value is the recoverable draw amount of 5000, so payment after draw is the recoverable draw amount of 5000, and a recoverable draw balance is 2000 is maintained in the system. In March, the payment is 4000, and the employee has a prior period draw balance of 2000, so the maximum again is the recoverable draw amount and the payment after draw is 5000. The difference between the payment after draw and payment result (1000) is added to the draw balance, which increases to 3000. In April, the payment is 3000, while the prior period had a draw balance, it is not carried over to Quarter 2 because the plan was configured to limit the subtraction of a prior period draw balance to the current quarter. Therefore, the draw balance is reset to 0, the payment after draw is the recoverable draw amount of 5000, and the draw balance for April is 2000. In May and June, the employee's payment exceeds the recoverable draw amount, but not by enough to completely reimburse the draw balance. Therefore, each month's payment after draw is the recoverable draw amount, and the excess is used to gradually decrease the draw balance to 500. However, a new quarter starts in July, so the existing draw balance of 500 from June is not carried over and used in calculations for July.

The user may also elect to make manual adjustments to payments, by entering manual adjustments into an adjustment table that is created by and maintained within the CPM system 10. The adjustment values are summed across records for each payment entity instance and payment period. If the compensation plan 20 is configured to calculate projected payments, adjustment values entered for a payment period will be applied to all projected payment periods that corresponds to the plan payment period. Similarly, the user may make overrides to payments by entering override values into an overrides table that is created by and maintained within the CPM system 10. The override value replaces an entity's current payment value for the payment period, and is used as the final payment (i.e. overrides are applied as the last step of payment calculations). If the compensation plan 20 calculates projected payments, override values entered for a payment period will be applied to all projected payments that correspond to the payment period. Although examples of adjustment and override tables are not shown, one of ordinary skill in the art would understand these tables can be arranged in numerous ways to include the necessary fields discussed above.

In the present CPM system 10, the plan payment results table 98 preferably contains the following data fields: the payment entity; the projected payment period (if applicable), the payment period; the projected payment indication (usually containing a value of “Y” or “N”); the total earnings results (containing the payment values immediately after component earnings results are aggregated and any eligibility is applied); prior period payments (this may be included only where prior period payments are being subtracted for the payment calculation, and may display the total sum of the previous payments in the time frame specified in the plan definition); the current period payment (the maximum between the total earnings minus the prior period payments and 0); the guarantee amount (this may be included only where a guarantee has been defined and used, and may display the guarantee value for each instance of the payment entity); the recoverable draw amount (this may be included only where a recoverable draw has been defined and used, and may display the recoverable draw value for each instance of the payment entity); the prior period draw balance (this may be included only where recoverable draws are defined for the plan, and if the option to limit the subtraction of previous draw payments and the payment period is the first period of the corresponding time period for the time unit selected as the limit, the prior period draw balance may be displayed as 0); the payment after draw (this may be included only where a guarantee or recoverable draw has been defined); the manual adjustment (where manual adjustments are applied, this field may display the sum of the adjustment field values for the payment entity and plan payment period using values from the adjustment table); the override (where overrides are applied, this field may display the override value for the payment entity and plan payment period using values from the override table); the payment due (the final value of the payment calculation). Similarly to the plan roster tables 69, 70, metric results tables 94, and earnings results tables 96 discussed above, the plan payment results table 98 may be configured to provide support for different versions of a compensation plan 20. Thus payment results from different version of the plan 20 can be maintained in the same table 98 and differentiated from each other, in a way that is recognized by the CPM system 10 or when used in other system processes or outside applications.

As discussed above, the present CPM system 10 may create and populate various roster 69, 70 and results tables 94-98 dynamically based on the user's specifications for the plan elements that these tables are associated with. The CPM system 10 may be configured so that certain fields in a plan roster or results table are “fixed” in the sense that the field may always appear in the table, while other fields are “variable” in the sense that the field changes depending on user specifications during the plan definition stage. For both fixed and variable fields, certain fields may be configured to always appear with a standard predetermined field name, while the names of other fields may depend on the plan specifications. Having fixed and variable fields with standard and custom field names helps to balance the needs of standardization and customization in the present CPM system, and also aids end users and system administrators in maintaining and utilizing the roster and results tables. The specific fixed and variable fields and field names for each roster and results table will not be discussed in detail, as one of ordinary skill in the art would understand the types of data fields that are applicable to each type of table, and that decisions regarding the fixed or variable nature of fields and their names are dictated by specific logic and business needs.

The following discussion provides additional information regarding plan parameter values and parameter tables, which have already been discussed in some detail above with respect to their use in plan metrics 24, components 26, and payments 28. In the present CPM system 10, plan parameters 29 represent values that are used in a compensation plan's calculations (e.g., target earnings, commission rates, etc.). A plan parameter 29 may have a single constant value, or multiple values that vary based on another value and are stored in a parameter table 100, or may be values stored in one of various types of lookup tables (a type of parameter table). Examples of types of parameter values that may be stored in parameter tables 100 to be used by a compensation plan element include, without limitation: target earnings, weights, guarantees, recoverable draws, eligibility exceptions, commission rates, lookup tables, values used in modifiers, and baseline prior period values. Parameter tables 100 are defined by the user directly within a plan metric 24, plan component 26, plan payment 28, or the overall compensation plan 20, and are created by the CPM system 10 dynamically on an as-needed basis as they are being defined by the user. This ensures that the parameter table 100 has the proper table structure, and eliminates the need for the user to set up parameter tables 100 outside of the compensation plan 20 and then link those tables up with the plan elements that require parameter values in those tables. The present CPM system 10 may be configured such that a parameter table 100 can only be used within the specific plan element or compensation plan 20 in which it was defined, so that two compensation plans 20 cannot “share” the same parameter table 100 as doing so may lead to conflicts when the compensation plans 20 are being processed, or changes to a parameter table's structure that negatively affects the plan 20 in which it was defined. Alternatively, the present CPM system 10 may allow a parameter table 100 to be shared across different plan elements and/or compensation plans 20, by providing other means of avoiding structural conflicts, thereby ensuring that a shared parameter table 100 contains the necessary fields to work with each plan element and/or plan. The data values maintained in parameter tables 100 may also be used in other business applications 16 that are outside of but associated with the present CPM system 10, such as elements of a larger SPM system 14 in which the CPM system 10 is integrated.

The interface for defining a parameter table 100 may be presented directly within the plan metric definition element 80, the plan component definition element 84, or the plan payment definition element 76 in which the parameter table's values are being used. When a parameter table 100 is required, the user is guided to configure and provide data values for the parameter table 100 by answering logical business questions instead of being asked to “define a table” in a generic fashion. Parameter tables 100 may store parameter values that vary by entities and/or fields (based on the entities and fields for which the calculation is being performed), and/or by periods of the plan metric/component/payment frequency. To use an earlier example where the user is defining a plan component 26 that performs earnings calculations based on a commission rate calculation, as shown in FIG. 52, the user may choose to obtain the commission rate from a parameter table 100 with values that vary by each instance of the product entity or field, by checking the third checkbox 87. The user is then guided to a commission rate parameter table 102 as shown in FIG. 69, which if it does not already exist is created dynamically by the system 10, and the user is guided to supply the data values for the parameter table 102 either by manually entering the data, by importing the data, or by using a data load process. In this example, the commission rate varies by product, and the “product” entity would have been selected as part of the earnings calculation entity for the plan component 26 being configured. FIG. 70 illustrates another exemplary parameter table 104 in which target earning values vary by specified periods of the plan payment frequency. In other words, if a compensation plan 20 utilizing the parameter table 104 is being run for a period between January and July of 2011, a target earnings value of 2000 would be used. If the compensation plan 20 is being run in August of 2011, a target earnings value of 3000 would be used instead.

The following discussion provides an overview of using compensation plans 20 and plan data in other SPM applications. Once a plan parameter table 100 or plan results table 94-98 has been created by the present CPM system 10, it may be used by another SPM application 16 associated with the CPM system 10, such as input data to other processes like data load or data transformation. The plan parameter tables 100 and results tables 94-98 may also be displayed to other users via data views, such as through a customized user portal that allows an end user to view specific data that the user has permission to access. For example, a manager may be granted permission to view a compensation plan's payment results table 98 to see the payments made to every employee that the manger is responsible for. However, as discussed above, it would be desirable to restrict the user from manually editing records when viewing such a payment results table 98. Plan parameter tables 100 and results tables 94-98 may also be used as the basis for submitting workflow requests in a workflow system associated with the present CPM system 10, or in workflow applications that are part of a larger associated SPM system 14, such as when an end user wishes to submit a dispute or other workflow request associated with a data record in a plan parameter 100 or results table 94-98. When defining a parameter table 100 in the CPM system 10, a user may utilize the CPM system's data load functionalities or those of an associated SPM system 14 to load data into the parameter table 100. Plans results tables 94-98 created and maintained in the present CPM system 10 may further be used as the report data sources for dynamic reports that are created and customized for individuals within an organization, or customized dashboards or other portal views displayed to those individuals. For example, a specific user's earnings data from a compensation plan's aggregated earnings results table 97b may be selectively displayed to the user via a user portal application of a SPM system 14 that the CPM system 10 is associated with. Using the navigation options and other features provided by the portal application, the user may view his or her earnings data by period, sort the earnings data, or enter workflow requests related to the data.

The compensation plans 20 defined and implemented within a CPM system 10 may themselves be used with other applications that are associated with the CPM system 10. For example and without limitation, the present CPM system 10 may be integrated with a SPM system 14 that includes a job management system, which allows the user to configure and manage the automatic running of certain system processes as part of “jobs” performed by the system. A compensation plan 20 within the present system 10 is a type of process that may be run in a “job” as defined by the job management system. For example and without limitation, a compensation plan 20 may be added to a job so that it can be run with other processes, such as data load processes and other alignments and crediting processes, and be scheduled to run on a reoccurring basis to calculate compensation payment information. Instead of being separate, the job management system may also be integrated with the CPM system 10 described above such that after defining one or more compensation plans 20 using the compensation plan creation element 35a of the software 34 and associated plan definition elements presented in the graphical user interface 50, the user may utilize a job management component 35d of the software 34 and associated graphical user interface elements to set up a job that automatically runs the compensation plan 20 on a regular basis. This job management element 35d may be part of or associated with the compensation plan processing element 35c of the software 34.

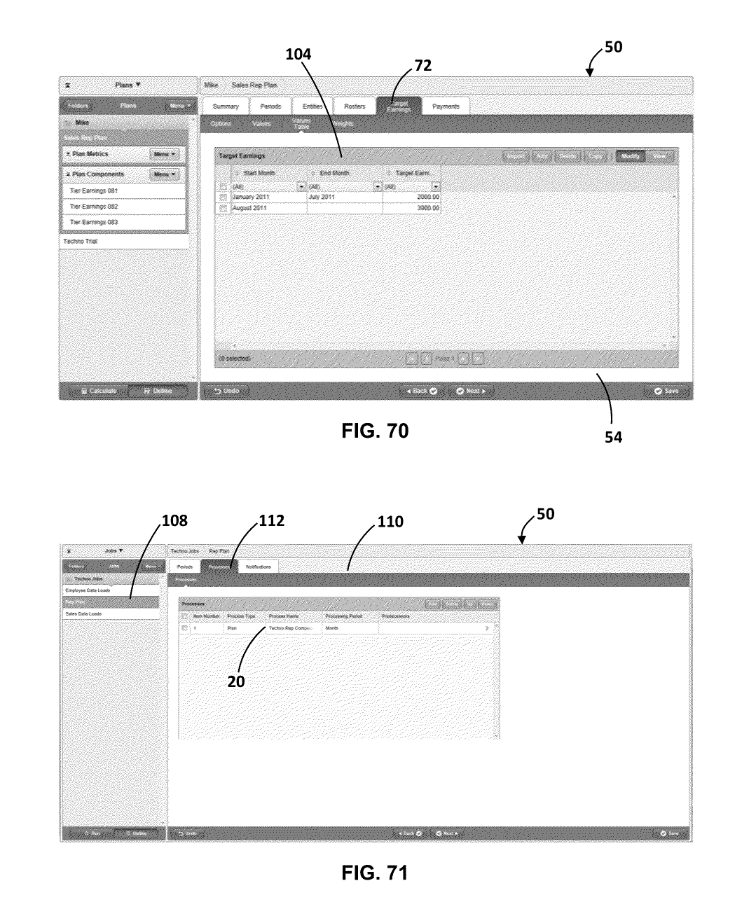

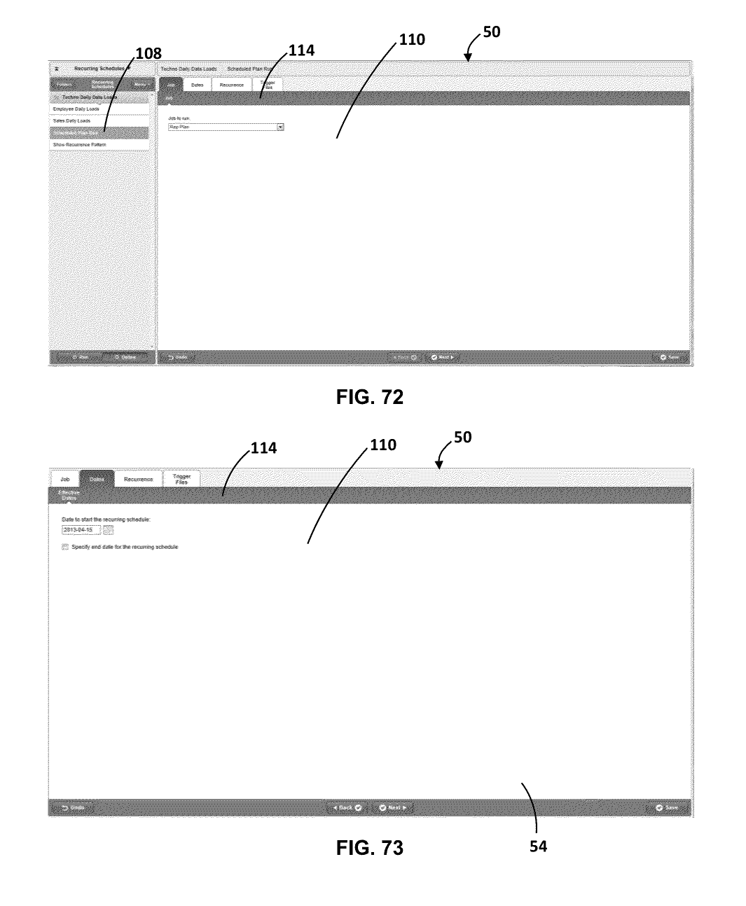

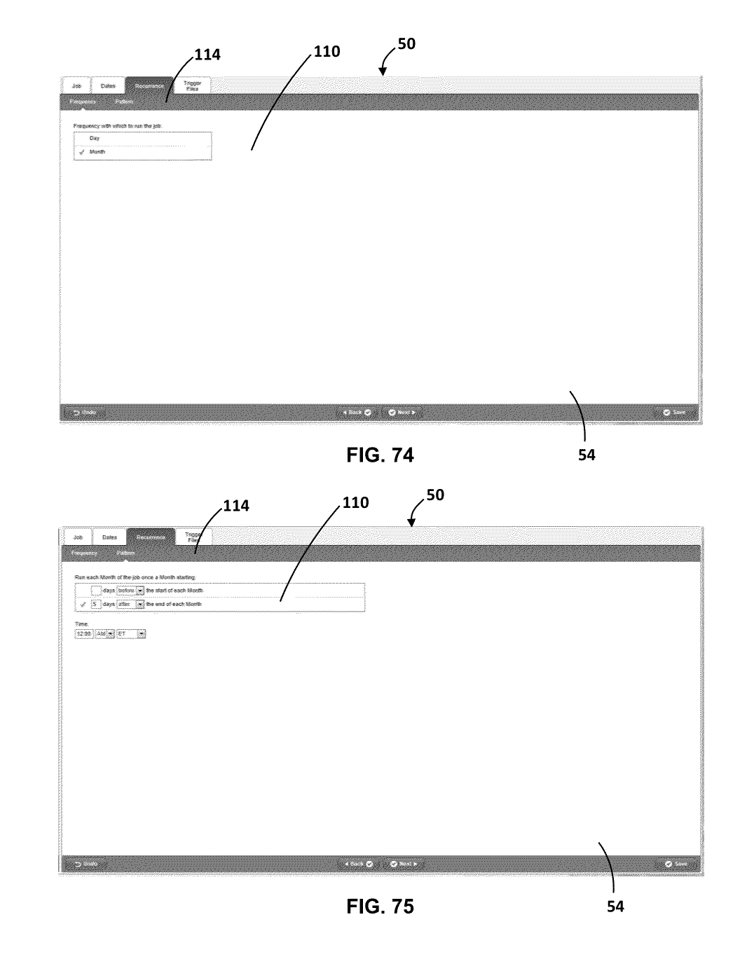

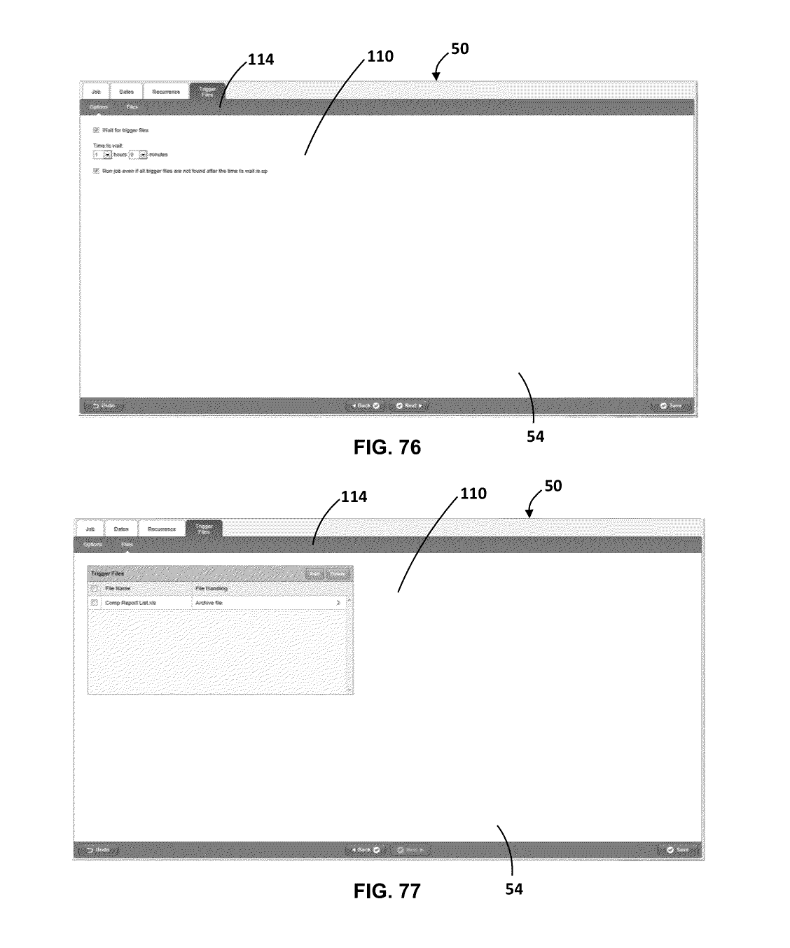

FIGS. 71-77 illustrate an exemplary job management definition element 110 that may be presented to the user via the graphical user interface 50 to configure a job 108 that includes a compensation plan 20 created in the CPM system 10 and set up automatic periodic processing of the compensation plan 20 along with other job elements. As shown in FIG. 71, the desired compensation plan 20 (e.g., Tencho Rep Compensation Plan) may be added to the job as a process using a process definition tab 112 of the job management definition element 110. The job definition element 110 may further include a schedule definition element 114, which allows the user to schedule a the job to be run on a recurring basis. In the example shown in FIG. 72, the job 108 containing the compensation plan 20 has been selected to run on a reoccurring schedule, which is further defined by the user using the interface shown in FIG. 73. The effective date selected by the user as the starting date of the reoccurring schedule indicates when the job 108 containing the compensation plan 20 can start running. The user may also optionally select an end date for the reoccurring schedule. As shown in FIG. 74, the frequency of a reoccurring schedule is based on the processing period of the job 108 for which the schedule is being defined. Where the job 108 contains a compensation plan 20, the processing period for the job 108 should corresponding to the plan's payment period, which in this example is every month, so the reoccurring schedule for the job 108 may be defined to run on a daily or monthly basis. Using the interface 114 shown in FIG. 75, the user may further specify the reoccurrence pattern for the schedule, which determines the day and time on which the job 108 will be run each month. The user may also specify whether a trigger file is required for a job 108 to run as part of a reoccurring schedule, as shown in FIG. 76. The job management component 35d may be configured to look for the trigger file before running the job 108. The trigger file may be a file required by the process itself (e.g., a file that contains data being used in the process), or it may simply be a file whose presence indicates that the process is ready to be run. As shown in FIG. 77, more than one file may be specified as a trigger file for a job 108 on a reoccurring schedule.

The following discussion provides an overview of versioning of compensation plans. As discussed above, an organization may make periodic updates to its compensation plans 20 that result in changes in how a compensation plan 20 calculates earnings and payments, but may not substantially impact the structure and setup of the plan. While these changes may be accounted for by creating new compensation plans 20 in the present CPM system 10, doing so may be inefficient where the changes are minor and/or frequently made, and may result in confusion for the user and other system processes or objects (like data views in a user portal) that utilize the same data used as inputs or produced as outputs by the compensation plan 20. Accordingly, the present CPM system 10 is configured to support different “versions” of the same compensation plan 20, so that changes to a plan 20 may be made over time and still recognized by the system 10 and user as a single plan, as opposed to a series of different compensation plans. Having different versions of a compensation plan 20 also gives the user a useful way of tracking changes to the plan 20, and to recalculate earnings and payments information for a past period when necessary even if the plan has since then changed.

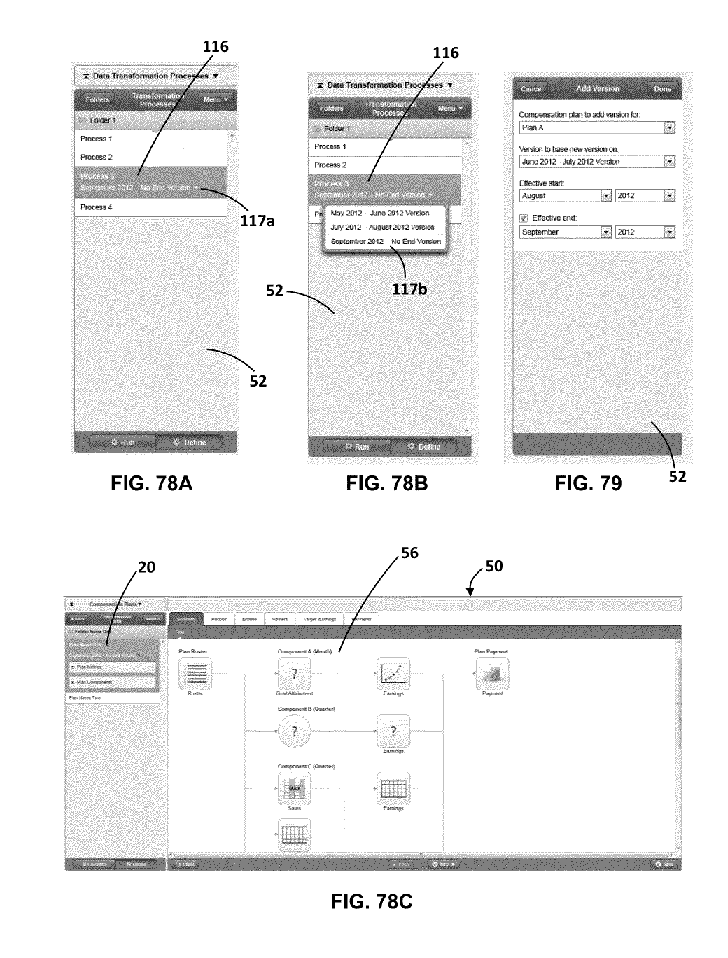

Other processes in the CPM system 10 or associated business applications 16 may also support this “versioning” concept. For example and without limitation, the job management system or software element 35d discussed above may support different versions of a process being managed within the job management system, such as a data transformation process or a compensation plan 20. FIGS. 78A and 78B illustrated a data transformation process 116 that may be part of a job that also contains a compensation plan 20, and the data transformation may be used to process input data to the compensation plan 20. A compensation plan 20 that has multiple versions may be displayed in a similar way as the data transformation process 116 shown in FIGS. 78A and 78B. When a specific data transformation process 116 is selected, for example via the left hand pane 52 of the graphical interface 50 as shown in FIG. 78A, the selected version of the data transformation process 116 may be displayed to the user. If the user wishes to view or run a different version of the same data transformation process, the user may select the arrow 117a shown in FIG. 78A, when then displays the dropdown menu 117b shown in FIG. 98B that lists additional versions of the same process 116. The user may then select a different version for review or processing purposes. FIG. 78C illustrates how different versions may be displayed and selected for a compensation plan 20 within the present CPM system 10. The specific example shown in FIG. 78C shows a particular version of a compensation plan 20 named “Plan Name One” that is effective for the time period of September 2012 to the present, with no end date set. If the user wishes to specifies a new version of the same compensation plan, the user do so using the left hand pane 52 of the graphical user interface 50 as shown in FIG. 79, and create a new version that starts after an end date specified for the current version of the compensation plan 20 shown in FIG. 78C.

It is important for a compensation plan 20 to support more than one version for different effective periods, as the definition of a compensation plan 20 encompasses a set of business rules that is likely to change over time. The present CPM system's plan versioning functionality enables the specifications of a plan to change over time but still remain part of a single plan definition. This also saves user administrative time and reduces changes for user error, as the user does not need to manually re-associate a new compensation plan 20 with the objects and applications associated with the old plan each time a change is introduced. As a result of having different versions of the same plan, any other object or application that makes use of the plan 20 (e.g., the job management system/element discussed above) or the plan's results (e.g., the user portal, dashboards, or reporting systems discussed above) will continue to work without any modifications even if the plan specifications change. Versioning of a compensation plan 20 is different from making copies of a plan. Even if a user made a copy of an existing plan and then made changes to it to save time and reduce possibilities for error, that resulting plan would still be considered a new plan within the CPM system 10, and any objects or applications that uses the original plan or plan results as an input may not recognize the new plan without additional modifications to those objects or applications.

Each version of a compensation plan 20 is represented by a range of non-overlapping effective periods. When a plan 20 is run for a given period, the system 10 determines what version of the plan is associated with that period and uses the appropriate corresponding specifications during processing. As shown in FIG. 79, the user may easily add a new version of a compensation plan 20 based on an existing version of the plan. For example and without limitation, the user may select a compensation plan 20 from the left hand menu 52 of the graphical user interface 50, and use a menu button to select the “add version” option, which displays the configuration options shown in FIG. 79 and receives user input regarding which compensation plan 20 to add a version to, which version of the plan (if other versions exist) to base the new version on, and the effective periods for the new version. When a new version of a compensation plan 20 is added in addition to an existing version, the system 10 validates that the effective periods of the different versions do not overlap. When a new version of a compensation plan 20 is added in addition to an existing version, almost any specification of that compensation plan 20 may be modified, except for elements that are fundamental to the plan's core definition. For example and without limitation, the present CPM system 10 may be configured to prohibit the user from modifying a plan's earnings and payments entities, and the payment and projected payment frequency of the plan when an additional version of a plan is being defined. However, if only one version of a compensation plan 20 exists, the CPM system 10 may permit the user to modify those elements when creating the first new version. When creating new versions of a compensation plan 20, the user may modify existing plan metrics 24 and components 26, and also add or delete plan metrics 24 and components 26 as necessary. To support different versions of a compensation plan 20, the plan results tables may be configured to store records for all versions (periods) of a plan. When a new version of a plan is added and its specifications require structural change to one or more plan results tables (i.e., the plan roster tables 69, 70, metric results tables 94, earnings results tables 96, and payment results tables 98 discussed in detail above), the CPM system 10 automatically makes the necessary changes without any impact on the records for existing versions (periods) of the plan. If a plan 20 contains a parameter table 100 and a new version of the plan is added, the CPM system 10 may create a copy of the existing parameter table 100 to be used in the new version of the plan 20. This allows parameter data to be maintained separately for each version without affecting the data for any other version of the plan. Although the exact graphical user interfaces for changing the definition of a plan when adding a new version are not shown, one of ordinary skill in the art would appreciate that they are substantially similar to the plan definition elements already discussed in detail above and shown in the figures, and that minor changes may be made to such plan definition elements and configuration steps without departing from the general spirit embodied within this application.

One of ordinary skill in the art would appreciate that the graphical user interface 50 shown in the figures and described in detail above is merely one possible embodiment presented for illustrative purposes, and is not intended to serve as limitations of alternative embodiments that would achieve the same purpose. In fact, the graphical user interface 50 may take numerous forms and configurations, and various modifications may be made without affecting its core functionalities. Furthermore, one of ordinary skill in the art would appreciate that although the components of the present CPM system 10 and software 34 are described separately with respect to each component's function, two or more of these components may be part of the same component, and may be executed simultaneously with each other. The components of the software 34 may be, for example and without limitation, in the form of software packages, software modules, software services, or software objects, and may be implemented or embedded within various virtual computer environments or hardware components.

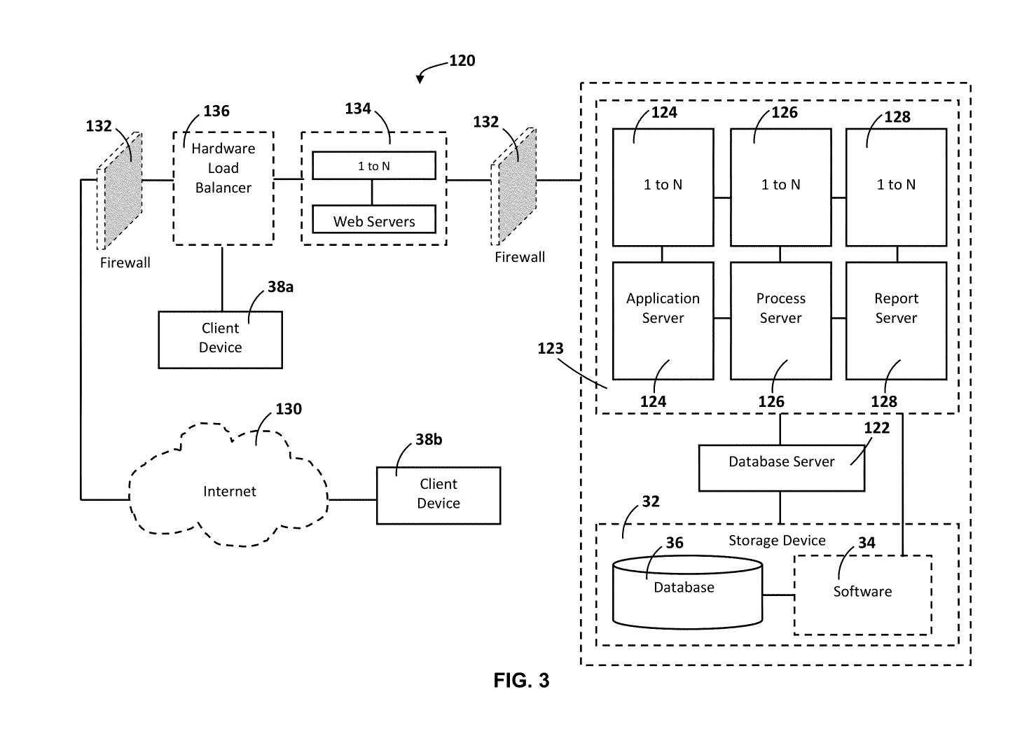

FIG. 3 illustrates an alternative embodiment of a scalable CPM system 120 according to the present application for creating and processing a compensation plan 20 within the CPM system 120. While the CPM system 10 shown in FIG. 2 represents a simplified configuration, the CPM system 120 shown in FIG. 3 represents a scaled installation that includes redundancy and may be exposed to the internet, which is well suited for environments where there are a large number of users or where there is need for extensive storage and processing capabilities. Elements shown in dotted lines represent optional components and groups within the CPM system 120. Since the CPM system 120 of FIG. 3 includes many of the same elements previously discussed with respect to the CPM system 10 of FIG. 2, the same reference numerals are used to identify the same elements described above. The CPM system 120 includes a storage device 32, which may contain a database 36 and software 34, which may be stored in the same or separate storage components within the storage device 32 and may be in communication with each other. The database 36 is configured to store information related to the CPM system 120 as well as information related to other business applications 16 within an associated SPM system 14. The software 34 includes the components described above with respect to the CPM system 10, which are not repeated here for the sake of brevity.

As further shown in FIG. 3, the storage device 32 may be in communication with a database server 122, which allows other elements of the CPM system 120 to access and read information stored in the database 36. The database server 122 may be in communication with one or more logic servers 123, each of which may be configured to perform a logical function. The logic servers 123 may include an application server 124, a process server 126 and a report server 128, each of which may be made up of a plurality of servers 1 to N and may include one or more processors 30. One of ordinary skill in the art would understand that each one of the servers described with respect to FIG. 3 may be made up of separate servers in communication with each other, or may be combined together on a single physical or virtual server. In addition, the storage device 32, database server 122, and logic servers 123 may all be part of the same physical device. The application server 124 may be configured to permit user interaction with the CPM system 120, and may be scaled as application servers 1 to N based on the number of users, including configuration users and end users. The process server 126 may be configured to perform data manipulations and other computing functions, and may be scaled as process servers 1 to N depending on the amount of processing load on the CPM system 120. The report server 128 may be configured to generate customized reports or other communications based on information in the CPM system 120, such as earnings and payments results data, and may be scaled as report servers 1 to N based on the requirements of the CPM system 120. Instead of or in addition to being stored in the storage device 32 and accessed by the logic servers 123, the software 34 may be part of one or more of the application, process, and report servers 124, 126, 128.

The logic servers 123 may be in communication with one or more client devices 38, which may access the logic servers through a network 44 such as a local area network (LAN) or the internet 130. As discussed above with respect to the CPM system 10 of FIG. 2, the client device 38 may include a display device 40 and an input device 42 to allow the user to interact with the CPM system 120 for either configuration or processing purposes. The logic servers 123 may be in communication with a LAN client device 38a through an optional firewall 132, which may be software or hardware based and may be in communication with a web server 134. The web server 134 may be scaled as a plurality of web servers 1 to N, depending on the networking needs of the CPM system 120. Although not a required component of the CPM system 120, the web server 134 may be used to direct users accessing the CPM system 120 to the appropriate application servers 124. The web server 134 may be in communication with an optional hardware load balancer 136, which is a network appliance that balances the load across a plurality of web servers 134, or directly across a plurality of application servers 124 if the system does not include a web server 134. If the CPM system 120 is implemented as a hosted solution where the storage device 32, database server 122, and logic servers 123 are hosted by an organization remotely from the end users, the firewall 132, web server 134, and hardware load balancer 136 are preferably provided by the hosting organization. The logic servers 123 may further be in communication with an internet client device 38b through another optional firewall 132 that secures the CPM system 120 from the internet 130, through which a user may use the internet client device 38b to access the CPM system 120.

Although the present method, system, computer software product, and related technologies with respect to creating and processing compensation plans have been described with respect to a CPM system, one of ordinary skill in the art would appreciate that the configuration and processing steps described in detail above may also be applied to a method of configuring and/or processing a compensation plan in accordance with the present application. One of ordinary skill in the art would further recognize that although the present CPM system may be configured guide the user through defining a compensation plan in a particular order, the user is free to deviate from the specific order described above, and/or go back after defining a plan element to make changes as needed. A computer implemented method of configuring and processing a compensation plan would include the steps of presenting a graphical user interface to a use that is creating or managing a compensation plan, and would include further steps related to receiving user input related to each element or building block of the compensation plan as discussed above, many steps of which may be optional and/or dependent on previous user specifications. The present invention may also be embodied in a computer software product that includes a non-transitory computer readable storage medium readable by a processor. The computer software product may be implemented in or utilized with, for example and without limitation, the CPM systems 10, 120 shown in FIGS. 2-3, or any other computer system having suitable processing and storage capabilities. Although not described in detail, one of ordinary skill in the art would recognize that the computer software product may include various set of instructions to create a compensation plan and/or process a compensation plan according to the steps described above with respect to the CPM system, which will not be repeated here for sake of brevity.

Furthermore, one of ordinary skill in the art would appreciate that the CPM systems and related methods and technologies illustrated and described herein are merely representatives of systems and methods that may embody the present invention, and that various other system types, configurations, and methods are also suitable for use with the invention. The software and hardware components described above with respect to the CPM systems may also take on other variations, modifications, and alternatives without departing from the spirit of the present application. Some examples and variations of these software and hardware components are discussed below.

The storage device 32 shown in FIGS. 2-3 may be or include a memory device such as a Dynamic Random Access Memory (D-RAM), Static RAM (S-RAM), other RAM, a flash memory, or any other suitable computer-readable medium. The storage device may further be or include a hard disk, a solid-state drive (SSD), a magnetic recording apparatus, a magneto-optical medium, an optical medium such as a compact disc-read only memory (CD-ROM), a digital versatile disk (DVD), a Blue-Ray disk (BD), or any other type of computer-readable medium or suitable device for electronic data storage. As used herein, the term “computer-readable medium” broadly refers to any storage medium that may store or transfer information, including volatile, nonvolatile, removable, and non-removable media. Specifically, computer-readable medium may include a non-transitory computer readable storage medium.

The database 36 shown in FIGS. 2-3 may be spread across one or more non-transitory computer-readable mediums, and may be or include one or more relational databases, hierarchical databases, object-oriented databases, one or more flat files, one or more spreadsheets, and/or one or more structured files. The database 64 may be managed by one or more database management systems, which may be based on a technology such as, for example and without limitation, Microsoft SQL Server, MySQL, PostgreSQL, Oracle Relational Database Management System (RDBMS), a NoSQL database technology, or any other appropriate technologies. The database 36 may include a number of different types of data that are used by the present system, method, and computer software product.

As used herein, the term “processor” broadly refers to any unit, module, or machine capable of executing a sequence of instructions. The processor 30 shown in FIG. 2 and the process server 126 shown in FIG. 3 may be or include, for example and without limitation, a single-core or multi-core processor, a general purpose processor, a special purpose processor, a conventional processor, a Graphics Processing Unit (GPU), a digital signal processor (DSP), one or a plurality of microprocessors, one or more microprocessors associated with a DSP core, a controller, a microcontroller, one or more Application Specific Integrated Circuits (ASICs), one or more Field Programmable Gate Array (FPGA) circuits, any other type of integrated circuit (ID), a system-on-a-chip (SOC), a Complex Instruction Set Computer (CISC), a Reduced Instruction Set Computer (RISC), or a state machine.

The display device 40 that may be embodied in a client device 38 as shown in FIGS. 2-3 may be or include, for example and without limitation, a monitor or television display, a plasma display, a liquid crystal display (LCD), or a display based on a technology such as front or rear projection, light emitting diodes (LEDs), organic light-emitting diodes (OLEDS), or Digital Light Processing (DLP). The display device interface may operate using technology such as Video Graphics Array (VGA), Super VGA (S-VGA), Digital Visual Interface (DVI), High-Definition Multimedia Interface (HDMI), or any other appropriate technologies. A display device interface may be used to communicate display data from the processor 30, 126 to the display device 40 to be displayed by the display device 40. The display device 40 may also be external to the client device 38 and coupled to the client device 38 via a display device interface.

The input device 42 that may be embodied in a client device 38 as shown in FIGS. 2-3 may be or include, for example and without limitation, a keyboard, mouse, trackball, pointing stick, touch screen, touch pad, stylus pad, or other suitable devices. The input device 42 may be configured to communicate with the processor 30 or the client device 38 using various peripheral device interface technologies, such as a Universal Serial Bus (USB), PS/2, Bluetooth, infrared, serial port, parallel port, or any other appropriate technologies.

The graphical user interface 50 shown in FIGS. 5-8, 11, 13-14, 16-39, 41-55, 57-79 may be displayed to the user via the display device 40, and more specifically through a web browser module. The web browser module may include or communicate with one or more sub-modules that perform functionality such as rendering HTML (including HTML5), rendering raster and/or vector graphics, executing JavaScript, and/or rendering multimedia content. The web browser module and its sub-modules may also implement technologies such as Rich Internet Application (RIA), Adobe Flash, Microsoft Silverlight, or any other appropriate multimedia technologies. These multimedia technologies may be implemented using one or more web browser plug-in modules and/or by using one or more sub-modules within the web browser module itself.

The client device 38 shown in FIGS. 2-3 may be or include, for example and without limitation, a desktop computer, a laptop computer, a netbook, a tablet computer, a personal digital assistant (PDA), a cellular phone such as a smartphone, or any other appropriate device. The client device may include the display device and input device, as well as a processor, memory device, communication interface, peripheral device interface, display device interface, storage device, and various other components. FIG. 80 shows a tablet computer 39 that is a more specific example of the client device 38 of FIGS. 2-3. The tablet computer 39 may include a processor 30 (not depicted), memory device (not depicted), storage device 32 (not depicted), and touch screen display 41, which may possess characteristics of the display device 40 and input device 42, as described above with respect to FIGS. 2 and 3. The touch screen display 41 may receive user input using technology such as, for example and without limitation, resistive sensing technology, capacitive sensing technology, optical sensing technology, or any other appropriate touch-sensing technology. The touch screen display 41 may also be configured to display the graphical user interface 50 of FIGS. 5-8, 11, 13-14, 16-39, 41-55, 57-79, such as through a web browser interface.

Although the present system, method, and computer software product has been described using examples relating to sales compensation plans, sales-related data, and sales performance management, the features described above with respect to the present invention are also applicable to and may be used by, mutatis mutandis, any type of business organization, non-business organization, or individual for any suitable purpose. Furthermore, while features and elements of the present system, method, and computer software product are described in particular combinations, it is to be appreciated that each feature or element can be used alone or in any combination with or without the other features and elements. Any single embodiment described herein may be supplemented with one or more elements from any one or more of the other embodiments described herein. Any single element of an embodiment may be replaced with one or more elements from any one or more of the other embodiments described herein. For example, each feature or element as described herein with reference to any one of FIGS. 1-80 may be used alone without the other features and elements or in various combinations with or without other features and elements from each or any combinations of the other figures from FIGS. 1-80. Each or any combination of features described herein with reference to FIGS. 1-80 may be considered optional. Sub-elements of the methods and features described herein with reference to FIGS. 1-80 may be performed in any arbitrary order (including concurrently) in any combination or sub-combination.

What is claimed is:

1. A computer-implemented method of configuring and processing a compensation plan in a plan management system, comprising the steps of:
presenting a graphical user interface via a display device, the graphical user interface configured to present guidance and receive user input related to the compensation plan;
receiving a user input specifying a plan roster containing a plan entity representing a business unit for which the compensation plan performs calculations;
receiving a user input specifying a plan metric configured to perform a metric calculation on input data related to the plan entity to produce metrics data;
receiving a user input specifying a plan component configured to perform an earnings calculation on input data comprising the metric results data to produce earnings data; and
receiving a user input specifying a plan payment configured to perform a payment calculation on input data comprising the earnings data to produce payments data.

2. The computer-implemented method of claim 1, further comprising the steps of:
upon receiving the user input specifying a plan roster, creating a plan roster table configured to store roster data, which comprises information related to the plan entity;
upon receiving the user input specifying a plan metric, creating a metric results table configured to store metrics data and related information;
upon receiving the user input specifying a plan component, creating an earnings results table configured to store earnings data and related information; and
upon receiving the user input specifying a plan payment, creating a payment results table configured to store payments data and related information.

3. The computer-implemented method of claim 1, further comprising the steps of:
processing at least one of the plan roster, the plan metric, the plan component, or the plan payment to produce at least one of corresponding roster data, metrics data, earnings data, or payments data;
in a case that the plan roster is processed, creating a plan roster table and populating the plan roster table with the roster data;
in a case that the plan metric is processed, creating a metric results table and populating the metric results table with the metrics data;
in a case that the plan component is processed, creating an earnings results table and populating the earnings results table with the earnings data; and
in a case that the plan payment is processed, creating a payment results table and populating the earnings results table with the payments data.

4. The computer-implemented method of claim 3, wherein the plan roster table, the metric results table, earnings results table, and payments results table are each stored in a storage device that is associated with the plan roster, plan metric, plan component, and plan payment elements of the compensation plan.

5. The computer-implemented method of claim 1, further comprising the step of:
presenting a diagram within the graphical user interface that visually represents the plan roster, the plan metric, the plan component, and the plan payment as individual nodes.

6. The computer-implemented method of claim 5, wherein each node in the diagram may be selected by a user to manually process the corresponding plan roster, plan metric, plan component, or plan payment separately from the rest of the compensation plan.

7. The computer-implemented method of claim 1, where the user input specifying a plan roster includes specification of an earnings entity for which the compensation plan performs earnings calculations, and specification of a payments entity, different from the earnings entity, for which the compensation plan performs payments calculations.

8. The computer-implement method of claim 7, further comprising the steps of:
creating an earnings roster table configured to store information related to the earnings entity; and
creating an earnings to payments roster table configured to store information related to the earnings entity, the payments entity, and an assignment relationship between instances of the earnings entity and the payments entity.

9. A system for configuring and processing a compensation plan, the system comprising:
a processor;
a storage device in communication with the processor;
a display device in communication with the processor and configured to present a graphical user interface;
an input device in communication with at least one of the processor, the storage device, or the display device; and
a software stored in the storage device and executable by the processor, the software comprising:
a component configured to display via the graphical user interface a plan setup element that presents guidance and provides options related to configuration of the compensation plan;
a component configured to receive user input from the input device specifying a plan roster containing a plan entity representing a business unit for which the compensation plan performs calculations;
a component configured to receive user input from the input device specifying a plan metric configured to perform a metric calculation on input data related to the plan entity to produce metrics data;
a component configured to receive user input from the input device specifying a plan component configured to perform an earnings calculation on input data comprising the metric results data to produce earnings data;
a component configured to receive user input from the input device specifying a plan payment configured to perform a payment calculation on input data comprising the earnings data to produce payments data;
a component configured to process the plan roster, the plan metric, the plan component, and the plan payment to produce corresponding information related to the plan entity, metrics data, earnings data, or payments data;
a component configured to create a plan roster table and populate the plan roster table with the information related to the plan entity;
a component configured to create a metric results table and populate the metric results table with the metrics data;
a component configured to create an earnings results table and populate the earnings results table with the earnings data; and
a component configured to create a payment results table and populate the payment results table with the payments data.

10. The system of claim 9, wherein the software further comprises a component configured to present a diagram within the graphical user interface to visually represent the plan roster, the plan metric, the plan component, and the plan payment as individual nodes within the diagram.

11. The system of claim 9, wherein the plan roster table, metric results table, earnings results table, and payment results table are each stored in the storage device and the information stored therein updated each time the corresponding plan roster, plan metric, plan component, or plan payment is processed.

12. The system of claim 9, wherein the software further comprises a component configured to receive user input related to a set of parameter values to be used in a plan calculation, create a parameter table, and populate the parameter table with data specified by the user input related to the set of parameter values.

13. The system of claim 9, wherein the plan setup element displayed via the graphical user interface comprises a periods definition element configured to present guidance, provide options, and receive user input regarding a payment frequency for the compensation plan, the user input regarding payment frequency being stored in the storage device and communicated to the component configured to process the plan roster, the plan metric, the plan component, and the plan payment.

14. The system of claim 13, wherein the plan setup element displayed via the graphical user interface further comprises an entities definition element configured to present guidance, provide options, and receive user input regarding one or more entities that may be selected as the plan entity.

15. The system of claim 14, wherein the plan entity comprises an earnings entity and a separate payments entity, the components configured to perform metric calculations and earnings calculations being further configured to produce metrics data and earnings data, respectively, associated with the earnings entity, and the component configured to perform payment calculations being further configured to produce payments data associated with the payments entity.

16. The system of claim 9, wherein the plan setup element displayed via the graphical user interface is associated with the component configured to receive user input specifying a plan metric, and are further configured to present guidance, provide options, and receive user input regarding a metric calculation frequency, a metric calculation entity, and a metric calculation type.

17. The system of claim 9, wherein the plan setup element displayed via the graphical user interface is associated with the component configured to receive user input specifying a plan component, and are further configured to present guidance, provide options, and receive user input regarding an earnings calculation frequency, an earnings calculation entity, and an earnings calculation type.

18. The system of claim 9, wherein the plan setup element displayed via the graphical user interface is associated with the component configured to process the plan roster, the plan metric, the plan component, and the plan payment, and are further configured to receive user input selecting one or more of the plan roster, the plan metric, the plan component, and the plan payment to be processed individually or together to produce corresponding information.

19. The system of claim 18, the software further comprising a component configured to present guidance, provide options, and receive user input related to versioning of the compensation plan, the user input comprising a plan version effective period associated with each version of the compensation plan.

20. A computer software product that includes a non-transitory computer readable storage medium readable by a processor, the non-transitory computer readable storage medium having stored thereon a set of instructions for configuring and processing a compensation plan, the instructions comprising:
a first sequence of instructions which, when executed by the processor, causes the processor to present a graphical user interface via a display device, the graphical user interface being configured to present guidance and receive user input related to the compensation plan;
a second sequence of instructions which, when executed by the processor, causes the processor to receive a user input specifying a plan roster containing a plan entity representing a business unit for which the compensation plan performs calculations;
a third sequence of instructions which, when executed by the processor, causes the processor to receive a user input specifying a plan metric configured to perform a metric calculation on input data related to the plan entity to produce metrics data;
a fourth sequence of instructions which, when executed by the processor, causes the processor to receive a user input specifying a plan component configured to perform an earnings calculation on input data comprising the metric results data to produce earnings data;
a fifth sequence of instructions which, when executed by the processor, causes the processor to receive a user input specifying a plan payment configured to perform a payment calculation on input data comprising the earnings data to produce payments data;
a sixth sequence of instructions which, when executed by the processor, causes the processor to process the plan roster, the plan metric, the plan component, and the plan payment to generate corresponding roster data, metrics data, earnings data, and payments data;
a seventh sequence of instructions which, when executed by the processor, causes the processor to create a plan roster table and populate the plan roster table with roster data;
an eighth sequence of instructions which, when executed by the processor, causes the processor to create a metric results table and populate the metric results table with metrics data;
a ninth sequence of instructions which, when executed by the processor, causes the processor to create an earnings results table and populate the earnings results table with earnings data; and
a tenth sequence of instructions which, when executed by the processor, causes the processor to create a payment results table and populate the payment results table with payments data.
